(19) United States
(12) Patent Application Publication
(10) Pub. No.: US 2003/0106067 A1
(43) Pub. Date: Jun. 5, 2003

(54) Integrated internet protocol (IP) gateway services in an RF cable network

(76) Inventors: Steve J. Hoskins, Duluth, GA (US); Samuel H. Russ, Alpharetta, GA (US); Himanshu R. Parikh, Duluth, GA (US); Ajith N. Nair, Lawrenceville, GA (US)

Correspondence Address: SCIENTIFIC-ATLANTA, INC., INTELLECTUAL PROPERTY DEPARTMENT, 5030 SUGARLOAF PARKWAY, LAWRENCEVILLE, GA, 30044, US

(21) Appl. No.: 09/998,107

(22) Filed: Nov. 30, 2001

(51) Int. Cl. H04N 7/173; H04N 7/16

(52) U.S. Cl. 725/119; 725/109; 725/111; 725/117; 725/147

(57) ABSTRACT

The integration of gateway services such as, but not limited to, one or none of Network Address Translation (NAT), firewalls, proxies, tunneling, and/or Virtual Private Networking (VPN) into RF cable devices such as, but not limited to, cable modems and/or set-top boxes advantageously provides additional capabilities for accessing the internet over an RF cable connection.

### FIELD OF THE INVENTION

The preferred embodiments of the present invention relate generally to the arts of data communication networks and cable television, and more particularly, to cable devices such as, but not limited to, cable modems and/or set-top boxes (as well as associated methodologies) for delivering information flows to network subscribers or users over radio frequency (RF) cable networks.

### BACKGROUND OF THE INVENTION

The underlying technology of the internet has been ubiquitously deployed not only within the internet, but also within private networks. This technology allows devices on computer networks to communicate using a related family of protocols that is usually identified by the two major protocols in the family, namely the transmission control protocol (TCP) and the internet protocol (IP). This family of protocols or any subset thereof generally is referred to as the TCP/IP protocol suite or just TCP/IP. The major growth of the internet and the use of the internet TCP/IP protocol suite within private networks occurred using the fourth version of the internet protocol (IP), which is commonly known as IP version 4 or IPv4. The popularity of the internet eventually revealed the restrictive space constraints of the 32-bit address space of IPv4. As a result newer versions of IP such as IP next generation (IPng) and IP version 6 (IPv6) were designed with a larger 128-bit address space.

Devices that utilize IP generally can be defined as hosts and routers. In general, routers connect two or more IP networks and forward IP datagrams between the IP networks as part of a routing process, while hosts usually have end-user applications that are the source and destinations of IP datagrams. Sometimes a processing device in an IP network has both routing processes for forwarding IP datagrams and end-user application processes for managing or configuring the device. As used in this application the term “IP device” means a processing system having an IP address (of any variant of IP such as, but not limited to, IPv4 or IPv6). Thus, as used in this application, the term “IP device” may comprise 1) devices running at least one IP host-oriented process that are the end-point of IP datagrams, 2) devices running at least one IP routing-oriented process for forwarding and/or manipulating IP datagrams, and 3) devices running at least one process that is any combination or variant of such host-oriented and routing-oriented IP processes. This definition of the term IP device also includes devices running all possible combinations of host-oriented processes, routing-oriented processes, and variants of host-oriented and routing-oriented processes. As this application deals with many of the well-known protocols used in the internet, several documents on these protocols will be referenced in the application. These documents are known as internet RFCs (request for comments) and can be obtained from the website of the Internet Engineering Task Force (IETF) at http://www.ietf.org.

As originally envisioned by designers of the internet, each IP (Internet Protocol) device or internet host was to be assigned at least one globally-unique IP address. However, the tremendous growth of the internet in the mid to late 1990s created a shortage of IP version 4 addresses. Although IP next generation (IPng) or IP version 6 (IPv6) are newer versions of the Internet Protocol (IP) and were being developed with a 128-bit address space, the large deployment of IP version 4 (IPv4) equipment limited the ability and cost-effectiveness of changing out or upgrading the IPv4 equipment with its 32-bit address space for the 128-bit address space of IPv6.

In addition, the growth of the internet together with inefficient assignment of addresses caused large increases in the number of entries in the routing tables forwarded by internet routers. To solve some of these routing problems Classless Inter-Domain Routing (CIDR) was introduced with route consolidation to reduce the number of routing table entries propagated among the routers of the internet backbone. As part of the implementation of route consolidation, many internet service providers (ISPs) required subscribers to renumber their IP devices whenever they changed their internet service to that internet service provider. Internet service providers required customers to renumber their IP devices even when the subscriber already had globally-unique IP addresses on the devices. Furthermore, to efficiently ration and allocate IP addresses, many ISPs started charging additional money for allocation to a customer of fixed and/or additional IP addresses.

As a result of these factors Network Address Translation (NAT) was developed to resolve some of the limitations of the 32-bit address space of IP version 4 (IPv4) and to provide a solution to the administratively costly problem of renumbering IP devices when a subscriber changed ISPs. Before the widespread use of the Dynamic Host Configuration Protocol (DHCP) for assigning IP addresses to IP devices or hosts, renumbering IP devices required a person to change the software settings on each IP device. This could be quite costly for the networks of large organizations.

Although the examples of network address translation (NAT) in this application generally use the 32-bit address space of IPv4, this is only for illustrative purposes and is not intended to be limiting in any way. The teachings in this application also will apply with the larger 128-bit address space of IPv6 or any other size IP address space presently defined or yet to be defined. In addition, network address translation (NAT) can be used to connect networks with smaller address spaces such as the 32 bits of IPv4 to networks with larger address spaces such as the 128 bits of IPv6. Thus, the translations of network addresses within NAT devices do not have to only convert network addresses of the same length.

For many remote access networks that are used for internet access, service providers often only provide a single internet-valid IP address to the subscriber's remote access equipment because of the scarcity of IP addresses. Often these remote access networks have a single IP device or a relatively small number of IP devices on a stub network. Common access technologies used by customers or subscribers for remote access to the internet include, but are not limited to, analog POTS (plain old telephone service) modems, ISDN (integrated services digital network) terminal adapters, xDSL (digital subscriber line) modems, and cable modems. Usually, the single IP address supplied by the service provider is dynamically assigned each time a subscriber powers on the access equipment and connects to the internet.

For devices running the Point-to-Point Protocol (PPP), the single IP address generally is assigned by the service provider to the subscriber-end device running PPP. (PPP is described in internet standard 51 or RFC 1661, “The Point-to-Point Protocol (PPP)” by W. Simpson, editor.) This assignment of IP addresses over PPP usually occurs during the negotiation of parameters for the IP Control Protocol (IPCP), which is capable of forwarding IP datagrams over a PPP link. (IPCP is described in RFC 1332, “The PPP Internet Protocol Control Protocol (IPCP)” by G. McGregor.) In general, IPCP is only capable of allocating at most one IP address per PPP connection.

For other subscriber equipment that does not connect to the internet using PPP, service providers usually utilize the Dynamic Host Configuration Protocol (DHCP) to dynamically allocate one internet-valid IP address to subscriber equipment. DHCP is an extension of the earlier BOOTP protocol (Bootstrap Protocol), and although DHCP is capable of allocating multiple IP addresses, most service providers only allow a subscriber or customer to dynamically obtain one internet-valid IP address as part of the basic access included in a package of capabilities associated with a monthly service fee. (DHCP is described in RFC 1541 and RFC 2131, “Dynamic Host Configuration Protocol” by R. Droms.)

However, some providers will allow customers to obtain additional internet-valid IP addresses for an additional fee. These fees serve to ration the scarce resource of internet-valid IP addresses. Because many subscribers or customers have multiple IP devices that they want to connect to the internet and because the subscribers do not want to pay for additional IP addresses, subscribers often use traditional NAT (Network Address Translation), which includes basic NAT and NAPT (Network Address Port Translation), to translate between the IP addresses and ports used on their multiple IP devices and the single IP address dynamically assigned by the service provider through IPCP or DHCP. In addition, several computer operating systems for general purpose computers have implemented this NAT technology including, but not limited to, the Internet Connection Sharing of Windows 98 Second Edition, Windows ME, and Windows 2000, the IP masquerading functionality of Linux, and the NAPT functionality of FreeBSD. Furthermore, some external routers also have implemented network address translation technology. Normally, these external routers have not been integrated into the devices for accessing an RF cable network.

However, these non-integrated solutions utilizing general purpose computers and/or external routers for NAT have some limitations. First, the NAT solutions run on general purpose computers generally require the customer either to have a separate general purpose computer for performing NAT or to accept slower performance on their general purpose computer as some of the computer's processing power is utilized for network address translation instead of being used for the customer's or user's other applications such as, but not limited, word processing. Also, using a separate general purpose computer for NAT may be more expensive than other solutions. Third, utilizing a separate general purpose computer may draw more electrical power and generate excess noise from a cooling fan than other potential solutions.

Also, for the non-integrated solutions of both general purpose computers and external routers, these devices generally are not aware that the network connectivity is through an RF cable network. As a result the general purpose computers and external routers cannot integrate the user interfaces for NAT setup with the user interfaces for cable modem connectivity diagnostics and/or setup. In addition, the existing solutions may introduce some security problems especially when running NAT on the same general purpose computer that is running other user applications such as word processing. Furthermore, though customers may view a cable modem and an external, non-integrated device for NAT as two pieces of equipment that together provide connectivity over an RF cable connection for multiple customer IP devices, there generally are no standard protocols or mechanisms for cable modems and external non-integrated NAT devices to communicate status and/or configuration with each other. This leads to both the cable modem and the external, non-integrated NAT device having an incomplete picture of the status and/or configuration of the customer's remote access over an RF cable connection for multiple IP devices.

### BRIEF DESCRIPTION OF THE DRAWINGS

The preferred embodiments of the invention can be better understood with reference to the following drawings. The components in the drawings are not necessarily to scale, emphasis instead being placed upon clearly illustrating the principles of the preferred embodiments of the present invention. Moreover, in the drawings, like reference numerals designate corresponding parts throughout the several views. The reference numbers in the drawings have at least three digits with the two rightmost digits being reference numbers within a figure. The digits to the left of those two digits are the number of the figure in which the item identified by the reference number first appears. For example, an item with reference number 212 first appears in FIG. 2.

FIG. 1 is a block diagram showing the architecture model for a Network Address Translation (NAT) device;

FIG. 2 is a block diagram showing an IP datagram inside a layer two, data link frame;

FIG. 3 is a block diagram showing an IP datagram inside a protocol capable of encapsulating IP datagrams;

FIG. 4 is a block diagram showing a cable modem (CM) architecture that utilizes an RF signal distribution network to connect the internet to customer premise equipment (CPE) comprising internet protocol (IP) devices;

FIG. 5 is a block diagram showing a point-to-point communications medium;

FIG. 6 is a block diagram showing a shared communications medium with a controller arbitrating access to the shared communications medium;

FIG. 7 is a block diagram showing a shared communications medium with access to the shared communications medium determined through a distributed media access control (MAC) protocol;

FIG. 8 is a block diagram showing a cable modem (CM) connected to IP devices that are customer premise equipment (CPE) of a subscriber network;

FIG. 9 is a block diagram showing a cable modem (CM) connected to IP devices that are customer premise equipment (CPE) of a subscriber network, the subscriber network comprising a non-integrated NAT device connected at the boundary between two communications media in the subscriber network;

FIG. 10 is a block diagram showing a cable modem connected to IP devices that are customer premise equipment (CPE) of a subscriber network, the subscriber network comprising a non-integrated, one-arm NAT device;

FIG. 11 is a block diagram showing a cable modem with integrated NAT capability that is connected to IP devices, the IP devices being customer premise equipment (CPE) of a subscriber network;

FIG. 12 is a block diagram showing a cable modem (CM) with integrated NAT and some non-limiting example processes and items of information that might be important in implementing such a cable modem;

FIG. 13 is a block diagram showing a cable TV network architecture that utilizes an RF signal distribution network to communicate audio and/or video programming from the headend or distribution hub through a set-top box (STB) to audio/visual customer premise equipment (CPE) such as, but not limited to, a television;

FIG. 14 is a block diagram showing a set-top box (STB) connected to audio/visual customer premise equipment (CPE) such as, but not limited to, a television and also connected to IP devices that are customer premise equipment (CPE) of a subscriber network;

FIG. 15 is a block diagram showing a set-top box (STB) connected to audio/visual customer premise equipment (CPE) such as, but not limited to, a television and also connected to IP devices that are customer premise equipment (CPE) of a subscriber network, the subscriber network comprising a non-integrated NAT device connected at the boundary between two communications media in the subscriber network;

FIG. 16 is a block diagram showing a set-top box (STB) connected to audio/visual customer premise equipment (CPE) such as, but not limited to, a television and also connected to IP devices that are customer premise equipment (CPE) of a subscriber network, the subscriber network comprising a non-integrated, one-arm NAT device;

FIG. 17 is a block diagram showing a set-top box (STB) connected to audio/visual customer premise equipment (CPE) such as, but not limited to, a television, the set-top box (STB) having an integrated NAT capability and also being connected to IP devices that are customer premise equipment (CPE) of a subscriber network; and

FIG. 18 is a block diagram showing a set-top box (STB) with integrated NAT and some non-limiting example processes and items of information that might be important in implementing such a cable modem.

### DETAILED DESCRIPTION OF THE PREFERRED EMBODIMENTS

The preferred embodiments of the present invention address many of these issues.

First, integrating user processes such as, but not limited to, NAT into the RF cable devices such as, not limited to, cable modems and/or set-top boxes that access the cable RF network might allow service providers and/or subscribers to utilize an integrated user interface for configuring and/or diagnosing connectivity problems with the RF cable network and for setting up user processes such as, but not limited to, network address translation. Also, some of the embodiments of the present invention cover integrating user processes into a set-top box with cable modem functionality. This type of device might use the user interface from the set-top box for setup and/or diagnostics of NAT and/or RF cable connectivity.

Furthermore, many cable modems in North America conform to the DOCSIS (Data-Over-Cable Service Interface Specification) standard, which limits the types of interfaces between cable modems and customer premise equipment. Some of the embodiments of the present invention allow RF cable devices such as, but not limited to, cable modems and/or set-top boxes to appear to the service provider's equipment as a DOCSIS cable modem, while not being as restrictive as the DOCSIS standards with respect to the customer premise interfaces and/or the user processes (such as, but not limited to, NAT) that may be integrated into a cable modem and/or a set-top box.

Network Address Translation (NAT)

Network Address Translation (NAT) is a generalized term that describes a family of related operations that modify IP datagrams as they are forwarded across IP addressing realms. An IP addressing realm is a section of an IP network containing hosts or IP devices whose IP addresses are unique within that IP addressing realm. In other words, an IP addressing realm is a network domain where the unique assignment of addresses to devices in that addressing realm allows IP datagrams to be properly routed among the devices. Although an internet user is completely empowered to create their own IP addressing realms, if the choice of IP addresses for an IP addressing realm includes a range of addresses that overlaps with other globally-valid addresses on the internet, then the user will not be able to access the internet devices with IP addresses within that overlapped portion of the addressing range.

To deal with this potential overlapping IP address problem, RFC 1597, “Address Allocation for Private Internets” by Y. Rekhter, B. Moskowitz, D. Karrenberg, and G. de Groot, was published and is incorporated by reference herein. Basically, RFC 1597 split the 32-bit IPv4 address space into a public, internet-valid set of addresses and a private set of addresses that are not valid on the internet. Based on this RFC, the authority that assigns valid internet IP address numbers never will assign any IPv4 addresses from the private address space of RFC 1597 to globally-valid internet devices. Thus, users can choose an IP addressing realm from the range of private addresses in RFC 1597 without ever worrying about the overlapping problem with another globally-valid IP address. (Subsequently, RFC 1918 or Best Current Practice 5, “Address Allocation for Private Internets” by Y. Rekhter, B. Moskowitz, D. Karrenberg, G. J. de Groot, and E. Lear has obsoleted RFC 1597. However, the basic IPv4 private and public address ranges remain the same in RFC 1918. RFC 1918 or Best Current Practice 5 is incorporated by reference herein.) The ranges of private IP addresses specified in RFC 1597 and RFC 1918 are shown in Table 1.

TABLE 1

| | | Number of | Number of | |
|---|---|---|---|---|
| | | Address Bits | Bits in a | |
| | | Allowed for | Mask that | |
| | | User | uses the | |
| | | Allocation in | Entire Range | Corresponding |
| Start of Range | End of Range | the Range | as a Subnet | Subnet Mask |
| 10.0.0.0 | 10.255.255.255 | 24 | 8 | 255.0.0.0 |
| 172.16.0.0 | 172.31.255.255 | 20 | 12 | 255.240.0.0 |
| 192.168.0.0 | 192.168.255.255 | 16 | 16 | 255.255.0.0 |

A taxonomy and a terminology for various NAT operations are described in internet RFC 2663, “IP Network Address Translator (NAT) Terminology and Considerations” by P. Srisuresh and M. Holdrege, which is incorporated by reference herein. In addition, an initial description of NAT was covered in RFC 1631, “The IP Network Address Translator (NAT)” by K. Egevang and P. Francis, which is incorporated by reference herein. RFC 1631 was later obsoleted by RFC 3022, “Traditional IP Network Address Translator (Traditional NAT)” by P. Srisuresh and K. Egevang, which is incorporated by reference herein. The NAT taxonomy in RFC 2663 is non-exhaustive, but provides an overview of the main functions involved in network address translation (NAT). RFC 2663 classifies NAT into three categories: 1) traditional NAT or outbound NAT, 2) bi-directional NAT or two-way NAT, and 3) Twice NAT. In addition, traditional NAT can be further classified into basic NAT and NAPT (Network Address Port Translation).

Architecturally the use of NAT in a network generally exchanges the requirement for complete global uniqueness of each IP address for the requirement to maintain more complex state information in the network regarding the sessions of information flows among devices in the network. This requirement to maintain state information means that NAT devices should have enough memory or storage to maintain the proper state information and enough processing power to update the state information and translate the packets according to the maintained state information. Thus, NAT implementations are often processor and/or memory intensive to be able to translate addresses and/or ports in all packets needing the translation. Although this translation necessarily introduces some delays into the network, the translation generally should be done fairly close to real-time to ensure that higher level protocols do not time-out the communication sessions.

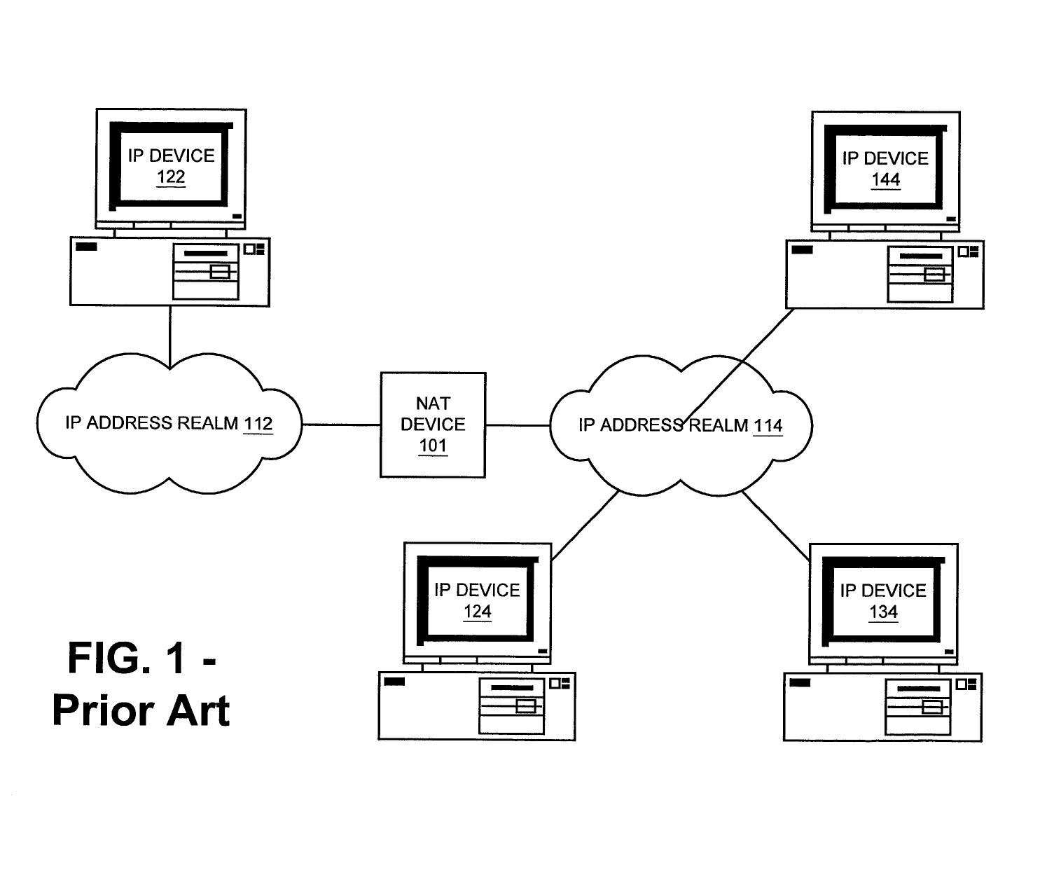

In general Network Address Translation (NAT) converts IP address information, TCP port information, and/or UDP port information contained in packets to allow devices within two different IP addressing realms to communicate. This translation of the information in packets effectively makes the packets appear to be from devices with valid IP addresses within the appropriate IP addressing realm. As an example of NAT functionality, FIG. 1 shows a NAT device 101 connected to two IP address realms 112 and 114. IP address realm 112 is connected to IP device 122, which has an IP address that is unique within IP address realm 112. IP address realm 114 is connected to three IP devices 124, 134, and 144, which each have an IP address that is unique within IP address realm 114. Uniqueness of an IP address within an IP address realm implies that such an IP address may not necessarily be unique outside of that IP address realm.

NAT devices try to provide for the translation of IP addresses and/or port numbers in a way that is transparent to the applications running on the IP devices that are each in a different IP address realm and are communicating across the IP address realms through a NAT device. At a minimum this usually involves changing IP addresses in the header of an IP datagram (and/or for NAPT the port numbers in a TCP or UDP header). In addition, at a minimum NAT usually has to change some checksum numbers for error detection and/or error recovery to properly adjust the modified packet for the changes to the IP addresses and/or port numbers for TCP and/or UDP.

The transmission control protocol (TCP) and the user datagram protocol (UDP) are two common protocols that are used above IP. This common use of TCP above IP has caused the related family of protocols used in the internet to be referred to as the TCP/IP protocol suite or just TCP/IP. However, there is no limitation in the internet protocols that requires TCP to be the only protocol above IP.

Furthermore, there are many protocols in the TCP/IP suite that generally are defined in the internet request for comments (RFC) documents. A non-exhaustive list of some of the protocols in the TCP/IP suite includes, but is not limited to, telnet, rlogin, file transfer protocol (FTP), trivial file transfer protocol (TFTP), network file system (NFS), electronic mail, simple mail transfer protocol (SMTP), post office protocol (POP), internet message access protocol (IMAP), multipurpose internet mail extensions (MIME), hyper-text transfer protocol (HTTP), real-time transport protocol (RTP), simple network management protocol (SNMP), bootstrap protocol (BOOTP), dynamic host configuration protocol (DHCP), border gateway protocol (BGP), routing information protocol (RIP), open shortest path first (OSPF), and the protocol(s) used in the domain name system (DNS).

TCP provides for a reliable, connection-oriented stream of data to be communicated between two IP devices. In addition, TCP port numbers allow communication between the same two IP devices using multiple streams of data that are multiplexed onto the same network by the transmitting IP device, demultiplexed from the network by the receiving IP device, and forwarded to the proper application program running on the receiving IP device. In contrast, UDP is a connectionless, datagram protocol that also has port numbers to allow the communication between the same two IP devices using multiple datagrams that are multiplexed onto the same network by the transmitting IP device, demultiplexed from the network by the receiving IP device, and forwarded to the proper application program running on the receiving IP device. A non-limiting example of multiple server process applications running on a single IP device and using different TCP port numbers would be a single IP device that has several server daemon processes running on it including, but not limited to, a file transfer protocol (FTP) server at TCP port 21, a telnet server at TCP port 23, and a hyper-text transfer protocol (HTTP) or web server at TCP port 80.

However, even with changes to IP address numbers (and/or port numbers for NAPT) and packet checksums, some protocols above IP as well as some protocols above TCP and/or UDP cannot be transparently supported by a NAT device that only changes the source and/or destination IP addresses of an IP datagram, the TCP and/or UDP source and/or destination port numbers, and/or the checksums in the packet to correct for these changes to IP addresses and/or port numbers. Some applications and protocols above IP, TCP, and/or UDP embed information about the IP addresses and/or the port numbers of the end devices within the streams of packets communicated by the protocol. To transparently translate packets with these embedded IP addresses and/or TCP/UDP port numbers, additional changes should be made to the packets being forwarded across two IP address realms. The functionality to perform these extra conversions is known as an application layer gateway (ALG).

Application layer refers to the application layer that is the seventh level of the OSI (Open Systems Interconnect) reference model, while gateway refers to any functionality above the level three, network layer of the OSI model. Originally, devices that performed layer three, IP network routing functions were referred to as gateways. However, more common modern usage of the terminology refers to devices that operate at OSI level three, the network layer, as routers, while devices that generally operate on OSI layers four (transport), five (session), six (presentation), and/or seven (application) are referred to as gateways. OSI level one, physical layer devices commonly are referred to as repeaters, while OSI level two, data link devices often are referred to as bridges and/or switches. (This use of the term switches generally is for data switching devices such as packet, frame, and/or cell switches and generally does not include circuit switches. After a circuit switch establishes a connection or path through the network, circuit-switches generally are not involved in the level two, data link functions. Instead, after the circuit is created, bits are passed through a circuit switch that generally behaves more like a layer 1 repeater than a layer 2 packet, frame, or cell switch.) Because the OSI model is well known in the art, a detailed discussion of all the features and functionality of each level in the OSI model will not be covered. Also, it is well known in the art that the IEEE (Institute for Electrical and Electronic Engineers) has further subdivided some of the OSI layers into sublayers.

The file transfer protocol (FTP) is a common internet protocol that includes IP addresses and port numbers in ASCII (American Standard Code for Information Interchange) text data carried within the information stream that is encapsulated by TCP headers. As a result, for FTP to work properly through a NAT device, an application level (or layer) gateway (ALG) should be used to change the ASCII text representations of IP addresses and/or TCP port numbers in FTP packets. Usually the ALGs for common internet protocols such as FTP are implemented on the same device that performs at least some of the NAT family of operations.

The translation of IP addresses and/or port numbers by a NAT device involves the creation of a mapping or binding between IP addresses (and/or ports) of different IP address realms. This IP address (and/or port number) mapping or binding can be created manually or statically so that an address in one IP address realm is always translated to the same address in another IP address realm until changed by administrative intervention. For example purposes and without introducing any limitations, assume that IP device 124 is associated with private IP address 10.0.0.124 within IP address realm 114 and NAT device 101 manages the globally-valid, internet IP address of 135.100.25.101. A network operator could statically bind IP address 10.0.0.124 of IP device 124 in IP address realm 114 through a one-to-one mapping to IP address 135.100.25.101 in IP address realm 112. Then every communication with IP device 124 across the boundary between IP address realm 114 and IP address realm 112 would use address 135.100.25.101 for packets in IP address realm 112. Alternatively, this binding or mapping of addresses (and/or ports) between IP address realm 112 and IP address realm 114 could be created dynamically based on the needs of devices to communicate across the boundary between address realms. These bindings could be established when sessions are initiated by an IP device beginning communications with a device in another IP address realm. In addition, an incoming name lookup request could trigger the creation of a new address and/or port binding or mapping between IP addresses and/or ports in one IP address realm and addresses and/or ports in another IP address realm. Furthermore, a NAT device may use a combination of both statically-created and dynamically-created IP address and/or port bindings or mappings.

For NAT to work properly, packets that are part of a single session communicated between one device in one IP address realm and another device in another IP address realm generally should go through the same IP address and/or port mapping. Because information on IP address and/or port binding or mapping usually is contained only within a single NAT device, this generally means that packets that are part of a single session communicated between two IP devices in different IP address realms generally should go through that single NAT device to receive the same, proper mapping and translation for each packet. To solve this issue NAT is often implemented on an IP router that is at the border of the two IP address realms. Though nothing technically limits NAT from being implemented on a layer two, bridge device, the proper layout of routes within an IP address realm makes it easier to ensure packets pass through the NAT functionality of a router whenever packets have to cross the IP address realm boundary that is intersected by the interfaces of a NAT router.

Some examples of network address translation using illustrative IP addresses should be helpful in understanding NAT technology. These examples of NAT that reference FIG. 1 are non-limiting, and the IP addresses are chosen only for illustrative purposes without limiting the embodiments of the present invention to those specific IP addresses. Furthermore, the embodiments of the present invention are not limited to the number of IP devices used for illustrative purposes in the examples referencing FIG. 1. NAT will work with other IP address assignments than those used in these examples even though a common use for NAT is to translate between the private IP addresses of RFC 1918 and the globally-unique, public IP addresses on the internet.

First, using FIG. 1 as a guide assume that IP address realm 112 is the internet where IP addresses are globally-unique except for the reserved private addresses specified in RFC 1918. Next, suppose that IP device 122 is a web server with an internet-valid IP address of 192.133.190.220, which is the IP address for the web server process of http://www.scientifc-atlanta.com. Also, assume that NAT device 101 uses or manages the internet-valid IP addresses 135.100.25.101 and 135.100.25.102. In addition, suppose that IP address realm 114 comprises the private range of IP addresses from 10.0.0.0 to 10.255.255.255 as defined in RFC 1918. Finally, suppose that IP devices 124, 134, and 144 have the private IP addresses 10.0.0.124, 10.0.0.134, and 10.0.0.144, respectively.

In traditional NAT or outbound NAT, the IP devices 124, 134, and 144 initiate access outbound from IP address realm 114, which generally comprises the private addresses in RFC 1918, to internet-valid IP devices in the global internet as represented by IP address realm 112. For example, IP device 124 with private IP address 10.0.0.124 might want to access IP device 122, which is a web server with IP address 192.133.190.220. Because the 10.X.X.X (where X is a wildcard representing any number from 0 to 255) network is not a valid internet address, some manipulation of the packets transferred between IP device 124 with an IP address of 10.0.0.124 and IP device 122 with an IP address of 192.133.190.220 is needed to allow the packets to be properly forwarded by network routers and to establish communications between IP device 122 and IP device 124. Network address translation (NAT) device 101 alters the packets communicated between IP device 122 and IP device 124. Generally, this alteration includes among other things changing the source IP address on packets sent from IP device 124 to IP device 122. On packets communicated in the opposite direction from IP device 122 to IP device 124, NAT device 101 generally alters the packet by at least changing the destination IP address.

Basic NAT is a subset of the functions within traditional NAT and provides translation of IP addresses for sessions initiated in one direction across the boundary between two IP address realms. As an example, assume that NAT device 101 contains a mapping between private IP address 10.0.0.124 and the internet-valid IP address of 135.100.25.101 that is managed or used by NAT device 101. Furthermore, assume that NAT device 101 contains a mapping between private IP address 10.0.0.134 and the internet-valid IP address of 135.100.25.102 that is managed or used by NAT device 101. If IP device 124 with private IP address 10.0.0.124 transmits packets to IP device 122 with public IP address 192.133.190.220, then NAT device 101 would change the source IP address from a private IP address of 10.0.0.124 to a public IP address of 135.100.25.101 on packets communicated from IP device 124 to IP device 122. On packets communicated in the opposite direction (i.e., from IP device 122 with IP address 192.133.190.220 to IP device 124 with IP address 10.0.0.124), NAT device 101 would change the destination IP address from a public IP address of 135.100.25.101 to a private IP address of 10.0.0.124. Similarly, if IP device 134 with private IP address 10.0.0.134 transmits packets to IP device 122 with public IP address 192.133.190.220, then NAT device 101 would change the source IP address from a private IP address of 10.0.0.134 to a public IP address of 135.100.25.102 on packets communicated from IP device 134 to IP device 122. On packets communicated in the opposite direction (i.e., from IP device 122 with IP address 192.133.190.220 to IP device 134 with IP address 10.0.0.134), NAT device 101 would change the destination IP address from a public IP address of 135.100.25.102 to a private IP address of 10.0.0.134.

In addition to this basic NAT functionality described above for mapping or translating IP addresses, traditional NAT also encompasses Network Address Port Translation (NAPT). As described in this example, NAT device 101 only manages two internet-valid IP addresses, 135.100.25.101 and 135.100.25.102. If both these IP addresses are currently being used for address translations of IP devices 124 and 134, which are each accessing IP device 122 with an internet-valid, public IP address of 192.133.190.220, then NAT device 101 does not have another free IP address available to provide address translation when IP device 144 with private IP address of 10.0.0.144 wants to access IP devices on IP address realm 112. The solution to this issue is to translate not only IP addresses, but also TCP and/or UDP port numbers. This port translation functionality is called Network Address Port Translation (NAPT) and is part of traditional NAT as defined in RFC 2663. With port translation, NAT device 101 can support communication across the boundary of two IP address realms for more IP devices than NAT device 101 has IP addresses that are valid within one of the IP address realms. In the current example, a NAT device 101 that is capable of NAPT can support simultaneous access across the boundary of IP address realms 112 and 114 for the three IP devices 124, 134, and 144 even though NAT device 101 only has two IP addresses (135.100.25.101 and 135.100.25.102) that are valid within IP address realm 112. IP address realm 112 is the internet in this current example.

Bi-directional NAT or two-way NAT allows IP devices in either IP address realm to initiate sessions to an IP device in the other IP address realm. In the example above of traditional NAT or outbound NAT, IP devices 124, 134, and/or 144 in IP address realm 114 established sessions to the web server running on IP device 122 in IP address realm 112. This communication using NAT was outbound from IP address realm 114 that comprised private IP addresses 10.X.X.X. In the traditional NAT example described above, the binding or mapping of IP addresses and/or ports in NAT device 101 was statically assigned or dynamically created when a device in IP address realm 114 initiated a session. Bi-directional or two-way NAT would allow IP device 122 with an IP address in IP address realm 112 to initiate a session to IP devices 124, 134, and/or 144 with IP addresses in IP address realm 114.

As a non-limiting example of bi-directional NAT, assume that IP device 122 has the internet-valid, public IP address of 192.133.190.220. Further assume that IP devices 124, 134, and 144 have the private IP addresses of 10.0.0.124, 10.0.0.134, and 10.0.0.144, respectively. Also, assume that NAT device 101 manages the two internet-valid IP addresses of 135.100.25.101 and 135.100.25.102. Finally, assume that 135.100.25.101 is statically mapped to 10.0.0.124, that 135.100.25.102 TCP port 80 is statically mapped to 10.0.0.134 TCP port 80, and that 135.100.25.102 TCP port 21 is statically mapped to 10.0.0.144 TCP port 21. TCP port 21 is the well-known TCP port for FTP servers, while TCP port 80 is the well-known port for HTTP servers or web servers. This example configuration for IP addresses is similar to the configuration described above in the example for traditional or outbound NAT. Thus, the outbound access described above for traditional or outbound NAT will still operate the same way under bi-directional or two-way NAT.

As an example of the inbound access for bi-directional NAT, assume that IP device 122 in IP address realm 112 initiates a web connection session on TCP port 80 to internet-valid IP address 135.100.25.101. Then NAT device 101 will translate these incoming packets and forward the TCP connection to IP device 124 with private IP address 10.0.0.124. Also, if IP device 122 in IP address realm 112 initiates a web connection session on TCP port 80 to internet-valid IP address 135.100.25.102, then NAT device 101 will translate these incoming packets and forward the TCP connection to IP device 134 with private IP address 10.0.0.134. But if IP device 122 in IP address realm 112 initiates an FTP connection session on TCP port 21 to internet-valid IP address 135.100.25.102, then NAT device 101 will translate these incoming packets and forward the TCP connection to IP device 144 with private IP address 10.0.0.144. Though this example of bi-directional or two-way NAT used static address and/or port assignments, these assignments could just as well have been made dynamically through incoming domain name lookups if the IP devices 124, 134, and 144 have unique fully-qualified domain names. Also, a NAT device may use a combination of both statically-created and dynamically-created IP address and/or port bindings or mappings both for sessions initiated outbound from one address realm (such as an RFC 1918 private address realm) and for sessions initiated inbound to that same address realm.

For packets traveling in one direction, traditional NAT (or outbound NAT) and bi-directional NAT (or two-way NAT) usually only translate or convert either the source or the destination addresses and/or ports, but not both the source and destination addresses and/or ports. In contrast, Twice NAT translates both the source and destination addresses and/or ports. Thus, a twice NAT device likely maintains twice as many address and/or port mappings or bindings as a traditional or bi-directional NAT device. An application for twice NAT occurs when the two IP address realms connected by a twice NAT device have IP address space collisions.

As a non-limiting example, suppose that IP address realm 112 is the internet and includes connected devices with globally-valid, public internet addresses such as IP device 122, which has IP address 192.133.190.220. Suppose that IP address realm 114 was initially wrongly configured to include 192.133.190.X within IP address realm 114. For example, assume that even though their IP addresses are public internet addresses, the internet IP devices 124, 134, and 144 have wrongly used these IP addresses that are officially assigned to another IP device on IP address realm 112 such as IP device 122. Let IP device 124 have an IP address of 192.133.190.220; let IP device 134 have an IP address of 192.133.190.221; and let IP device 144 have an IP address of 192.133.190.222. Suppose that IP device 134 wants to access IP device 122 that validly has an IP address of 192.133.190.220 on the global internet. The problem is that the routing within IP address realm 114 will forward the access request from IP device 134 to IP device 124 because IP address realm 114 already wrongly includes the addresses of 192.133.190.X. This information on routing for the 192.133.190.X network within IP address realm 114 would be contained in the IP hosts and routers within IP address realm 114.

The solution for this problem is for NAT device 101 to perform twice NAT functionality. For example, NAT device 101 could map the globally-valid IP address of 192.133.190.220 for IP device 122 into a private IP address of 10.0.0.122 that is used internally within IP address realm 114 to refer to IP device 122. The routes within IP address realm 114 can be configured to route messages to 10.0.0.122 through NAT device 101 for translation of either, depending on the direction of the packet, source or destination IP addresses and/or ports between 10.0.0.122 and the globally-valid, public IP address of 192.133.190.220 for IP device 122. In addition, NAT device 101 should translate either, depending on the direction of the packet, the destination or source IP addresses and/or ports between the internal, non-globally-valid IP address of 192.133.190.221 for IP device 134 and a globally-valid IP address such as 135.100.25.101 that is managed by NAT device 101. This twice NAT functionality ensures that IP device 122 in the internet as represented by IP address realm 112 sees globally-valid, public IP addresses in the packets it receives and transmits. Furthermore, twice NAT allows the routing to be set up in IP address realm 114 so that IP device 134 can access internet IP device 122 even though IP address 192.133.190.221 of IP device 134 is an overlapped IP address in both the address spaces of IP address realm 112 and IP address realm 114.

IP Datagrams

The seven layers of the OSI reference architecture are: 1) the physical layer, 2) the data link layer, 3) the network layer, 4) the transport layer, 5) the session layer, 6) the presentation layer, and 7) the application layer. Furthermore, the Institute for Electrical and Electronic Engineers (IEEE) has subdivided level two, the data link layer of the OSI model into at least a media access control (MAC) sublayer and a logical link control (LLC) sublayer. The OSI model was developed for an OSI protocol that was not widely accepted by the communications industry. Because the OSI model was developed independently from many commonly used communication protocols, the abstractions of the OSI model do not exactly match every working protocol including the TCP/IP protocol suite. However, the seven-layer OSI protocol model is a useful abstraction for evaluating and discussing communication protocols and has become well known in the art for such purposes.

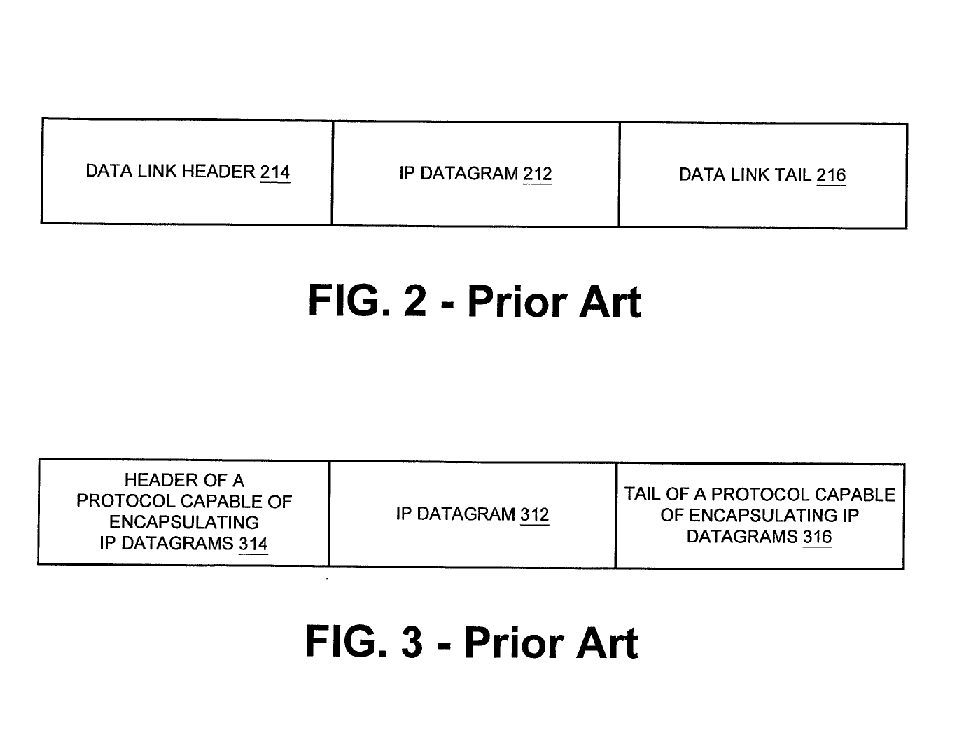

IP generally is considered to be a level three, network layer protocol from the OSI model. In the basic OSI model, network protocols such as IP are encapsulated in level two, data link layer protocols. Thus, FIG. 2 shows IP datagram 212 encapsulated within data link header 214 and data link tail 216. Not all protocols have both a header and a trailer or tail. Thus, data link tail 216 is not used in many data link protocols.

As is well-known in the art, the internet protocol (IP) works by breaking up information or data into datagrams, with each datagram or IP datagram at least containing datagram data and an IP header. The IP header further contains a source IP address and a destination IP address. Although IP is a level three, network layer protocol that was generally designed to function over level two, data link protocols, there are many ways to encapsulate IP datagrams within other protocols that are not layer two, data link protocols. Some non-limiting examples of such encapsulations include tunneling and virtual private network (VPN) technologies. FIG. 3 shows the general case where IP datagram 312 may be encapsulated in a protocol that includes a protocol header capable of encapsulating IP datagrams 314 and a protocol tail capable of encapsulating IP datagrams 316. As was discussed above with regard to data link protocols, some protocols do not use trailers or tails.

Thus, the embodiments of the present invention are not to be limited to performing network address translation (NAT) only for IP datagrams encapsulated in data link frames. So long as information can be extracted from a packet to perform the necessary IP address and/or port translations, the NAT functionality of the preferred embodiments of the present invention will work when IP is encapsulated in protocols that generally are not considered to be level two, data link layer protocols. Some non-limiting examples of other protocols capable of carrying IP datagrams include those used for tunneling and VPNs such as, but not limited to, GRE (Generic Routing Encapsulation), PPTP (Point-to-Point Tunneling Protocol), L2F (Layer 2 Forwarding), L2TP (Layer 2 Tunneling Protocol), and IP Sec (IP Secure). Some of these protocols encrypt the data or information encapsulated within the protocol. To work properly NAT devices should be able to read the IP datagrams and generally translate the IP addresses and/or port numbers. Thus, either the information to be translated in the IP datagrams should be communicated over the network in an unencrypted form, or the NAT device should have the proper encryption/decryption keys to decrypt the IP datagrams, make the necessary translations, and if needed encrypt the resulting IP datagrams.

Cable Modem Network Architecture

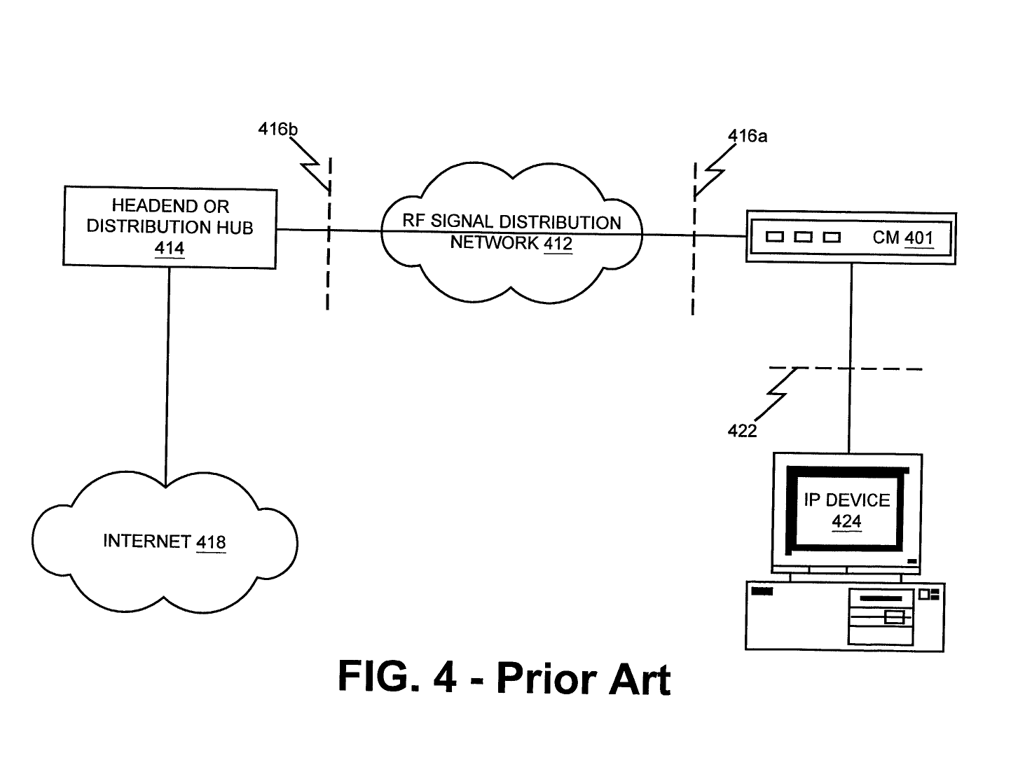

FIG. 4 shows an architecture model for connecting cable modems (CMs) over a cable network. This architecture in FIG. 4 generally follows the architecture and terminology of the Data-Over-Cable Service Interface Specification (DOCSIS) reference architecture. DOCSIS is a set of standards that are commonly used for cable modems (CMs). Although the specification of this present application often refers to DOCSIS, this specification is not intended to limit the embodiments of the invention to apply only to DOCSIS cable modem systems. The description of the preferred embodiments of the present invention uses DOCSIS cable modem systems as a non-limiting example of how the preferred embodiments of the present invention might be implemented in order to operate in a cable modem system. Thus, the references to DOCSIS in the specification of this patent application are only used as a non-limiting example. Furthermore, the references to DOCSIS are intended to cover not only current and past DOCSIS standards, but also future DOCSIS standards that have not substantially changed the functionality of the features of DOCSIS cable modems and/or interfaces that are described herein and are relevant to the embodiments of the present invention.

Cable modem (CM) 401 is connected through radio frequency (RF) signal distribution network 412 to headend or distribution hub 414. In DOCSIS and most specifications for communicating digital computer data over cable RF distribution networks, the headend or distribution hub 414 contains a controller device that terminates the RF cable connections to the cable modems. In DOCSIS this device is called a cable modem termination system (CMTS).

In most RF cable data communication networks such as, but not limited to DOCSIS, this controller or CMTS is a centralized concentrator that shares a data link connection over the RF cable with one or more cable modems. In general, the CMTS and the cable modems (CMs) share one instance of a Media Access Control (MAC) protocol. Often the central controller or CMTS performs bridging, switching, and/or routing functions. (Here the switching generally refers to packet, frame, and/or cell switching as opposed to circuit switching.) These functions of the centralized controller or CMTS may use store-and-forward and/or cut-through processing of packets. In general, store-and-forward networking devices receive an entire packet and check the entire packet for errors before forwarding the packet based on some address or identifier information in the packet. In contrast, devices using cut-through-processing generally only look at the address or identifier information in the header or towards the beginning of the packet. Then the cut-through devices may start forwarding the bits of the packet even before the entire packet has been received.

In general, data links between network devices do not contain intervening devices such as, but not limited to, bridges, switches, and/or routers that generally make decisions about forwarding packets based upon one or more addresses or identifiers in the packets. (Again this use of the term switches generally is for data switching devices such as, but not limited to, packet, frame, and/or cell switches and generally does not include circuit switches. After a circuit switch establishes a connection or path through the network, circuit-switches generally are not involved in the level two, data link functions. Instead, after the circuit is created, bits are passed through a circuit switch that generally behaves more like a layer 1 repeater than a layer 2 packet, frame, or cell switch.) Thus, the data link between one or more cable modems and a centralized controller or CMTS at a headend or distribution hub generally does not include intervening devices that operate on layers 2 through 7 of the OSI model.

However, the data link between a centralized controller or CMTS and one or more cable modems may include various OSI layer 1 (or physical layer) devices and/or combinations thereof such as, but not limited to, repeaters, amplifiers, attenuators, media converters, modulators, demodulators, baluns, electrical-optical converters, etc. (In general, a balun or balanced/unbalanced converter is an impedance matching device used to connect balanced cabling to unbalanced cabling. Also, circuit switches generally function as layer one devices such as repeaters once the circuit is connected.) In fact, for hybrid fiber-coax (HFC) systems that are commonly used for RF cable networks, a central controller or CMTS generally may have a fiber connection to the HFC network at a headend or distribution hub. Thus, the central controller or CMTS may generate optical signals. Then the HFC network uses various physical layer devices to deliver a signal that eventually is in an electrical format on the RF cable network and is received by one or more cable modems.

Those skilled in the art will be aware of many different types of physical layer devices and will be aware of the differences between OSI level 1, physical layer devices and devices that operate at other levels of the OSI model such as, but not limited to level 2, data link layer devices. Generally, OSI level 1 physical layer devices do not divide networks into multiple data links or multiples instances of a MAC protocol. A network containing one instance of a MAC protocol can be segmented into two instances of a MAC protocol by inserting a device such as, but not limited to, a two port, layer 2 bridge into the network. For example, in a CSMA/CD (Carrier Sense Multiple Access with Collision Detection) or ethernet network, the insertion of a bridge would segment or divide the network so that some devices on a first side of the bridge utilize a first instance of the CSMA/CD MAC protocol while other devices on a second side of the bridge utilize a second instance of the CSMA/CD protocol. In CSMA/CD or ethernet these instances of the MAC protocol are known as collision domains.

Because responsibility for maintaining communication networks and equipment is often divided based on physical ownership of the equipment or physical location of the equipment, the lines of demarcation for equipment ownership and/or responsibility between network service providers and customers are often called user-network interfaces. User-network interfaces have protocols, procedures, and specifications for the user-side, the customer-side, the subscriber-side, or in this case the cable modem-side of the interface. Furthermore, user-network interfaces have protocols, procedures, and specifications for the network-side, the service-provider-side, or in this case the headend-side or the CMTS-side of the user-network interface.

The connection of cable modem 401 to RF signal distribution network 412 is through interface 416a, which in DOCSIS is called the CM to RF cable interface (CM RFI), while the connection of the headend or distribution hub 414 (or equipment within the headend or distribution hub such as a CMTS) to the RF signal distribution network 412 is through interface 416b, which in DOCSIS is called the CMTS RF cable interface (CMTS RFI). Interface 416a is closer than interface 416b to the user-side or end of the RF signal distribution network 412. Interface 416b is closer than interface 416a to the network-side of the RF signal distribution network 412. Cable modems 401 generally should obey user-side rules and/or procedures for connecting to interface 416a, while headends or distribution hubs 414 generally should obey network-side rules and/or procedures for connecting to interface 416b.

For many deployed RF signal distribution networks, the customer-side or subscriber-side of the RF signal distribution network 412 uses coaxial (or coax) cable. In contrast, the headend-side or network-side of RF signal distribution network 412 often connects using fiber optical transmission equipment. Thus, RF signal distribution network 412 is commonly called a hybrid fiber-coax or HFC network. The properties of this RF signal distribution network 412 are chosen by designers based at least upon the bandwidth demands of the information carried over the network and the distance from the headend or distribution hub to the customer or subscriber premise.

Often RF distribution network 412 uses the same network as that used to carry CATV signals. However, RF distribution network 412 for cable modems 401 does not have to use the same RF distribution network as the CATV network. Cable TV or CATV (Community Antenna TV) signals have historically been distributed by frequency-division multiplexing (FDM) many analog TV signals onto a CATV RF distribution network. As digital technology has evolved, the CATV networks have transmitted more and more digital information through the CATV RF distribution network. This digital information is often time-division multiplexed (TDM) into the RF distribution network. Depending on cost, bandwidth, and performance considerations, a customer premise might actually be connected to separate RF distribution networks for CATV access and for cable modem access. Still, for most networks it is expected that RF signal distribution network 412 will carry both CATV signals and signals for cable modem data access.

FIG. 4 further shows that general access to the internet 418 is connected to headend or distribution hub 414. Also, cable modem 401 is connected to a communications medium in or at the customer premises that has an interface 422 as shown in FIG. 4. This communications medium and interface 422 connect to customer premise equipment (CPE) such as IP device 424. This customer premise communication medium defines an interface 422 between the cable modem 401 and the IP device 424. In DOCSIS this interface 422 is known as the cable modem to CPE (customer premise equipment) interface (CMCI). Normally, in a cable data network information flowing in the direction from the headend or distribution hub 414 towards the customer premise is known as a downstream information flow, while information flowing in the opposite direction (i.e., from the customer premise towards the headend or distribution hub) is known as an upstream information flow.

Customer Premise Communications Media

Many types of technologies are possible for distributing signals carrying information within a customer premise. The signals used in modem communications systems usually encode data or information using systematic modifications of electromagnetic waves. For a communications receiver to properly recover the information encoded in an electromagnetic wave by a transmitter, the information carried by the electromagnetic wave generally should be separated by space, frequency, and/or time from other electromagnetic waves that might interfere with the electromagnetic wave carrying the communications signal between the transmitter and the receiver.

The separation of electromagnetic waves carrying communications signals by space normally involves constraining a large portion of the energy of the signal within a spatial locality that usually is known as the communications medium or media. For wired communications a significant proportion of the energy of an electromagnetic wave is constrained within the physical medium. This definition of wired communication media that constrain electromagnetic waves includes, but is not limited to, metal conductors, metallic wave guides, and optical conductors or wave guides (i.e., fiber optics). For wireless communications no tangible communications cable exists as the medium. However, for wireless communications the energy of the electromagnetic wave carrying the communications signals is constrained by the attenuation of the transmitted signal as the distance from the source or transmitter increases. Thus, a communications medium generally includes some spatial limit wherein most of the energy of an electromagnetic signal is contained. Often the technologies for communications depend on the distance limitations of a communications medium before a communications signal is attenuated to the point at which the information that the signal contained cannot be recovered.

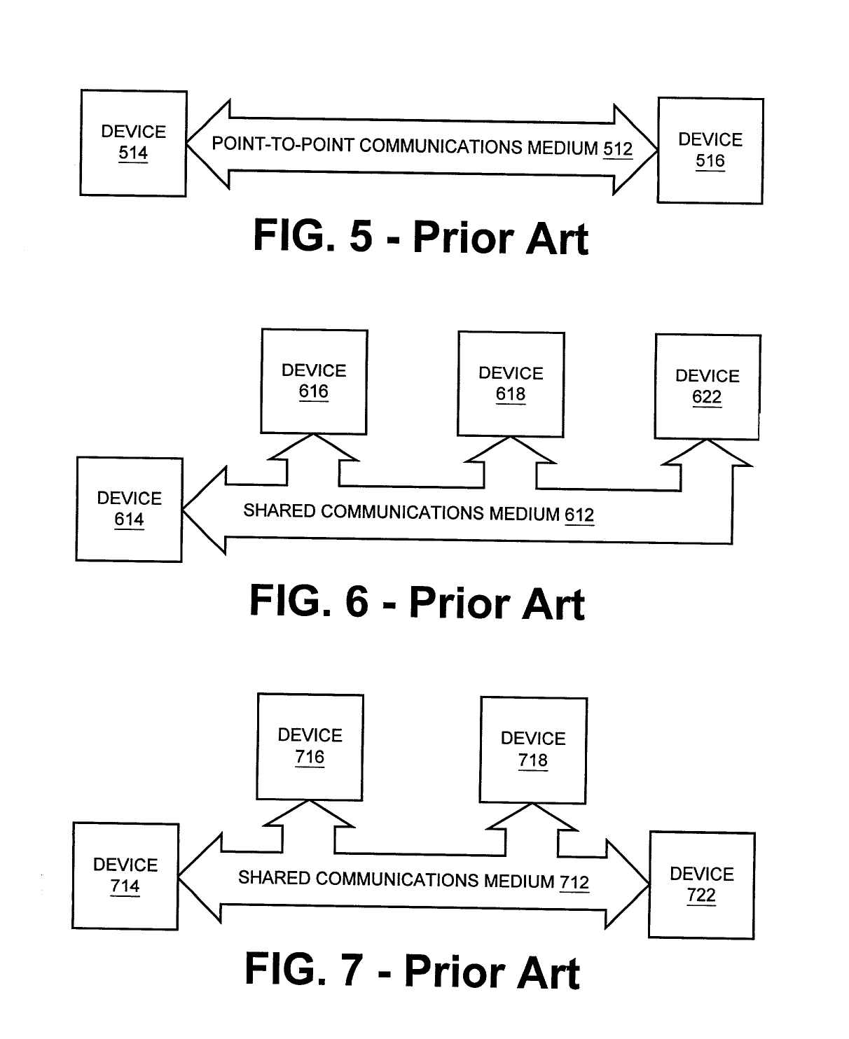

Within a communications medium, electromagnetic waves carrying communications signals can be separated by frequency and/or time. Separation of multiple communications signals by frequency generally is called frequency-division multiplexing (FDM), while separation of multiple communications signals by time generally is called time-division multiplexing (TDM). Within a communications medium and within a range of frequencies, there are many ways to handle the time allocation between devices connected to the communications medium and operating at the same frequencies. FIGS. 5-7 and the explanation below are non-limiting examples of some of the common ways to deal with allocating time for devices to transmit on a communications medium.

FIG. 5 shows point-to-point communications medium 512 connected between communications devices 514 and 516. In general, there are no problems with conflicts over the use of the media in point-to-point media. A point-to-point medium is a medium connected between two devices. In a uni-directional point-to-point link, a transmitter in a first device communicates in a forward direction with a receiver in a second device. In a bi-directional point-to-point link, a transmitter in a first device communicates in a forward direction with a receiver in a second device, and a transmitter in the second device communicates in a reverse direction with a receiver in the first device. For many bi-directional point-to-point communications links, the communications from device 514 to device 516 uses a different time and/or frequency than the communications from device 516 to device 514. Also, a point-to-point communications medium should not be confused with the internet Point-to-Point Protocol (PPP), which generally functions in a point-to-point manner but may operate over several different types or forms of communications media. Also, sometimes a bi-directional point-to-point link can be implemented even though the devices on both ends of the communications medium transmit at the same time and using the same frequencies. As a non-limiting example, this situation occurs in the phone network where the direction of propagation of the electromagnetic waves determines which device on the bi-directional link transmitted the electromagnetic waves.

In contrast to the point-to-point communications medium 512 in FIG. 5, the shared communications medium 616 in FIG. 6 has more than two devices connected to the medium. A communications medium shared by a number of devices contending for access is often called a shared medium, a contention medium, a broadcast medium, or a multi-point medium. It is often called a broadcast medium because even though generally only one device can transmit on the medium at a specific time and frequency, many devices could potentially receive a broadcast frame on the medium at a specific time and frequency. For instance, if device 614 transmitted a communications signal onto shared communications medium 612, then devices 616, 618, and 622 all potentially could listen to the transmitted communications signal.

For shared or contention communications media, various rules are used for specifying which device of multiple devices can transmit and/or receive at a specific time and/or frequency on the shared communications medium. These rules for controlling access to the shared medium are often called media access control or MAC protocols. (In general, a MAC protocol also may control access to a point-to-point communications medium; however, the MAC protocol for a point-to-point communications medium is often more simplified than a MAC protocol for a shared communications medium.) One method for controlling or arbitrating which devices can use a shared communications medium at a specific time is to use a centralized algorithm that generally is executing on a controller or master device. As a non-limiting example, assume that device 614 is a controller or master for devices 616, 618, and 622 connected to shared communications medium 612. Devices 616, 618, and 622 are often called slave devices and generally can use the shared communications medium 612 only when given permission by the master or controller, which is device 614.

Another method for controlling which devices can use a shared communications medium at a specific time is to use an algorithm that generally is distributed among the devices sharing the medium. FIG. 7 shows shared communications medium 712 where devices 714, 716, 718, and 722 each execute a distributed algorithm to determine which devices may use the shared communications medium at a specific time. Devices 714, 716, 718, and 722 may all execute the same algorithm such that they contend as peers for access to the shared communications medium 712. Alternatively, devices 714, 716, 718, and 722 may execute varied algorithms that provide higher priority for some of the devices. In general, there is a spectrum of many possible different MAC algorithms ranging from a peer-to-peer algorithm to a master-slave algorithm.

In addition to using the dimensions of space, time, and/or frequency to separate communications signals carried by electromagnetic waves to prevent interference and allow the receiver to recover the original information, the method of encoding information in the carrying signals also can be used to allow the receiver to recover the originally transmitted information. One method of accomplishing this information encoding is used in Code Division Multiple Access (CDMA), which utilizes spread spectrum techniques and distinguishes messages from each other using code identifiers. CDMA is generally classified as a direct sequence spread spectrum technique. CDMA and other spread spectrum techniques (such as, but not limited to, direct sequence and/or frequency hopping techniques) are well-known in the art and may be used on the customer premise communication medium. Although the various spread spectrum techniques and technologies are commonly used for wireless communications that are not constrained to a physical or tangible communications medium, these spread spectrum techniques and technologies also could be used on wired or wireline communications media that generally constrain signal energy within the wired transmission line.

Other than specific limitations in the claims, the communications media used for carrying communication signals within the subscriber or customer premises are not limited in this present application. Some non-limiting examples of common communications media that might be used for connecting customer IP devices are discussed below.

There are many technologies that may be used for connecting equipment in the customer premise. Because a customer premise usually identifies certain spatial limitations where the communications signals should be transmitted, often the technologies used for communications media in a customer premise are designed to generally match these spatial or distance limitations. Therefore, technologies for communicating signals for a few to many miles are not commonly considered as potential communications media for distributing signals within a customer premise. Although these “longer distance” technologies would operate properly within a customer premise, they usually are too costly to utilize for customer premise communications media. One method of categorizing communication systems is based on the distance over which they operate. In general, LANs (Local Area Networks) are used over a relatively small area in or at a customer premise such as a building; MANs (Metropolitan Area Networks) are used over a larger area such as within a city or town; and WANs (Wide Area Networks) span the largest area such as a nation or the entire world.

Some wired point-to-point technologies that may be used for customer premise communications media include, but are not limited to, RS-232, RS-449, and V.35. RS-232 is an old standard that commonly was used for connecting analog POTS modems to computers and for other relatively slow speed connections. RS-449 and V.35 support higher data rates than RS-232 and have been used for interfacing data equipment to T1 CSU/DSUs (Channel Service Units/Data Service Units). The T1 data rate of 1.536 Mbps is relatively close to the maximum data rate of some cable modems, so RS-449 and V.35 could directly operate at the speeds of current cable modems.

Also, some protocols commonly are used to encapsulate the IP datagrams for transmission over point-to-point communications media. Two of the most common, non-limiting, example protocols for this encapsulation are SLIP (Serial Line Internet Protocol) and PPP (Point-to-Point Protocol). In general, SLIP was designed just to support the encapsulation of IP datagrams whereas PPP is a more general protocol that negotiates various link settings, negotiates settings for one or more Network Control Protocols (NCPs), and encapsulates the data from other protocols into PPP NCP frames. The PPP protocol may carry IP datagrams in at least the following two frame types: IPCP (Internet Protocol Control Protocol) frames and/or BNCP (Bridging Network Control Protocol) frames. The PPP IPCP protocol negotiates some IP settings and carries IP datagrams within PPP frames. The PPP BNCP protocol negotiates some LAN level settings and may carry IP datagrams within ethernet frames that are encapsulated in PPP. Furthermore, using other encapsulation methods IP datagrams might carried inside of other types of NCP frames within PPP. Thus, a non-limiting example of a customer premise communications medium would be a V.35 physical connection between an IP device and a cable modem with NAT or a set-top box with cable modem functionality and NAT. A cable modem with NAT and/or a set-top box with cable modem functionality and NAT might communicate with an IP device using PPP IPCP frames that carry IP datagrams.

Furthermore, the shared media of internal and/or external computer buses as well as the shared media of LANs are some non-limiting examples of wired media for connecting an IP device to a cable modem with NAT or to a set-top box with cable modem functionality and NAT. Universal Serial Bus (USB) and FireWire (a.k.a. IEEE 1394) are two non-limiting examples of external serial buses that allow the connection of multiple devices and might be used to connect an IP device to a cable modem with NAT or to a set-top box with cable modem functionality and NAT. The DOCSIS Cable Modem to Customer Premise Equipment Interface Specification (DOCSIS CMCI) describes one potential use of USB to connect a DOCSIS cable modem to a single IP device. However, DOCSIS CMCI does not disclose using USB to connect an IP device to a cable modem with NAT or to a set-top box with NAT capabilities. Also, DOCSIS CMCI specifies the use of the USB Ethernet Networking Control Model or the USB Abstract Control Model to carry ethernet frames. Although not described in DOCSIS CMCI, it is certainly possible to use PPP over USB between an IP device and a cable modem with NAT or a set-top box with cable modem functionality and NAT. As non-limiting examples, the PPP frames might carry IP datagrams in IPCP and/or in BNCP. This use of PPP over USB is not specified in DOCSIS CMCI. However, a cable modem or set-top box with NAT capability that uses PPP over USB to interface with an IP device still may appear DOCSIS-compliant on the RF cable interface.

In addition to external buses, internal computer buses such as, but not limited to, the AT/ISA (Advanced Technology/Industry Standard Architecture) bus and/or the PCI (Peripheral Component Interconnect) bus might be used to connect an IP device to a cable modem or set-top box with NAT capabilities. Because of the limited distance of these internal buses, data is often transferred in parallel across multiple lines in the bus. Although DOCSIS CMCI describes a PCI cable modem, it does not cover integrating NAT into a cable modem and/or into a set-top box. Also, as described in this specification, a cable modem with NAT or a set-top box with cable modem functionality and NAT will work with the communications media of wired LAN technologies such as, but not limited to, token ring and/or CSMA/CD (Carrier Sense Multiple Access with Collision Detection) ethernet that may connect one or more IP devices to a cable modem with NAT or to a set-top box with cable modem functionality and NAT. CSMA/CD and other CSMA MAC protocols generally are peer-to-peer oriented with each device on the contention medium basically performing the same MAC access procedures as part of a distributed MAC algorithm.

In addition to the possible types of wired customer premise communications media that are discussed in the preceding sections, most customer premises already are wired with two transmission lines. These common transmission lines are the analog POTS telephone line and the power line. Historically, both these transmission lines were used to connect customer premises up to telephone central offices and to power company distribution networks, respectively. More recently, these transmission lines have been considered for use as communications media for distributing information within a customer premise. In general, both phoneline and powerline technologies often use some variations of frequency-division multiplexing (FDM) to communicate information on the same communications media that is carrying analog POTS signals or electrical power signals, respectively.

An analog POTS line normally distributes 4 KHz analog POTS signals through a customer premise that commonly is a residential dwelling. All the bandwidth of an analog POTS line within a customer premises is not used for analog POTS communications. This unused bandwidth may be used to carry other information such as, but not limited to, the communications between an IP device and a cable modem with NAT or a set-top box with cable modem functionality and NAT. For example, the frequencies outside the POTS voice channel baseband, which basically exists from 0 to 4 KHz, might be used for carrying signals between an IP device and a cable modem with NAT or a set-top box with cable modem functionality and NAT. In addition, during the time that the phone line is not being used for POTS calls, the entire spectrum of the POTS wiring within a customer premise generally is available for use by communications between at least one IP device and a cable modem with NAT or a set-top box with cable modem functionality and NAT. Thus, a phoneline communications device might detect the state of the analog POTS line with respect to analog POTS telephone calls. During the time that the phoneline is not used for POTS phone calls, the entire spectrum might be used for customer premise communications.

The Home Phoneline Networking Alliance (HomePNA or HPNA) has developed some standards for using telephone lines as a communication medium for carrying data within a customer premise. HPNA 1.0 supports 1 Mbps data rates, while HPNA 2.0 supports 10 Mbps data rates. A cable device with integrated NAT such as a cable modem or a set-top box with cable modem functionality will work using one or more versions of HPNA or any other phoneline networking technology to connect an IP device to a cable modem with NAT or to a set-top box with cable modem functionality and NAT. The cable modem or set-top box still can be designed to appear on the RF cable interface as no different than a cable modem with an ethernet connection to an IP device.

A power line normally distributes alternating current (A.C.) electrical power at 50 Hz (Europe) or 60 Hz (United States) within a customer premise. In general, the use of power lines for communications often involves using some form of frequency-division multiplexing (FDM) to communicate information on the powerline in addition to the 50 Hz or 60 Hz A.C. power carrying signal. In addition, some powerline protocols transmit during the zero voltage crossing time when the magnitude of the sinusoidal alternating current (A.C.) signal is at a minimum. One of the older powerline communications technologies is X. 10, which is mainly used to carry a small amount of information for home automation tasks such as, but not limited to, turning a light on or off. Newer powerline communications technologies and/or products include, but are not limited to, Consumer Electronics Bus (CEBus) and PowerPacket™. Actually, CEBus is defined to work over powerlines, telephone line twisted pair, coax cable, and RF wireless. However, CEBus is most commonly used over powerlines. CEBus uses a CSMA/CDCR (Carrier Sense Multiple Access with Collision Detection and Collision Resolution) MAC protocol. Some of these technologies use various spread spectrum techniques to efficiently use the powerline communications media. The HomePlug Powerline Alliance is one organization that works on developing standards for powerline networking.

A cable device with integrated NAT such as a cable modem or a set-top box with cable modem functionality will work using a powerline communications media to connect an IP device to a cable modem with NAT or to a set-top box with cable modem functionality and NAT. The cable modem or set-top box still can be designed to appear on the RF cable interface as no different than a cable modem with an ethernet connection to an IP device.

Furthermore, wireless technologies also could be used to connect one or more IP devices to a cable modem with NAT or to a set-top box with cable modem functionality and NAT. Generally, wireless technologies can be categorized into infrared and radio frequency (RF) technologies, and wireless RF can be further categorized into narrow band and spread spectrum. Infrared technologies such as, but not limited to, IrDA (Infrared Data Associates) often are constrained to line-of-sight communications. Also, infrared communications commonly are used for the hand-held remote controls of set-top boxes and might be used for some applications of connecting IP devices to a cable modem with NAT or to a set-top with cable modem functionality and NAT.

Some examples of RF wireless technologies that might be used for communications in a customer premise include, but are not limited to, IEEE 802.11a, IEEE 802.11b, DECT, HomeRF, and Bluetooth. IEEE 802.11a and IEEE 802.11b also are known as wireless ethernet standards and use a Carrier Sense Multiple Access with Collision Avoidance (CSMA/CA) MAC protocol. In general, the IEEE 802.11 working group is responsible for developing some Wireless Local Area Network (WLAN) standards. The IEEE 802.11 standards define several different physical layers including, but not limited to, both frequency hopping and direct sequence spread spectrum techniques as well as baseband infrared techniques. IEEE 802.11a uses Orthogonal Frequency Division Multiplexing (OFDM), while IEEE 802.11b uses a direct sequence spread spectrum methodology. IEEE 802.11b also is known by the name of Wireless Fidelity (Wi-Fi), which is similar to the naming method of High Fidelity (Hi-Fi) used for stereo sound. Furthermore, the Wireless Ethernet Compatibility Alliance (WECA) is an organization that certifies compatibility of equipment with at least some of the IEEE 802.11 wireless ethernet standards.

DECT or Digital Enhanced Cordless Telecommunications is a Time Division Multiple Access (TDMA) wireless system that mainly has been used for digital cordless telephones within a home. Generally, DECT has a master-slave-like allocation process where a Fixed Part (FP) unit such as, but not limited to, a base station communicates with a Portable Part (PP) unit such as, but not limited to, a cordless phone.

HomeRF is another working group that develops wireless communication standards that include the Shared Wireless Access Protocol (SWAP). The HomeRF SWAP protocol uses a frequency hopping spread spectrum physical layer and a MAC layer that both supports time division multiple access (TDMA) for isochronous services such as, but not limited to voice, and supports CSMA/CA for asynchronous data services. HomeRF provides for the following three types of information service flows: 1) asynchronous packet data, 2) prioritized, connection-oriented streaming data, and 3) isochronous, full-duplex, symmetric information such as that used for voice in the DECT standards. Thus, HomeRF incorporates some of the DECT standards.

Bluetooth is yet another wireless technology that was originally designed for the purpose of physical cable replacement. For example, Bluetooth was originally considered as a replacement for the myriad of physical cables currently used for interconnecting devices such as, but not limited to, printers, personal digital assistants (PDAs), desktop computers, fax machines, keyboards, joysticks, and/or mice. However, the uses of Bluetooth now have grown so that it might be considered for other forms of wireless data connectivity within a customer premise. Bluetooth uses a TDMA architecture and generally has a master-slave relationship.

Any and all of these previously described customer premise communication media technologies might be used for communications between an IP device and a cable modem with NAT or a set-top box with cable modem functionality and NAT. In addition, those skilled in the art will recognize that other existing and not yet developed technologies also might be used to connect an IP device to a cable modem with NAT or to a set-top box with cable modem functionality and NAT. In general, the embodiments of the present invention will work with any communications media and protocols used at or within the customer premise. A cable modem with NAT or a set-top box with cable modem functionality and NAT may utilize various customer premise communications media and still appear on the cable RF interface to be no different than a DOCSIS cable modem connected to an ethernet communications medium at or within the customer premise.

DOCSIS Cable Modems

The DOCSIS radio frequency interface (RFI) specification and the DOCSIS cable modem to customer premise equipment interface (CMCI) specification are both important in defining the behavior of DOCSIS cable modems over RF cable connections. Furthermore, the DOCSIS RFI specification has two versions. DOCSIS RFI 1.0 provides for basic communications over an RF cable connection for DOCSIS cable modems. Version 1.1 of DOCSIS RFI adds many ATM-like (Asynchronous Transfer Mode) capabilities with an unsolicited grant service (UGS) that provides the necessary quality of service (QoS) for constant bit rate (CBR) applications.

The following four DOCSIS standards documents are incorporated by reference into this application: 1) Data-Over-Cable Service Interface Specifications—Radio Frequency Interface Specification—SP-RFI-I05-991105 (DOCSIS RFI 1.0), re-released for publication on Nov. 5, 1999; 2) Data-Over-Cable Service Interface Specifications—Radio Frequency Interface Specification—SP-RFIv1.1-I06-001215 (DOCSIS RFI 1.1), re-released for publication on Dec. 15, 2000; 3) Data-Over-Cable Service Interface Specifications—Cable Modem to Customer Premise Equipment Interface Specification—SP-CMCI-I05-001215 (DOCSIS CMCI), published on Dec. 15, 2000; and 4) Data-Over-Cable Service Interface Specification—Cable Modem Telephony Return Interface Specification—SP-CMTRI-I01-970804 (DOCSIS CM TRI), released for publication on Aug. 4, 1997. These DOCSIS documents may be found at the web site of CableLabs® (http://www.cablelabs.com) and specifically at the cable modem project web site (http://www.cablemodem.com) of CableLabs®.

Furthermore, DOCSIS RFI 1.0 and RFI 1.1 specify the interaction between cable modems (CMs) and cable modem termination systems (CMTSes) during cable modem initialization. As part of the initialization of DOCSIS compliant cable modems, the cable modem establishes IP connectivity by dynamically obtaining an IP address through DHCP. DOCSIS cable modems use this assigned IP address for communicating with equipment in the service provider's network generally for the purpose of establishing operational capabilities and facilitating network management and trouble-shooting. For example, after obtaining an IP address, a DOCSIS CM may use the IP address and the trivial file transfer protocol (TFTP) to download operational settings or parameters from a TFTP server. Thus, if a cable modem follows the DOCSIS standards, then it is also an IP device with an IP address being assigned by the DOCSIS CMTS for configuration and management. However, the IP address assigned to a cable modem need not necessarily come from the same subnet as the IP addresses assigned to other customer or subscriber devices.

At the MAC level DOCSIS RFI version 1.0 defines a frame format with a data PDU (packet data unit) that may comprise a packet data PDU or an ATM data PDU. In general, packet data PDUs may be 1518 octets (or bytes) in size. In communications the term octet is often used instead of byte to refer to a quantity of eight bits. The 1518 octets include a six octet (48 bit) destination address, a six octet (48 bit) source address, a two octet type or length field, a four octet cyclic redundancy check (CRC) or frame check sequence (FCS), and 0 to 1500 octets of user data. Thus, a DOCSIS packet data PDU comprises many of the same fields as an ethernet version 2.0 frame. Similarly to CSMA/CD (Carrier Sense Multiple Access with Collision Detection) networks such as ethernet, a DOCSIS packet data PDU also may contain the information from an IEEE 802.3 frame, optionally including 802.2 LLC (Logical Link Control) information. In addition, the packet data PDU in DOCSIS RFI 1.0 will support packet data PDUs of up to 1522 octets (or bytes) needed for IEEE 802.1 Q VLAN tagging. Also, DOCSIS RFI 1.0 supports an ATM PDU capable of carrying an integer multiple of ATM cells of 53 octets (i.e., n×53 octets). However, the MAC definition in DOCSIS RFI 1.0 does not specify procedures for fragmenting frames containing user data larger than 1500 octets in order to bridge the information contained in such frames from an interface connected to customer premise equipment onto a DOCSIS RFI 1.0 interface in packet data PDUs.

Like the DOCSIS RFI 1.0 specification, the DOCSIS RFI 1.1 specification includes packet data PDUs that are capable of carrying the information from ethernet/802.3 frames. However, the MAC frame format specification has some differences. First, the ATM cell PDU is supposed to be skipped over in DOCSIS RFI 1.1. In addition, DOCSIS RFI 1.1 provides mechanisms for fragmenting MAC frames that have too much data to fit into the 1500 octets for user data in a packet data PDU.

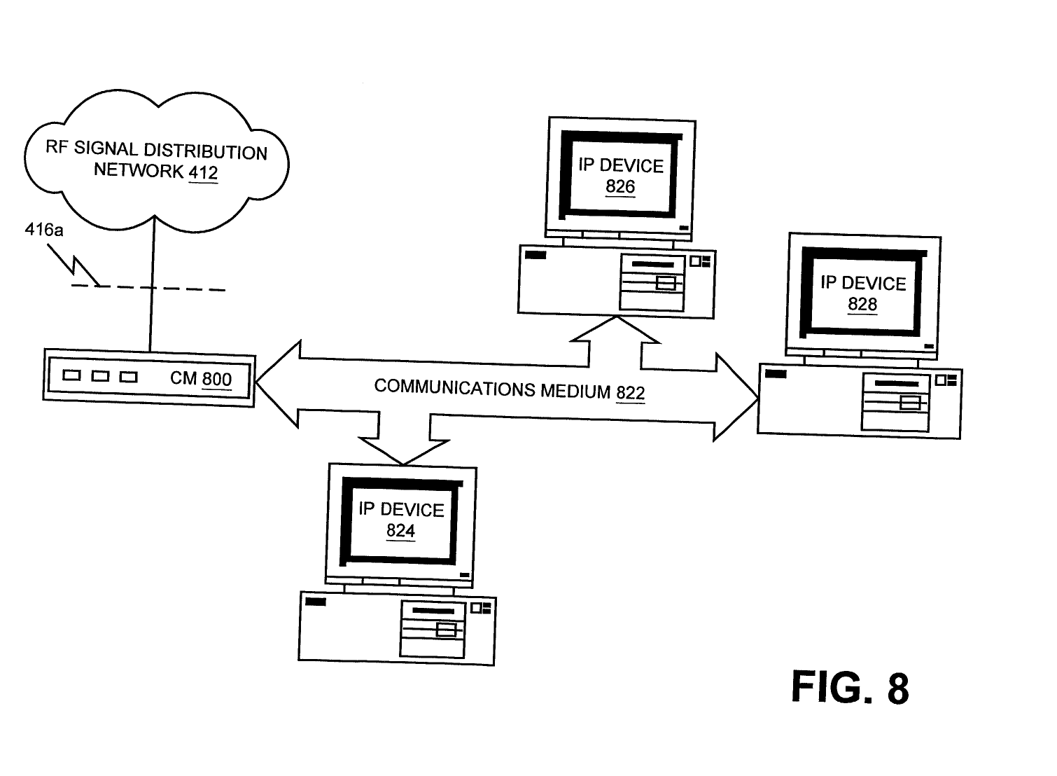

As defined in the DOCSIS RFI 1.0, RFI 1.1, and CMCI standards, DOCSIS cable modems (CMs) generally forward packets or frames over the RF cable connection based on the transparent, link layer bridging procedures of IEEE 802.1D that describes the functionality of layer two bridges. These transparent bridging procedures are slightly modified in the DOCSIS standards. In addition, some DOCSIS-compliant cable modems may use a telephone return upstream data path instead of an RF return upstream data path. According to the DOCSIS cable modem telephony return interface (CM TRI) specification, this return path should use network layer routing instead of transparent link, layer bridging. Also, although the detailed description of FIGS. 8-18 only covers RF return upstream data paths for cable modems or devices with cable modem functionality, nothing prevents the embodiments of the present invention from being used with an RF downstream data path and a telephone return upstream data path.

Other Cable Modems

Although this document references the DOCSIS cable modem standards, nothing in the present description is intended to limit the embodiments of the present invention only to cable modems and set-top boxes that conform to DOCSIS. Many of the concepts described herein will be applicable to other cable modem and set-top box technologies and/or standards such as, but not limited to, the Digital Audio-Visual Council (DAVIC) standards that have primarily been used more in Europe than in North America. Specifically, this document incorporates by reference the two following documents from the DAVIC 1.5 Specification: 1) DAVIC Intranet Technical Platform Specification (Provisional Document Structure) Revision 1.0, dated Apr. 12, 1994 and 2) DAVIC Cable Modem (Technical Specification) Revision 3.1, dated Nov. 6, 1998. DAVIC has now disbanded, and DAVIC standards have been taken over by the International Standards Organization.

Forwarding Models or Constructs

Communications devices are often generally divided into the two common constructs (or theoretical models of operation) of bridges, which generally operate at layer two of the OSI model, and routers, which generally operate at layer three of the OSI model. In general, the bridge construct operates using at least some of the following processes. First, bridges (i.e., a device operating using a bridge construct) forwards packets or frames based upon MAC address. Next, a device operating using a bridging construct usually does not translate or change MAC or data link addresses of packets when it forwards the packets through the device. Many bridges dynamically learn the location of devices and corresponding MAC addresses in the network. After dynamically learning this information, bridges generally maintain tables that allow forwarding decisions to be based upon the dynamically learned location of the devices and corresponding MAC addresses. Though not the only type of bridges, the type of bridge described above is known as a transparent, learning bridge. The bridge is transparent to the devices in the network because the devices generally may communicate packets or frames across the bridge transparently without being aware that the bridge is in the network. To provide this transparency and allow full connectivity through a bridge, the data link or MAC addresses should be unique within the bridged portion of a network (i.e., within the portion of the network over which MAC addresses are not translated or exchanged by network devices such as, but not limited to, routers). Within the context of a network where MAC addresses are not translated or exchanged by network devices such as, but not limited to, routers, the MAC addresses of each device in the network generally should be different (i.e., unique) from the MAC addresses of every other device in the network so that a particular network device may be selected by it MAC address.

In contrast, devices following the router construct or model generally make packet or frame forwarding decisions based upon the destination network address of the packet. Routers generally do change the source and/or destination MAC addresses of packets or frames that are forwarded across a router. For example, in general when packets are forwarded across a router, the source MAC address of a packet or frame is replaced with a MAC address of the router, and the destination MAC address is replaced with a value determined by the router as part of its forwarding algorithm. Based upon the destination network address, routers determine the next location to which a packet should be forwarded. To forward packets across some communications media that use MAC addresses, a router should determine the MAC address to which the packet should be forwarded in the communications media. Usually, routers maintain tables that contain a mapping between network addresses and MAC addresses. These tables may be created statically or dynamically through protocols such as, but not limited to, the Address Resolution Protocol (ARP). Because ARP is one of the most common protocols for dynamically creating this mapping table that relates network addresses to MAC addresses, the table is often called an ARP cache. In effect ARP operates by asking communication devices connected to a communications medium to inform the requesting device of the MAC address corresponding to a network address. Generally, based on the information in the ARP cache, a router device populates the destination MAC address field of the outgoing packet and forwards the packet on towards its destination.

Unlike devices connected through only transparent bridging, devices in a routed network should be somewhat aware of the routing configuration of the network. Even devices that are not acting as routers make decisions on sending packets based on whether the destination network device is on the same subnetwork or subnet. If the destination device is on the same subnet, then the sending network device generally determines the MAC address of the destination network device by looking up the destination's MAC address in the sending device's ARP cache and when necessary using the ARP protocol to populate the ARP cache with the needed information. If the destination network device is not on the same subnet, then the sending device forwards the packet to a default router or gateway. (Though use of the term “gateway” to describe network layer routers has been deprecated, “default gateway” is still commonly used for describing the default router for IP devices or hosts.)

Bridges generally interconnect communications media that are each running the same frame format. For example a bridge may be connected between two ethernet LANs. Each ethernet LAN operates a separate instance of the distributed algorithm used for controlling access to the shared ethernet medium. For ethernet, this algorithm is known as CSMA/CD (Carrier Sense Multiple Access with Collision Detection). A bridge connection between two ethernets divides the network into two collision domains with each collision domain comprising a set of devices connected to the shared media that are executing one instance of the distributed CSMA/CD algorithm for arbitrating access to a shared communications medium.

Furthermore, each network on either side of a bridge generally has the same frame size. For example, for a bridge interconnecting two ethernet networks, the frame size of each ethernet network generally is 1524 octets. The 1524 octet frame size includes a seven octet preamble and a one octet start frame delimiter leaving 1518 octets for the remaining information in an ethernet frame. Six octets are used for the destination MAC or hardware address, and six octets are used for the source MAC or hardware address. Two octets of the ethernet frame represent a type field, and four octets are used for a frame check sequence for error detection. This leaves 1518−6−6−2−4=1500 octets for user data in ethernet frames. The ethernet frame format is similar to though not exactly the same as the IEEE 802.3 frame format. The Internet Protocol (IP) is usually carried on CSMA/CD networks in ethernet version 2.0 frames and more rarely carried in IEEE 802.3 frames with an 802.2 logical link control (LLC) header and a sub-network attachment point (SNAP) header.

In contrast to the 1500 octets of user data in ethernet, other protocols may have larger or smaller frame sizes. Though bridges may be connected between networks with dissimilar frame sizes, this creates problems in communicating data between the two networks. For instance, FDDI (fiber distributed data interface) has a frame size capable of carrying around 4770 octets of user data. If a bridge interconnects an ethernet network, which has frames capable of carrying up to 1500 octets of user data, to an FDDI network, which has frames capable of carrying up to around 4770 octets of user data, then the allowed maximum transfer unit (MTU) that may be carried between the two networks in a single frame is only 1500 octets of user data. Generally, bridges interconnecting networks with dissimilar frame sizes do not modify the frames to allow large frames from one network to be passed along to another network. Thus, even though bridges may interconnect networks with dissimilar frame sizes, the network devices on each network often have to be responsible for ensuring that the data is contained in packets within the maximum transfer unit (MTU) size, so that the packets may be transferred across the bridge. In contrast, routers generally are capable of fragmenting large packets to allow the data in the large packets to be transferred across networks with relatively small MTUs. As discussed above, DOCSIS RFI 1.1 does include provisions for fragmenting large MAC frames for upstream transmission over the RF cable connection even though the DOCSIS forwarding over the RF cable connection generally follows a transparent bridging process.

Thus, two models or constructs of network connectivity devices are the bridge construct and the router construct. Bridges generally make forwarding and/or filtering decisions based on layer two, data link information and generally may change lower layer characteristics of a packet in forwarding the packet across bridges. Because bridges generally are layer two devices, these OSI lower layers generally comprise layer one (i.e., physical layer) characteristics. As a non-limiting example of changing lower layer characteristics, a bridge might change the layer one (i.e., the physical layer) encoding of information from electrical to optical as a packet is forwarded through the bridge from one communications medium to another. In contrast, routers generally make forwarding and/or filtering decisions based on layer three, network information and generally may change lower layer characteristics of a packet in forwarding the packet across routers. Because routers generally are layer three devices, these OSI lower layers generally comprise layer two (i.e., data link layer) and/or layer one (i.e., physical layer) characteristics. As a non-limiting example of changing lower layer characteristics, a router might change the layer two (i.e., the data link layer) framing from ethernet to token ring and also might change the layer one (i.e., the physical layer) encoding of information from electrical to optical as a packet is forwarded through the bridge from one communications medium to another. Devices that change the information in OSI layers three through seven as packets are forwarded through the devices are commonly called gateways. (This is the more modern definition of the term gateway as opposed to older, deprecated use of the term gateway for layer three routing functions.)

However, these bridge and router constructs are only models and actual network devices for forwarding packets may use various combinations and/or subsets of the functions of bridges and routers. For example, with respect to packet-switching technologies, the term “switch” once generally referred to the functions performed by bridges operating on layer two of the OSI model. However, more recently layer three or IP switches have been developed that generally use the transparent learning algorithms of bridges, but operate like routers on layer three information such as IP addresses. In general, network devices may be divided into two types of equipment: end systems and intermediate systems. End systems generally run user applications, while intermediate systems generally are responsible for forwarding data within the network. Thus, bridges, routers, and switches are some non-limiting examples of intermediate systems.

Also, actual network devices performing as intermediate systems for forwarding packets of data may be configured to use a routing construct for some protocols and to use a bridging construct for other protocols. In addition, the bridging construct and the routing construct generally describe the forwarding behavior between any pair of interfaces on an intermediate system. In other words, the forwarding behavior is often considered with respect to receiving information on one interface and forwarding or not forwarding the information to another interface for transmission. An intermediate system that has more than two interfaces may have various constructs or models for forwarding packets of data that are received on one interface and transmitted on another interface. Thus, for a specific protocol a two interface intermediate system may have one possible forwarding model between the two interfaces. For a specific protocol a three interface intermediate system may have three possible forwarding models between each pair of interfaces.

In general, for an intermediate system with N interfaces, there are N!/[(N−2)!×2!] possible pairs of interfaces with each pair potentially using a different construct for forwarding the data from one interfaces to another interface of a pair of interfaces. This calculation of the number of possible pairs of interfaces is a count of all possible mathematical combinations of N items taken 2 at a time. Furthermore, theoretically an intermediate system may use different forwarding constructs or models for one direction of packet flow than for another direction of packet flow. In other words, one forwarding construct may be used for packets transversing from interface one to interface two, while another forwarding construct may be used for packets transversing from interface two to interface one. For an intermediate system with N interfaces, if the forwarding construct is affected by the direction of packet flow, then the number of choices for forwarding constructs between pairs of interfaces is N!/(N−2)!, which is a count of all possible mathematical permutations of N items taken 2 at a time.

Cable Modem (CM) and Subscriber Network Customer Premise Equipment (CPE)

U.S. Pat. No. 6,178,455 is incorporated by reference herein, is entitled “Router which dynamically requests a set of logical network addresses and assigns addresses in the set to hosts connected to the router”, was filed on Apr. 11, 1997, and issued to Mark E. Schutte and Scott E. Hrastar on Jan. 23, 2001. U.S. Pat. No. 6,178,455 shows one potential embodiment of a cable modem. In general, cable modems have the following items: an RF interface, a receiver for the RF interface, a central processing unit (CPU), some type of storage or memory, an interface to a customer premise communications medium such as ethernet, a transmitter for the customer premise communications medium, and a receiver for the customer premise communications medium. Furthermore, the receiver for the RF interface may comprise a tuner and/or a demodulator. The RF interface receiver is used for downstream communications from a headend and/or distribution hub. In addition, a cable modem has at least one interface and at least one transmitter for upstream communications. If a cable modem uses the RF network for upstream communications, then the RF interface is the upstream communications interface. This type of RF-only cable modem generally has a transmitter for the RF interface. Also, some cable modems have a telco interface for upstream communications. This type of telco return cable modem generally has a transmitter for the telco interface. In addition, a telco return cable modem may have a receiver for the telco interface. This is only one potential embodiment of a cable modem and those skilled in the art will be aware of other possible embodiments.

FIG. 8

FIG. 8 shows a cable modem (CM) 800 connected to RF signal distribution network 412 over a connection that has interface 416a. Furthermore, cable modem (CM) 800 is connected to a communications medium 822 at a customer premise. Also, as shown in FIG. 8, communications medium 822 is further connected to three IP devices 824, 826, and 828. Although FIG. 8 shows CM 800 connected to only communications medium 822 for communicating with customer premise data devices such as IP devices 824, 826, and 828, in general CM 800 may be connected to at least one medium at the customer premise that is further connected to customer premise data devices. Thus, CM 800 may be connected to more than one communications media at the customer premise for communicating with customer premise data devices. Furthermore, if CM 800 is connected to more than one medium for communicating with customer premise data devices, then the multiple media may or may not be the same type of communications media. As a non-limiting example, CM 800 may be connected to some customer premise data devices using a wired ethernet medium and to other customer premise data devices using a wireless medium. In addition, the customer premise data devices also might be processes internal to CM 800. If all the customer premise data devices are internal processes within CM 800, then CM 800 might not have any externally connected customer premise communications media.

In general, cable modem 800 is capable of forwarding many network level protocols. (Under DOCSIS a cable modem generally uses layer two bridging as a forwarding construct between the RF cable interface and communications media connected to customer premise data networking equipment.) Therefore, customer premise data devices generally may utilize any protocol including other protocols instead of or in addition to the Internet Protocol (IP). However, the network address translation (NAT) utilized in some of the preferred embodiments of the present invention generally is used for translating information conforming to the TCP/IP protocol suite. Thus, the customer premises data networking devices in FIGS. 8-18 are shown as IP devices.

IP devices in FIGS. 8-18 (such as IP devices 824, 826, and 828 in FIG. 8) are customer premise data devices that are capable of using at least one variant of the Internet Protocol (IP). These variants include, but are not limited to, IPv4, IPng, and/or IPv6. At most customer premises, IP devices 824, 826, and 828 generally are IP hosts or end systems. However, cable modem 800 also will work if the IP devices are intermediate systems with IP protocol stacks for forwarding IP datagrams and/or user applications such as, but not limited to, network management and configuration. Also, even though IP devices in FIGS. 8-18 are represented pictorially as personal computers, this is only for illustrative purposes and is not meant to introduce any limitations on the type of equipment that may be an IP device. IP devices generally may be any device capable of running a process that uses any variant of the IP protocol such as, but not limited to, personal computers, workstations, and telephones. In addition, IP devices may be special purpose processors for applications such as, but not limited to, utility meter reading and home automation. Furthermore, if CM 800 follows the DOCSIS standards, then it is also an IP device with an IP address being assigned by the DOCSIS CMTS for configuration and management. However, the IP address assigned to CM 800 for configuration and management need not necessarily come from the same subnet as the IP addresses assigned to other customer or subscriber devices such as IP devices 824, 826, and/or 828.

In general, IP devices 824, 826, and 828 should have globally-valid, internet IP addresses to have simultaneous access to the internet for each device without utilizing network address translation (NAT) or some other form of access gateway, such as, but not limited to, a proxy server. A non-limiting example of IP address assignment for FIG. 8 might be for IP device 824 to have the global, public IP address of 135.100.25.101, for IP device 826 to have the global, public IP address of 135.100.25.102, and for IP device 828 to have the global, public IP address of 135.100.25.103. In this way each device could have access to the internet through cable modem 800. However, service providers usually charge for additional globally-valid, public IP addresses beyond the one IP address provided in the basic monthly service charge for an account. Thus, this non-limiting example IP address assignment for FIG. 8 may not be preferred by customers.

In general, the communications media for connecting customer premise data devices in FIGS. 8-18, such as communications medium 822, might be any form of communications media. However, as cable modems generally are designed to connect customer or subscriber premises to service providers, the communications media for connecting customer premise data devices in FIGS. 8-18, including communications medium 822, are likely to use a technology such as, but not limited to, a LAN (local area network) designed for communications within a relatively small geographic area. Often a LAN will be contained within a single building such as a customer's residence or a commercial structure.

The form of communications medium 822 and the communications media for connecting customer premise data devices in FIGS. 8-18 includes, but is not limited to, wired or wireless as well as point-to-point or shared with contention determined by a centralized algorithm or by a distributed algorithm. Furthermore, the communications media might possibly use multiplexing techniques such as, but not limited to, time-division multiplexing (TDM) and/or frequency-division multiplexing (FDM) as well as possibly use spread spectrum technologies such as, but not limited to, frequency hopping and/or direct sequence techniques. These direct sequence techniques might include, but are not limited to, code division multiple access (CDMA).

However, despite the fact that communications medium 822 and the communications media for connecting customer premise data devices in FIGS. 8-18 are generally any communications media, the DOCSIS cable modem to customer premise equipment (CMCI) specification covers a standard for interfacing DOCSIS CMCI-compliant cable modems to some types of CPE. This DOCSIS CMCI standard only describes three interfaces for communications media, such as communications medium 822 in FIG. 8, that are used for connecting a cable modem (CM 800) to customer premise equipment (CPE) such as IP device 824. DOCSIS CMCI describes a LAN interface using ethernet, an external computer bus interface using universal serial bus (USB), and an internal computer bus interface using the peripheral component interconnect (PCI) bus. Thus, to be compliant with the DOCSIS CMCI specification, a cable modem should interface to CPE using ethernet (including IEEE 802.3), USB, or PCI.

The general system level cable data network architecture for connecting IP devices to cable modems is covered in DOCSIS. However, the DOCSIS CMCI specifications heretofore have limited the communications medium 822 for DOCSIS cable modems to only ethernet (as well as IEEE 802.3), USB, and PCI.

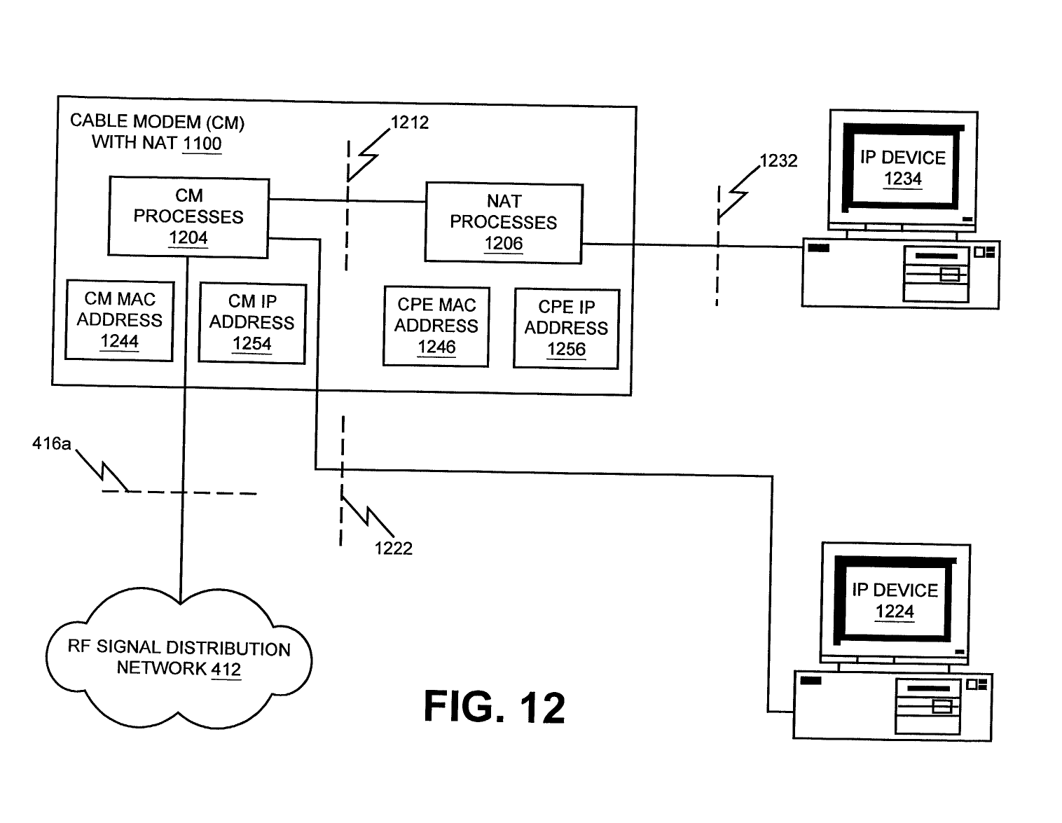

Despite these limitations of DOCSIS CMCI, in the embodiments of the present invention, communications medium 822 may be any form of communications medium for connecting customer premise data devices. If cable modem 800 uses some other communications media than ethernet, USB, or PCI for communications medium 822, then cable modem 800 will not be compliant with the DOCSIS CMCI standard. However, such a cable modem might still comply with the DOCSIS CM RFI (cable modem radio frequency interface) specifications and/or the DOCSIS CM TRI (cable modem telephony return interface) specification. Cable modem 800 could use technologies other than ethernet, USB, and PCI for communications medium 822 and still comply with these DOCSIS standards by appearing no different than an ethernet attached cable modem, when viewed from its RF cable interface (CM RFI). The details of a CM appearing no different than an ethernet attached DOCSIS cable modem are further covered in the description below generally regarding FIG. 12.

In general, the term “integration” in the computer and networking fields involves combining or blending previously separate activities, programs, processes, functions, and/or hardware components into a functional whole. Within the context of the embodiments of the present invention, the terms integrated and integration generally imply that two items that are integrated together share some resources more than a communications media connecting the items and more than any instances of the algorithms of media access control (MAC) protocols that correspond to the communications media shared by the two items. (Generally communications media are not considered to be communications devices, and thus communications media do not actively retain state information beyond the time it takes to propagate a signal through the media. However, when two communications devices are connected to a communications media, the devices may share some information on the state of the communications media because each device generally may be running processes that are at least one instance of the media access control (MAC) protocol for that communications media.)

For the embodiments of the present invention, two integrated items generally are within the same box or device and/or generally use the same at least one connection to an electrical power outlet. (The power outlet need not necessarily be an alternating current (A.C.) power outlet.) Generally, in addition to sharing at least one power source and/or being in the same box or device, integrated items may share other resources of a device or box such as, but not limited to, processing and/or storage. The shared processing may or may not include the use of at least one microprocessor, and the shared storage may or may not include the use of at least one digital memory. Furthermore, the resources shared by integrated items may include software and/or hardware (such as, but not limited to, circuitry and/or logic). Also, the integration of items into one device or box generally allows the device or box to use at least one common user interface for the integrated items. In effect, the integrated items generally share at least one common user interface for the device or box.

Because communications medium 822 is not necessarily limited to the DOCSIS CMCI-compliant communications media of ethernet, USB, and PCI, FIG. 8 shows the potential integration of non-DOCSIS communications media into a cable modem that generally may be compliant with DOCSIS RFI and/or DOCSIS TRI. Furthermore, because communications medium 822 for communicating with customer premise data devices is at least one communications medium, FIG. 8 shows the potential integration of interfaces for more than one communications media into a cable modem. The more than one communications media (represented in FIG. 8 by communications medium 822) connected to the cable modem generally are used for communicating with customer premise data devices. Also, a cable modem with multiple communications media for communicating with customer premise data network devices may or may not be compliant with DOCSIS RFI and/or DOCSIS TRI. The integration of items in the embodiments of the present invention allows for capabilities and/or functions that generally were not available in solutions using separate (non-integrated) devices, components, and/or functions.

In general, the integration of additional functionality into a cable modem may or may not require additional processing capacity and/or storage capacity such as, but not limited to, digital memory. Furthermore, sometimes the integration of additional functionality into a cable modem might require additional software and/or hardware such as, but not limited to, circuitry and logic. Generally, integrating more functionality into a cable modem often increases the amount of hardware and/or software needed in the device, which usually raises the production costs of the device. To have a common platform for cable modems and to maintain a low price point for entry-level cable modem devices with lesser functionality, the additional hardware and/or software, which may be needed to support the integration of more advanced functionality, might be implemented in optional modules. These optional modules might be modular option cards or expansion cards that may be installed at the factory or possibly in the field (e.g., at the customer premise) by service technicians and/or customers. Furthermore, software upgrades might be downloaded to the cable modem through any communications media connected to the cable modem.

Some examples of interfaces that might be used for connecting expansion modules to a cable modem include, but are not limited to, the interfaces that have historically been used for expansion interfaces. A few particular non-limiting examples of these historical expansion interfaces are: 1) the AT/ISA bus (Advanced Technology/Industry Standard Architecture) of older PCs, 2) the PCMCIA (Personal Computer Memory Card International Association or PC Card) standard generally used for laptops, and 3) the PCI (Peripheral Component Interconnect) bus of newer PCs. In addition to industry standard expansion interfaces, many equipment vendors in the computer and networking fields often have designed their own proprietary expansion interfaces. None of these examples of expansion interfaces are meant to be limiting as there are many existing standard and proprietary expansion interfaces, and many new and modified expansion interfaces likely will be developed in the future.

Because of the scarcity of IP addresses, many service providers do not provide multiple IP addresses to network subscribers using cable modems. In addition, those service providers that offer additional IP addresses usually charge for the additional IP addresses, which helps to ration the scarce commodity of IP addresses. Many users or subscribers want to connect multiple IP devices to the internet, but cannot obtain or do not wish to pay for additional IP addresses. Thus, customers often implement external, non-integrated network address translation (NAT) to connect multiple IP devices to the internet using fewer internet-valid, public IP addresses than there are IP devices in the customer premise that may connect to the internet.

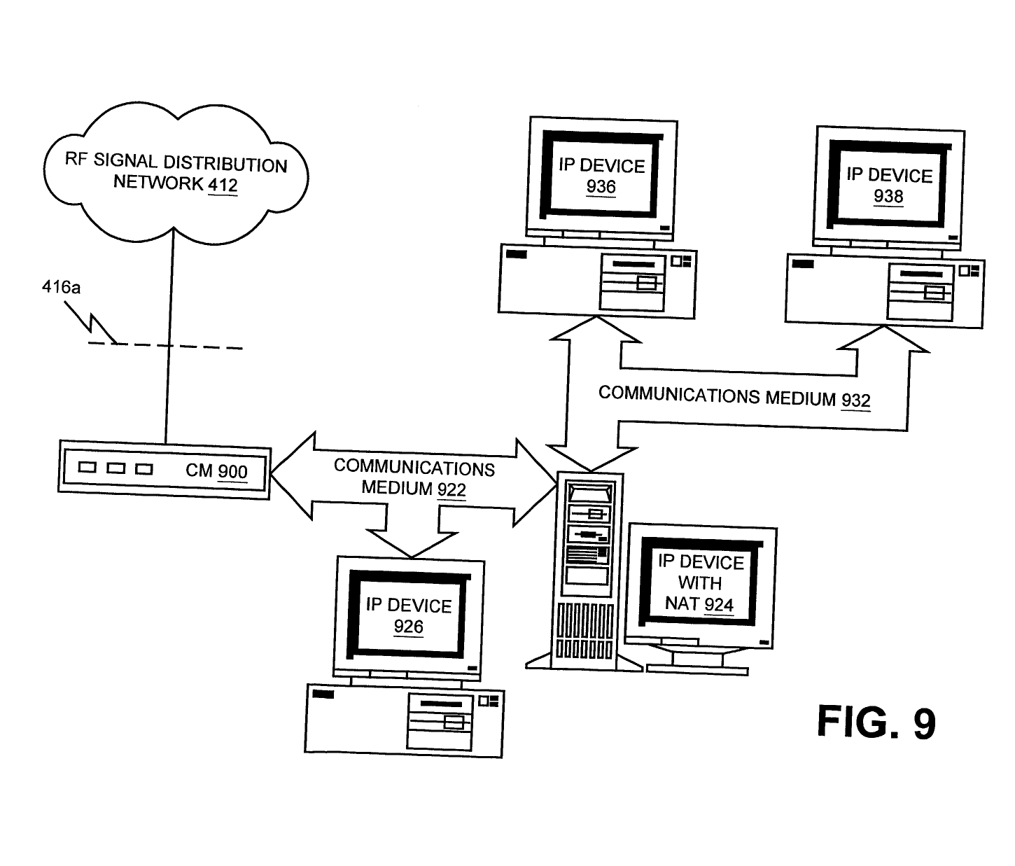

FIG. 9

FIG. 9 shows a non-limiting example of how an external, non-integrated NAT device might be used in a customer or subscriber network to provide internet access to more IP devices than have been assigned internet-valid, public IP addresses. In FIG. 9 cable modem (CM) 900 is connected to RF signal distribution network 412, which conforms to interface 416a. In addition, CM 900 is connected to communications medium 922, which is further connected to IP device with NAT 924 and IP device 926. Although FIG. 9 shows CM 900 connected to only communications medium 922 for communicating with customer premise data devices such as IP devices 924 and 926, in general CM 900 may be connected to at least one medium at the customer premise that is further connected to customer premise data devices. Thus, CM 900 may be connected to more than one communications media at the customer premise for communicating with customer premise data devices. Furthermore, if CM 900 is connected to more than one medium for communicating with customer premise data devices, then the multiple media may or may not be the same type of communications media. As a non-limiting example, CM 900 may be connected to some customer premise data devices using a wired ethernet medium and to other customer premise data devices using a wireless medium. In addition, the customer premise data devices also might be processes internal to CM 900. If all the customer premise data devices are internal processes within CM 900, then CM 900 might not have any externally connected customer premise communications media.

Although FIGS. 9, 10, 15, and 16 show the non-integrated IP devices with NAT (such as IP device with NAT 924) pictorially as tower/server computers as opposed to the desktop computers used to represent the other IP devices, this pictorial difference in the figures between tower/server computers and desktop computers is not meant to have any functional significance and is only used to more quickly identify the devices in the figures that are functioning as NAT devices. IP device with NAT 924 is connected to both communications medium 922 and communications medium 932. IP devices 936 and 938 are connected to communications medium 932.

In general, cable modem 900 is capable of forwarding many network level protocols. (Under DOCSIS a cable modem generally uses layer two bridging as a forwarding construct between the RF cable interface and communications media connected to customer premise data networking equipment.) Therefore, customer premise data devices generally may utilize other protocols instead of or in addition to the Internet Protocol (IP). However, the network address translation (NAT) utilized in some of the preferred embodiments of the present invention generally is used for translating information conforming to the TCP/IP protocol suite. Thus, the customer premise data devices in FIG. 9 are shown as IP devices.

IP devices 924, 926, 936, and 938 in FIG. 9 are customer premise data devices that are capable of using at least one variant of the Internet Protocol (IP). These variants include, but are not limited to, IPv4, IPng, and/or IPv6. At most customer premises, IP devices 926, 936, and 938 generally are IP hosts or end systems. However, cable modem 900 also will work if the IP devices are intermediate systems with IP protocol stacks for forwarding IP datagrams and/or user applications such as, but not limited to, network management and configuration. Also, even though IP devices in FIG. 9 are represented pictorially as personal computers, this is only for illustrative purposes and is not meant to introduce any limitations on the type of equipment that may be an IP device. IP devices generally may be any device capable of running a process that uses any variant of the IP protocol such as, but not limited to, personal computers, workstations, and telephones. In addition, IP devices may be special purpose processors for applications such as, but not limited to, utility meter reading and home automation. Although IP device with NAT 924 could utilize the networking constructs or models of other intermediate systems, usually IP device with NAT 924 generally functions as an IP router with the additional functionality of network address translation (NAT). Furthermore, if CM 900 follows the DOCSIS standards, then it is also an IP device with an IP address being assigned by the DOCSIS CMTS for configuration and management. However, the IP address assigned to CM 900 for configuration and management need not necessarily come from the same subnet as the IP addresses assigned to other customer or subscriber devices such as IP devices 924 and/or 926.

A non-limiting example of IP address assignment for FIG. 9 might be for IP device 926 to have the global, public IP address of 135.100.25.101, while IP device with NAT 924 has the global, public IP address of 135.100.25.102 for its interface in communications medium 922. Because both IP device 926 and IP device with NAT 924 have internet-valid, public IP addresses, both of these devices may transparently access the internet without needing network address translation (NAT) functionality. In contrast, suppose IP device with NAT 924 has private IP address 10.0.0.124 on its interface in communications medium 932 and suppose that IP device 936 and IP device 938 have private IP addresses 10.0.0.136 and 10.0.0.138, respectively. Then to access the internet, IP devices 936 and 938 might use IP device with NAT 924 to provide network address translation on all packets communicated between IP devices 936 and 938 and the internet. Because in this example IP device with NAT 924 has only one internet-valid, public IP address of 135.100.25.102, IP device with NAT 924 generally should use NAPT (Network Address Port Translation) to allow the two IP devices 936 and 938 to access the internet simultaneously.

In general, the communications media such as communications medium 922 and communications medium 932 might be any form of communications media for connecting customer premise data devices. However, as cable modems generally are designed to connect customer or subscriber premises to service providers, communications media 922 and 932 are likely to use a technology such as, but not limited to, a LAN (local area network) designed for communications within a relatively small geographic area. Often a LAN will be contained within a single building such as a customer's residence or a commercial structure.

The form of communications media 922 and 932 for connecting customer premise data devices includes, but is not limited to, wired or wireless as well as point-to-point or shared with contention determined by a centralized algorithm or by a distributed algorithm. Furthermore, the communications media might possibly use multiplexing techniques such as, but not limited to, time-division multiplexing (TDM) and/or frequency-division multiplexing (FDM) as well as possibly use spread spectrum technologies such as, but not limited to, frequency hopping and/or direct sequence techniques. These direct sequence techniques might include, but are not limited to, code division multiple access (CDMA).

However, despite the fact that communications media 922 and 932 are generally any communications media for connecting customer premise data devices, the DOCSIS cable modem to customer premise equipment (CMCI) specification covers a standard for interfacing DOCSIS CMCI-compliant cable modems to some types of CPE. This DOCSIS CMCI standard only describes three interfaces for communications media, such as communications medium 922 in FIG. 9, that are used for connecting a cable modem (CM 900) to customer premise equipment (CPE) such as IP device 926. DOCSIS CMCI describes a LAN interface using ethernet, an external computer bus interface using universal serial bus (USB), and an internal computer bus interface using the peripheral component interconnect (PCI) bus. Thus, to be compliant with the DOCSIS CMCI specification, a cable modem should interface to CPE using ethernet (including IEEE 802.3), USB, or PCI.

The general system level cable data network architecture for connecting IP devices to cable modems is covered in DOCSIS. Also, the use of a non-integrated, NAT router with external connections to a cable modem in one communications medium and to other IP devices in another communications medium commonly has been deployed by users. However, the DOCSIS CMCI specifications heretofore have limited the communications medium 922 for DOCSIS cable modems to only ethernet (as well as IEEE 802.3), USB, and PCI.

Despite these limitations of DOCSIS CMCI, in the embodiments of the present invention, communications medium 922 may be any form of communications medium for connecting customer premise data devices. If cable modem 900 uses some other communications media than ethernet, USB, or PCI for communications medium 922, then cable modem 900 will not be compliant with the DOCSIS CMCI standard. However, such a cable modem might still comply with the DOCSIS CM RFI (cable modem radio frequency interface) specifications and/or the DOCSIS CM TRI (cable modem telephony return interface) specification. Cable modem 900 could use technologies other than ethernet, USB, and PCI for communications medium 922 and still comply with these DOCSIS standards by appearing no different than an ethernet attached cable modem, when viewed from its RF cable interface (CM RFI). The details of a CM appearing no different than an ethernet attached DOCSIS cable modem are further covered in the description below generally regarding FIG. 12. In contrast to communications medium 922, communications medium 932 is not defined by DOCSIS and may be any type of communications medium that might be used for distributing signals at a customer premise.

In general, the term “integration” in the computer and networking fields involves combining or blending previously separate activities, programs, processes, functions, and/or hardware components into a functional whole. Within the context of the embodiments of the present invention, the terms integrated and integration generally imply that two items that are integrated together share some resources more than a communications media connecting the items and more than any instances of the algorithms of media access control (MAC) protocols that correspond to the communications media shared by the two items. (Generally communications media are not considered to be communications devices, and thus communications media do not actively retain state information beyond the time it takes to propagate a signal through the media. However, when two communications devices are connected to a communications media, the devices may share some information on the state of the communications media because each device generally may be running processes that are at least one instance of the media access control (MAC) protocol for that communications media.)

For the embodiments of the present invention, two integrated items generally are within the same box or device and/or generally use the same at least one connection to an electrical power outlet. (The power outlet need not necessarily be an alternating current (A.C.) power outlet.) Generally, in addition to sharing at least one power source and/or being in the same box or device, integrated items may share other resources of a device or box such as, but not limited to, processing and/or storage. The shared processing may or may not include the use of at least one microprocessor, and the shared storage may or may not include the use of at least one digital memory. Furthermore, the resources shared by integrated items may include software and/or hardware (such as, but not limited to, circuitry and/or logic). Also, the integration of items into one device or box generally allows the device or box to use at least one common user interface for the integrated items. In effect, the integrated items generally share at least one common user interface for the device or box.

Because communications medium 922 is not necessarily limited to the DOCSIS CMCI-compliant communications media of ethernet, USB, and PCI, FIG. 9 shows the potential integration of non-DOCSIS communications media into a cable modem that generally may be compliant with DOCSIS RFI and/or DOCSIS TRI. Furthermore, because communications medium 922 for communicating with customer premise data devices is at least one communications medium, FIG. 9 shows the potential integration of interfaces for more than one communications media into a cable modem. The more than one communications media (represented in FIG. 9 by communications medium 922) connected to the cable modem generally are used for communicating with customer premise data devices. Also, a cable modem with multiple communications media for communicating with customer premise data network devices may or may not be compliant with DOCSIS RFI and/or DOCSIS TRI. The integration of items in the embodiments of the present invention allows for capabilities and/or functions that generally were not available in solutions using separate (non-integrated) devices, components, and/or functions.

In general, the integration of additional functionality into a cable modem may or may not require additional processing capacity and/or storage capacity such as, but not limited to, digital memory. Furthermore, sometimes the integration of additional functionality into a cable modem might require additional software and/or hardware such as, but not limited to, circuitry and logic. Generally, integrating more functionality into a cable modem often increases the amount of hardware and/or software needed in the device, which usually raises the production costs of the device. To have a common platform for cable modems and to maintain a low price point for entry-level cable modem devices with lesser functionality, the additional hardware and/or software, which may be needed to support the integration of more advanced functionality, might be implemented in optional modules. These optional modules might be modular option cards or expansion cards that may be installed at the factory or possibly in the field (e.g., at the customer premise) by service technicians and/or customers. Furthermore, software upgrades might be downloaded to the cable modem through any communications media connected to the cable modem.

Some examples of interfaces that might be used for connecting expansion modules to a cable modem include, but are not limited to, the interfaces that have historically been used for expansion interfaces. A few particular non-limiting examples of these historical expansion interfaces are: 1) the AT/ISA bus (Advanced Technology/Industry Standard Architecture) of older PCs, 2) the PCMCIA (Personal Computer Memory Card International Association or PC Card) standard generally used for laptops, and 3) the PCI (Peripheral Component Interconnect) bus of newer PCs. In addition to industry standard expansion interfaces, many equipment vendors in the computer and networking fields often have designed their own proprietary expansion interfaces. None of these examples of expansion interfaces are meant to be limiting as there are many existing standard and proprietary expansion interfaces, and many new and modified expansion interfaces likely will be developed in the future.

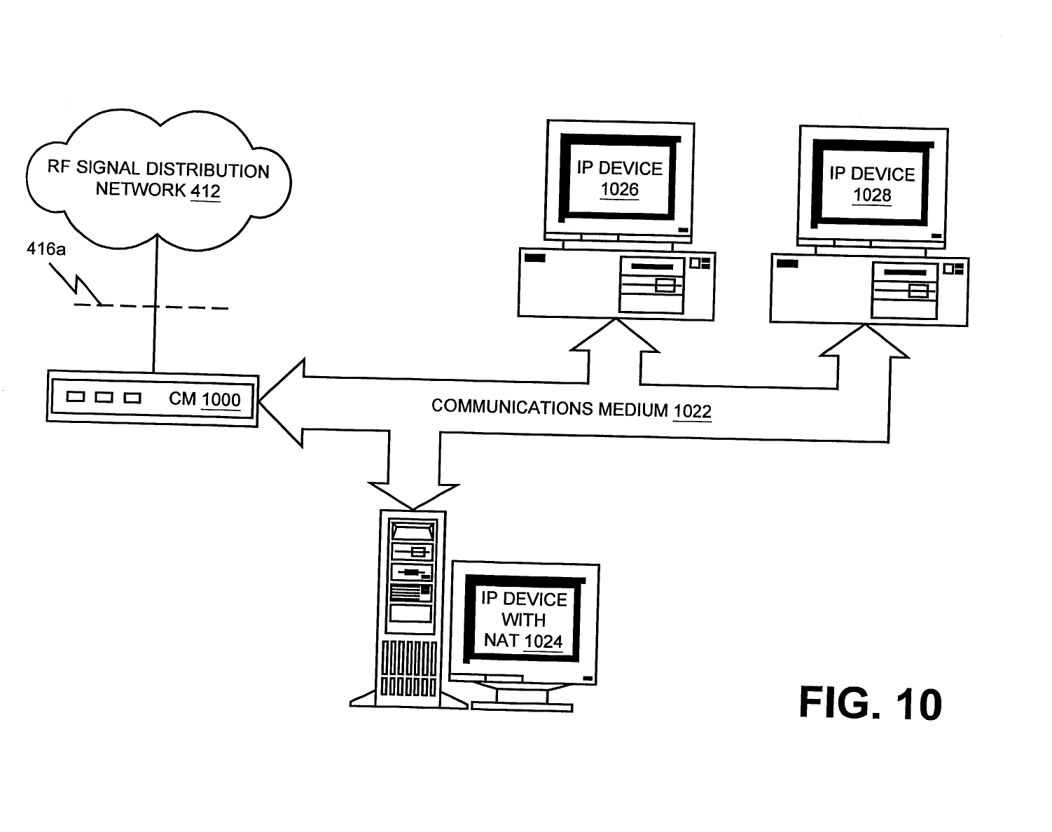

FIG. 10

FIG. 10 shows another non-limiting example of how an external, non-integrated NAT device might be used in a customer or subscriber network to provide internet access to more IP devices than have been assigned internet-valid, public IP addresses. In FIG. 10 cable modem (CM) 1000 is connected to RF signal distribution network 412, which conforms to interface 416a. In addition, CM 1000 is connected to communications medium 1022, which is further connected to IP device with NAT 1024 as well as IP devices 1026 and 1028. Although FIG. 10 shows CM 1000 connected to only communications medium 1022 for communicating with customer premise data devices such as IP devices 1024, 1026, and 1028, in general CM 1000 may be connected to at least one medium at the customer premise that is further connected to customer premise data devices. Thus, CM 1000 may be connected to more than one communications media at the customer premise for communicating with customer premise data devices. Furthermore, if CM 1000 is connected to more than one medium for communicating with customer premise data devices, then the multiple media may or may not be the same type of communications media. As a non-limiting example, CM 1000 may be connected to some customer premise data devices using a wired ethernet medium and to other customer premise data devices using a wireless medium. In addition, the customer premise data devices also might be processes internal to CM 1000. If all the customer premise data devices are internal processes within CM 1000, then CM 1000 might not have any externally connected customer premise communications media.

Although FIG. 10 shows non-integrated IP device with NAT 1024 pictorially as a tower/server computer as opposed to a desktop computer that is used to represent the other IP devices, this pictorial difference in the figures between tower/server computers and desktop computers is not meant to have any finctional significance and is only used to more quickly identify the device in the figure that is functioning as a NAT device.

In general, cable modem 1000 is capable of forwarding many network level protocols. (Under DOCSIS a cable modem generally uses layer two bridging as a forwarding construct between the RF cable interface and communications media connected to customer premise data networking equipment.) Therefore, customer premise data devices generally may utilize other protocols instead of or in addition to the Internet Protocol (IP). However, the network address translation (NAT) utilized in some of the preferred embodiments of the present invention generally is used for translating information conforming to the TCP/IP protocol suite. Thus, the customer premise data devices in FIG. 10 are shown as IP devices.

IP devices 1024, 1026, and 1028 in FIG. 10 are customer premise data devices that are capable of using at least one variant of the Internet Protocol (IP). These variants include, but are not limited to, IPv4, IPng, and/or IPv6. At most customer premises, IP devices 1026 and 1028 generally are IP hosts or end systems. However, cable modem 1000 also will work if the IP devices are intermediate systems with IP protocol stacks for forwarding IP datagrams and/or user applications such as, but not limited to, network management and configuration. Also, even though IP devices in FIG. 10 are represented pictorially as personal computers, this is only for illustrative purposes and is not meant to introduce any limitations on the type of equipment that may be an IP device. IP devices generally may be any device capable of running a process that uses any variant of the IP protocol such as, but not limited to, personal computers, workstations, and telephones. In addition, IP devices may be special purpose processors for applications such as, but not limited to, utility meter reading and home automation. Although IP device with NAT 1024 could utilize the networking constructs or models of other intermediate systems, usually IP device with NAT 1024 generally functions as an IP router with the additional functionality of network address translation (NAT). Furthermore, if CM 1000 follows the DOCSIS standards, then it is also an IP device with an IP address being assigned by the DOCSIS CMTS for configuration and management. However, the IP address assigned to CM 1000 for configuration and management need not necessarily come from the same subnet as the IP addresses assigned to other customer or subscriber devices such as IP device 1024.

FIG. 10 shows IP device with NAT 1024 as a one-arm NAT device that has an interface to only one communications medium 1022. This one-arm configuration of FIG. 10 is in contrast to the “two-arm” configuration of FIG. 9, where IP device with NAT 924 has one connection to communications medium 922 and one connection to communications medium 932. Generally, most routers have at least two arms. In other words, such “two-arm” or “multiple arm” routers are connected to at least two separate media. These “two-arm” or “multiple-arm” routers generally route data between and among the at least two separate media usually using at most one IP address within each media. In contrast, a one-arm router has two or more network-level, IP addresses within one data-link-level communications medium.

A one-arm router is commonly implemented by assigning multiple IP addresses to a single interface that is connected to one data-link-level communications medium. This type of one-arm router may be supported by the software in the router to allow the assignment of multiple IP addresses to a single data-link-level interface. In addition, for processing systems running routing software that does not support assigning multiple IP addresses to a single data-link-level interface, a one-arm routing configuration might be obtained by connecting two or more data-link-level interfaces of the processing system to the same communications medium. This configuration allows the processing system running the routing software to route packets between the two data-link interfaces that are each assigned with one different IP address and that are both connected to the same communications medium. A NAT device such as IP device with NAT 1024 may be implemented as a one-arm device that might be only connected to a single communications medium 1022 but has multiple IP addresses associated with the at least one connection to a single communications medium 1022.

A non-limiting example of IP address assignment for FIG. 10 might be for IP device with NAT 1024 to have the global, public IP address of 135.100.25.101 as well as the private IP address of 10.0.0.124 both associated with the device's at least one connection to communications medium 1022. Because IP device with NAT 1024 has an internet-valid, public IP address, this device may transparently access the internet without needing network address translation (NAT) functionality. In contrast, suppose IP devices 1026 and 1028 have private IP addresses 10.0.0.126 and 10.0.0.128, respectively. Then to access the internet, IP devices 1026 and 1028 might use IP device with NAT 1024 to provide network address translation (NAT) on all packets communicated between IP devices 1026 and 1028 and the internet. Because in this example IP device with NAT 1024 has only one internet-valid, public IP address of 135.100.25.101, IP device with NAT 1024 generally should use NAPT (Network Address Port Translation) to allow the two IP devices 1026 and 1028 to access the internet simultaneously.

Cable modems that follow the DOCSIS RFI 1.0 and/or RFI 1.1 standards generally implement layer two bridging as the forwarding algorithm. In addition, cable modems following DOCSIS RFI 1.0 and/or RFI 1.1 are supposed to filter out (or not forward) frames that are received by the cable modem on the cable modem to CPE interface (CMCI) and that have source MAC addresses that are not provisioned or learned as supported CPE devices. Such filtering prevents data link frames from devices that are not allowed access to the service provider's network from transversing across the cable modem from the CMCI interface (generally represented by communications medium 1022) to the RFI interface 416a. In addition, the DOCSIS RFI 1.0 and/or RFI 1.1 standards specify that compliant cable modems are capable of filtering based upon network layer protocol numbers so that a DOCSIS cable modem may be configured to only forward the network layer protocols associated with the TCP/IP suite (such as, but not limited to, IP with a protocol ID of 0800 hexadecimal, ARP with a protocol ID of 0806 hexadecimal, and/or RARP (reverse ARP) with a protocol ID of 8035 hexadecimal).

These cable modem filtering mechanisms and/or forwarding algorithms generally are used to prevent unauthorized access to the service provider's RF cable network by CPE devices with unauthorized MAC addresses and by CPE devices running unauthorized network protocols. However, these filtering/forwarding mechanisms are not perfect. For example, suppose IP device with NAT 1024 has a MAC address that is authorized for access through cable modem 1000 onto the service provider's RF network. Further suppose that IP device with NAT 1024 is a one-arm router that has both a globally-valid, public IP address of 135.100.25.101 and a private IP address of 10.0.0.124 that are both associated with the MAC address that is authorized to communicate through cable modem 1000 onto the service provider's RF network. In this situation cable modem 1000 would not block or filter frames with a source MAC address corresponding to the authorized MAC address of IP device with NAT 1024 but with a source IP address of the private IP value of 10.0.0.124. Thus, a cable modem that is compliant with DOCSIS RFI 1.0 and/or RFI 1.1 would forward IP datagrams into the service provider's network that have invalid private IP addresses. One solution to this problem is for the cable modem to use additional filter criteria to prevent IP datagrams with private IP addresses from transversing the cable modem and entering into the service provider's network. A cable modem utilizing such filters would be a hybrid device with some characteristics of the bridge construct and some characteristics of the routing construct related to making forwarding decisions based upon network layer IP addresses. Thus, the one-arm NAT configuration of FIG. 10 identifies the potential need for more sophisticated filtering capabilities for cable modems than are defined in DOCSIS RFI 1.0 and/or RFI 1.1.

In general, communications medium 1022 might be any form of communications media for connecting customer premise data devices. However, as cable modems generally are designed to connect customer or subscriber premises to service providers, communications medium 1022 is likely to use a technology such as, but not limited to, a LAN (local area network) designed for communications within a relatively small geographic area. Often a LAN will be contained within a single building such as a customer's residence or a commercial structure.

The form of communications medium 1022 for connecting customer premise data devices includes, but is not limited to, wired or wireless as well as point-to-point or shared with contention determined by a centralized algorithm or by a distributed algorithm. Furthermore, the communications media might possibly use multiplexing techniques such as, but not limited to, time-division multiplexing (TDM) and/or frequency-division multiplexing (FDM) as well as possibly use spread spectrum technologies such as, but not limited to, frequency hopping and/or direct sequence techniques. These direct sequence techniques might include, but are not limited to, code division multiple access (CDMA).

However, despite the fact that communications medium 1022 is generally any communications media for connecting customer premise data devices, the DOCSIS cable modem to customer premise equipment (CMCI) specification covers a standard for interfacing DOCSIS CMCI-compliant cable modems to some types of CPE. This DOCSIS CMCI standard only describes three interfaces for communications media, such as communications medium 1022 in FIG. 10, that are used for connecting a cable modem (CM 1000) to customer premise equipment (CPE) such as IP device 1026. DOCSIS CMCI describes a LAN interface using ethernet, an external computer bus interface using universal serial bus (USB), and an internal computer bus interface using the peripheral component interconnect (PCI) bus. Thus, to be compliant with the DOCSIS CMCI specification, a cable modem should interface to CPE using ethernet (including IEEE 802.3), USB, or PCI.

The general system level cable data network architecture for connecting IP devices to cable modems is covered in DOCSIS. Also, the use of a non-integrated, NAT router with external connections to a cable modem in one communications medium and to other IP devices in another communications medium commonly has been deployed by users. Unlike FIG. 10, the non-integrated, external NAT router commonly deployed in cable data networks by users has connections to two different communications media (i.e., it is a two-arm router) as opposed to the connection of IP device with NAT 1024 to a single communications medium. In addition, the DOCSIS CMCI specifications heretofore have limited the communications medium 1022 for DOCSIS cable modems to only ethernet (as well as IEEE 802.3), USB, and PCI.

Despite these limitations of DOCSIS CMCI, in the embodiments of the present invention, communications medium 1022 may be any form of communications medium for connecting customer premise data devices. If cable modem 1000 uses some other communications media than ethernet, USB, or PCI for communications medium 1022, then cable modem 1000 will not be compliant with the DOCSIS CMCI standard. However, such a cable modem might still comply with the DOCSIS CM RFI (cable modem radio frequency interface) specifications and/or the DOCSIS CM TRI (cable modem telephony return interface) specification. Cable modem 1000 could use technologies other than ethernet, USB, and PCI for communications medium 1022 and still comply with these DOCSIS standards by appearing no different than an ethernet attached cable modem, when viewed from its RF cable interface (CM RFI). The details of a CM appearing no different than an ethernet attached DOCSIS cable modem are further covered in the description below generally regarding FIG. 12.

In general, the term “integration” in the computer and networking fields involves combining or blending previously separate activities, programs, processes, functions, and/or hardware components into a functional whole. Within the context of the embodiments of the present invention, the terms integrated and integration generally imply that two items that are integrated together share some resources more than a communications media connecting the items and more than any instances of the algorithms of media access control (MAC) protocols that correspond to the communications media shared by the two items. (Generally communications media are not considered to be communications devices, and thus communications media do not actively retain state information beyond the time it takes to propagate a signal through the media. However, when two communications devices are connected to a communications media, the devices may share some information on the state of the communications media because each device generally may be running processes that are at least one instance of the media access control (MAC) protocol for that communications media.)

For the embodiments of the present invention, two integrated items generally are within the same box or device and/or generally use the same at least one connection to an electrical power outlet. (The power outlet need not necessarily be an alternating current (A.C.) power outlet.) Generally, in addition to sharing at least one power source and/or being in the same box or device, integrated items may share other resources of a device or box such as, but not limited to, processing and/or storage. The shared processing may or may not include the use of at least one microprocessor, and the shared storage may or may not include the use of at least one digital memory. Furthermore, the resources shared by integrated items may include software and/or hardware (such as, but not limited to, circuitry and/or logic). Also, the integration of items into one device or box generally allows the device or box to use at least one common user interface for the integrated items. In effect, the integrated items generally share at least one common user interface for the device or box.

Because communications medium 1022 is not necessarily limited to the DOCSIS CMCI-compliant communications media of ethernet, USB, and PCI, FIG. 10 shows the potential integration of non-DOCSIS communications media into a cable modem that generally may be compliant with DOCSIS RFI and/or DOCSIS TRI. Furthermore, because communications medium 1022 for communicating with customer premise data devices is at least one communications medium, FIG. 10 shows the potential integration of interfaces for more than one communications media into a cable modem. The more than one communications media (represented in FIG. 10 by communications medium 1022) connected to the cable modem generally are used for communicating with customer premise data devices. Also, a cable modem with multiple communications media for communicating with customer premise data network devices may or may not be compliant with DOCSIS RFI and/or DOCSIS TRI. The integration of items in the embodiments of the present invention allows for capabilities and/or functions that generally were not available in solutions using separate (non-integrated) devices, components, and/or functions.

In general, the integration of additional functionality into a cable modem may or may not require additional processing capacity and/or storage capacity such as, but not limited to, digital memory. Furthermore, sometimes the integration of additional functionality into a cable modem might require additional software and/or hardware such as, but not limited to, circuitry and logic. Generally, integrating more functionality into a cable modem often increases the amount of hardware and/or software needed in the device, which usually raises the production costs of the device. To have a common platform for cable modems and to maintain a low price point for entry-level cable modem devices with lesser functionality, the additional hardware and/or software, which may be needed to support the integration of more advanced functionality, might be implemented in optional modules. These optional modules might be modular option cards or expansion cards that may be installed at the factory or possibly in the field (e.g., at the customer premise) by service technicians and/or customers. Furthermore, software upgrades might be downloaded to the cable modem through any communications media connected to the cable modem.

Some examples of interfaces that might be used for connecting expansion modules to a cable modem include, but are not limited to, the interfaces that have historically been used for expansion interfaces. A few particular non-limiting examples of these historical expansion interfaces are: 1) the AT/ISA bus (Advanced Technology/Industry Standard Architecture) of older PCs, 2) the PCMCIA (Personal Computer Memory Card International Association or PC Card) standard generally used for laptops, and 3) the PCI (Peripheral Component Interconnect) bus of newer PCs. In addition to industry standard expansion interfaces, many equipment vendors in the computer and networking fields often have designed their own proprietary expansion interfaces. None of these examples of expansion interfaces are meant to be limiting as there are many existing standard and proprietary expansion interfaces, and many new and modified expansion interfaces likely will be developed in the future.

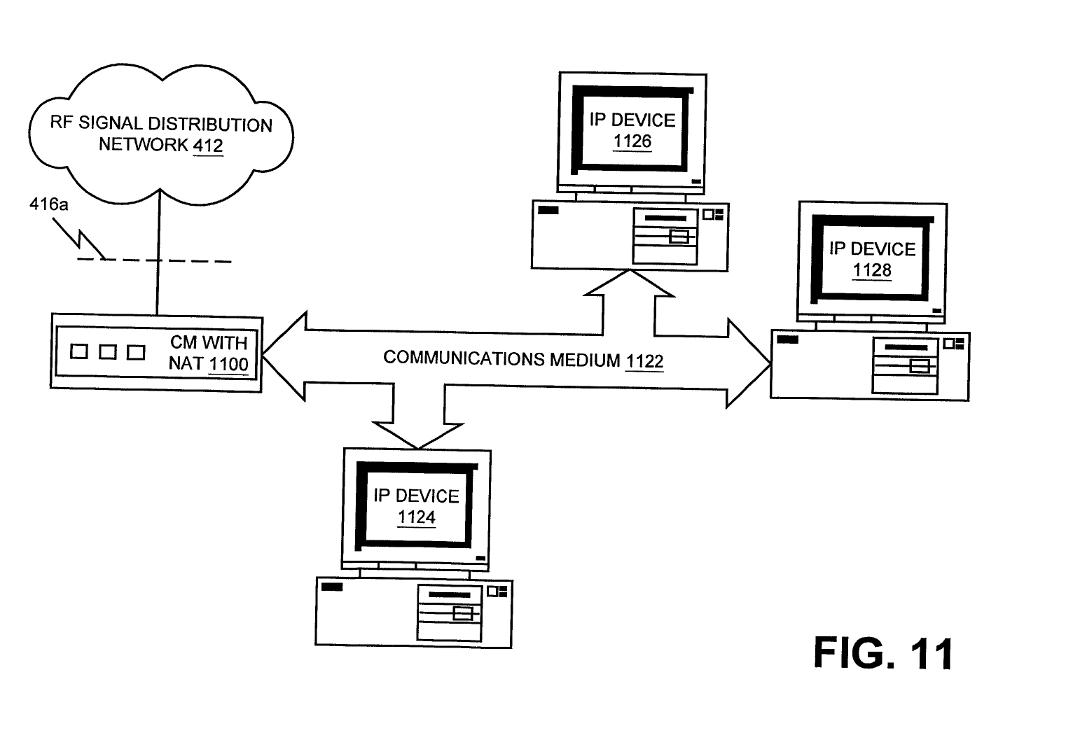

FIG. 11

FIG. 11 shows a non-limiting example of how integrated NAT functionality might be included in a cable modem to provide internet access to more IP devices than have been assigned internet-valid, public IP addresses. In FIG. 11 cable modem (CM) with NAT 1100 is connected to RF signal distribution network 412, which conforms to interface 416a. In addition, CM with NAT 1100 is connected to communications medium 1122, which is further connected to IP devices 1124, 1126, and 1128. Although FIG. 11 shows CM with NAT 1100 connected to only communications medium 1122 for communicating with customer premise data devices such as IP devices 1124, 1126, and 1128, in general CM with NAT 1100 may be connected to at least one medium at the customer premise that is further connected to customer premise data devices. Thus, CM with NAT 1100 may be connected to more than one communications media at the customer premise for communicating with customer premise data devices. Furthermore, if CM with NAT 1100 is connected to more than one medium for communicating with customer premise data devices, then the multiple media may or may not be the same type of communications media. As a non-limiting example, CM with NAT 1100 may be connected to some customer premise data devices using a wired ethernet medium and to other customer premise data devices using a wireless medium. In addition, the customer premise data devices also might be processes internal to CM with NAT 1100. If all the customer premise data devices are internal processes within CM with NAT 1100, then CM with NAT 1100 might not have any externally connected customer premise communications media.

In general, cable modem (CM) with NAT 1100 is capable of forwarding many network level protocols. (Under DOCSIS a cable modem generally uses layer two bridging as a forwarding construct between the RF cable interface and communications media connected to customer premise data networking equipment.) Therefore, customer premise data devices generally may utilize other protocols instead of or in addition to the Internet Protocol (IP). However, the network address translation (NAT) utilized in some of the preferred embodiments of the present invention generally is used for translating information conforming to the TCP/IP protocol suite. Thus, the customer premise data devices in FIG. 11 are shown as IP devices.

IP devices 1124, 1126, and 1128 in FIG. 11 are customer premise data devices that are capable of using at least one variant of the Internet Protocol (IP). These variants include, but are not limited to, IPv4, IPng, and/or IPv6. At most customer premises, IP devices 1124, 1126, and 1128 generally are IP hosts or end systems. However, cable modem with NAT 1100 also will work if the IP devices are intermediate systems with IP protocol stacks for forwarding IP datagrams and/or user applications such as, but not limited to, network management and configuration. Also, even though IP devices in FIG. 11 are represented pictorially as personal computers, this is only for illustrative purposes and is not meant to introduce any limitations on the type of equipment that may be an IP device. IP devices generally may be any device capable of running a process that uses any variant of the IP protocol such as, but not limited to, personal computers, workstations, and telephones. In addition, IP devices may be special purpose processors for applications such as, but not limited to, utility meter reading and home automation. Furthermore, if CM with NAT 1100 follows the DOCSIS standards, then it is also an IP device with an IP address being assigned by the DOCSIS CMTS for configuration and management. However, the IP address assigned to CM with NAT 1100 for configuration and management need not necessarily come from the same subnet as at least one IP address used for network address translation (NAT) processes within CM with NAT 1100.

A non-limiting example of IP address assignment for FIG. 11 might be for CM with NAT 1100 to have the global, public IP address of 135.100.25.101 as an IP address used for the NAT processes within CM with NAT 1100. For a DOCSIS cable modem that also performs NAT, the IP address used for NAT processes generally would be in addition to the IP address assigned by the cable network for initializing and managing the cable modem processes. For CM with NAT 1100 to transparently appear to be no different than an ethernet attached cable modem, when viewed from its RF cable interface (CM RFI), the IP address or IP addresses used for NAT processes within CM with NAT 1100 should appear to be the IP address of customer premise IP devices and not the IP address used for initializing and managing a DOCSIS cable modem.

Furthermore, service providers may not necessarily use IP addresses from the same subnets for both the IP address used for initializing and managing a cable modem and the IP address or IP addresses used for customer premise devices. Service providers may specifically choose different IP subnets for the IP address used for initializing and managing a cable modem so as to make it impossible for subscribers or customers to access the cable modem to adjust features such as network security and/or statistics. A device such as CM with NAT 1100 might need to take into account the differing security and control needs of service providers and subscribers in accessing and configuring the settings of cable modem processes as opposed to customer premise processes such as network address translation (NAT) when both cable modem processes and customer premise processes are within the same device such as CM with NAT 1100.

In addition to CM with NAT 1100 having a globally-valid, public IP address of 135.100.25.101 for customer premise processes such as NAT, IP device 1124 may have a globally-valid, public IP address of 135.100.25.102 for its interface in communications medium 1122. Thus, IP device 1124 could access the internet through CM with NAT 1100 without needing network address translation (NAT) of the IP datagrams sent and received by IP device 1124. Thus, a CM with NAT 1100 may provide network address translation for some customer premise IP devices and may not provide network address translation for other customer premise IP devices.

In contrast, suppose IP device 1126 has private IP address 10.0.0.126 and IP device 1128 has private IP address 10.0.0.128. Then to access the internet, IP devices 1126 and 1128 might use CM with NAT 1100 to provide network address translation on all packets communicated between the internet and IP devices 1126 and 1128. Because in this example CM with NAT 1100 has only one internet-valid, public IP address of 135.100.25.101, CM with NAT 1100 generally should use NAPT (Network Address Port Translation) to allow the two IP devices 1126 and 1128 to access the internet simultaneously.

In general, communications medium 1122 might be any form of communications media for connecting customer premise data devices. However, as cable modems generally are designed to connect customer or subscriber premises to service providers, communications medium 1122 is likely to use a technology such as, but not limited to, a LAN (local area network) designed for communications within a relatively small geographic area. Often a LAN will be contained within a single building such as a customer's residence or a commercial structure.

The form of communications medium 1122 for connecting customer premise data devices includes, but is not limited to, wired or wireless as well as point-to-point or shared with contention determined by a centralized algorithm or by a distributed algorithm. Furthermore, the communications media might possibly use multiplexing techniques such as, but not limited to, time-division multiplexing (TDM) and/or frequency-division multiplexing (FDM) as well as possibly use spread spectrum technologies such as, but not limited to, frequency hopping and/or direct sequence techniques. These direct sequence techniques might include, but are not limited to, code division multiple access (CDMA).

However, despite the fact that communications medium 1122 is generally any communications media, the DOCSIS cable modem to customer premise equipment (CMCI) specification covers a standard for interfacing DOCSIS CMCI-compliant cable modems to some types of CPE. This DOCSIS CMCI standard only describes three interfaces for connecting DOCSIS CMCI compliant cable modems to customer premise equipment (CPE) such as IP device 1124. DOCSIS CMCI describes a LAN interface using ethernet, an external computer bus interface using universal serial bus (USB), and an internal computer bus interface using the peripheral component interconnect (PCI) bus. Thus, to be compliant with the DOCSIS CMCI specification, a cable modem should interface to CPE using ethernet, USB, or PCI. In general, to be compliant with the layer two bridging paradigm for forwarding defined in DOCSIS RFI 1.0 and/or RFI 1.1, the NAT functionality of CM with NAT 1100 generally should operate as a layer two bridge.

Although cable modem with NAT 1100 might use some other communications media than ethernet, USB, or PCI for communications medium 1122, then cable modem with NAT 1100 would not be compliant with the DOCSIS CMCI standard. However, such a cable modem could still comply with the DOCSIS CM RFI (cable modem radio frequency interface) specifications and/or the DOCSIS CM TRI (cable modem telephony return interface) specification. Cable modem 1100 could use technologies other than ethernet, USB, and PCI for communications medium 1122 and still comply with these DOCSIS standards by appearing no different than an ethernet attached cable modem, when viewed from its RF cable interface (CM RFI). In addition, although DOCSIS RFI 1.0 and/or 1.1 generally describe a layer two, bridge forwarding algorithm for cable modems, a cable modem with NAT may implement bridging, routing, and/or hybrid combinations and subsets of bridging and/or routing, still maintaining transparent behavior to the RF cable interface. This transparency to the RF cable interface is accomplished by appearing no different than an ethernet attached cable modem, when viewed from its RF cable interface (CM RFI). To a service provider, such a cable modem would appear no different than a DOCSIS-compliant cable modem.

Thus, communications medium 1122 may or may not be a DOCSIS CMCI compliant communications media such as ethernet, USB, or PCI. Furthermore, CM with NAT 1100 may or may not be compliant with the DOCSIS forwarding algorithm that generally specifies layer two bridging between the DOCSIS cable modem to CPE interface (CMCI) and the DOCSIS RF cable interface (RFI). Still with the proper functionality, CM with NAT 1100 may appear to service provider's equipment no different than an ethernet attached cable modem generally using layer two, bridging, when viewed from its RF cable interface (CM RFI).

In general, the term “integration” in the computer and networking fields involves combining or blending previously separate activities, programs, processes, functions, and/or hardware components into a functional whole. Within the context of the embodiments of the present invention, the terms integrated and integration generally imply that two items that are integrated together share some resources more than a communications media connecting the items and more than any instances of the algorithms of media access control (MAC) protocols that correspond to the communications media shared by the two items. (Generally communications media are not considered to be communications devices, and thus communications media do not actively retain state information beyond the time it takes to propagate a signal through the media. However, when two communications devices are connected to a communications media, the devices may share some information on the state of the communications media because each device generally may be running processes that are at least one instance of the media access control (MAC) protocol for that communications media.)

For the embodiments of the present invention, two integrated items generally are within the same box or device and/or generally use the same at least one connection to an electrical power outlet. (The power outlet need not necessarily be an alternating current (A.C.) power outlet.) Generally, in addition to sharing at least one power source and/or being in the same box or device, integrated items may share other resources of a device or box such as, but not limited to, processing and/or storage. The shared processing may or may not include the use of at least one microprocessor, and the shared storage may or may not include the use of at least one digital memory. Furthermore, the resources shared by integrated items may include software and/or hardware (such as, but not limited to, circuitry and/or logic). Also, the integration of items into one device or box generally allows the device or box to use at least one common user interface for the integrated items. In effect, the integrated items generally share at least one common user interface for the device or box.

Because communications medium 1122 is not necessarily limited to the DOCSIS CMCI-compliant communications media of ethernet, USB, and PCI, FIG. 11 shows the potential integration of non-DOCSIS communications media into a cable modem that generally may be compliant with DOCSIS RFI and/or DOCSIS TRI. Furthermore, because communications medium 1122 for communicating with customer premise data devices is at least one communications medium, FIG. 11 shows the potential integration of interfaces for more than one communications media into a cable modem. The more than one communications media (represented in FIG. 11 by communications medium 1122) connected to the cable modem generally are used for communicating with customer premise data devices. Also, a cable modem with multiple communications media for communicating with customer premise data network devices may or may not be compliant with DOCSIS RFI and/or DOCSIS TRI.

In addition, FIG. 11 shows the integration of user processes such as, but not limited to, network address translation into CM with NAT 1100. Other user processes that may or may not be integrated into a cable modem include tasks such as, but not limited to, firewall, proxy, tunneling, VPN (Virtual Private Networking), and/or DHCP. In addition, combinations, variations, and/or subsets of the possible user processes also may be integrated into CM with NAT 1100. The integration of items in the embodiments of the present invention allows for capabilities and/or functions that generally were not available in solutions using separate (non-integrated) devices, components, and/or functions.

In general, the integration of additional functionality into a cable modem may or may not require additional processing capacity and/or storage capacity such as, but not limited to, digital memory. Furthermore, sometimes the integration of additional functionality into a cable modem might require additional software and/or hardware such as, but not limited to, circuitry and logic. Generally, integrating more functionality into a cable modem often increases the amount of hardware and/or software needed in the device, which usually raises the production costs of the device. To have a common platform for cable modems and to maintain a low price point for entry-level cable modem devices with lesser functionality, the additional hardware and/or software, which may be needed to support the integration of more advanced functionality, might be implemented in optional modules. These optional modules might be modular option cards or expansion cards that may be installed at the factory or possibly in the field (e.g., at the customer premise) by service technicians and/or customers. Furthermore, software upgrades might be downloaded to the cable modem through any communications media connected to the cable modem.

Some examples of interfaces that might be used for connecting expansion modules to a cable modem include, but are not limited to, the interfaces that have historically been used for expansion interfaces. A few particular non-limiting examples of these historical expansion interfaces are: 1) the AT/ISA bus (Advanced Technology/Industry Standard Architecture) of older PCs, 2) the PCMCIA (Personal Computer Memory Card International Association or PC Card) standard generally used for laptops, and 3) the PCI (Peripheral Component Interconnect) bus of newer PCs. In addition to industry standard expansion interfaces, many equipment vendors in the computer and networking fields often have designed their own proprietary expansion interfaces. None of these examples of expansion interfaces are meant to be limiting as there are many existing standard and proprietary expansion interfaces, and many new and modified expansion interfaces likely will be developed in the future.

FIG. 12

FIG. 12 shows a more detailed diagram of cable modem (CM) with NAT 1100. CM with NAT 1100 is connected to RF signal distribution network 412, which conforms to interface 416a. The processes and entities shown in FIG. 12 are only for illustration purposes and are not meant to limit the software and/or hardware architecture of CM with NAT 1100. Commonly, a CM with NAT 1100 will have some processes that generally handle cable modem functionality (shown in the figure as CM processes 1204) and some processes that generally handle NAT functionality (shown in the figure as NAT processes 1206). Within CM with NAT 1100 the CM processes 1204 and the NAT processes 1206 generally are capable of communicating with each other as shown by the connection between CM processes 1204 and NAT processes 1206. This connection between at least some of the processes within CM with NAT 1100 is only for illustrative purposes. The connection between processes in FIG. 12 is not meant to limit the manner in which the processes may or may not communicate and is not meant to limit the manner in which the processes may or may not be interconnected. Furthermore, FIG. 12 shows interface 1212 defining the interface of the connection between CM processes 1204 and NAT processes 1206.

Generally, when multiple processes are integrated into a single device the processes may communicate with each other. Some non-limiting examples of ways that processes within CM with NAT 1100 may communicate with each other include, but are not limited to, communication over a bus interface and/or communication through access to shared memory. However, nothing in the embodiments of the present invention is meant to limit the methods, mechanisms, and/or interfaces that are used for communication between and among processes within CM with NAT 1100.

In addition, FIG. 12 shows CM processes 1204 connected to RF signal distribution network 412 over RF cable interface 416a. This connection in FIG. 12 is only used to illustrate that the cable modem (CM) processes 1204 generally should be able to communicate using RF signal distribution network 412 over RF cable interface 416a. The connection of CM processes 1204 to RF signal distribution network 412 over RF cable interface 416a is not meant to limit CM processes 1204 to only being directly connected to RF cable interface 416a. In general, other processes in CM with NAT 1100 may provide hardware and/or software that facilitates the ability of CM processes 1204 to send information via RF signal distribution network 412 and/or to receive information via RF signal distribution network 412 over RF cable interface 416a.

In general, cable modem with NAT 1100 is capable of forwarding many network level protocols. (Under DOCSIS a cable modem generally uses layer two bridging as a forwarding construct between the RF cable interface and communications media connected to customer premise data networking equipment.) Therefore, customer premise data devices generally may utilize any protocol including other protocols instead of or in addition to the Internet Protocol (IP). However, the network address translation (NAT) utilized in some of the preferred embodiments of the present invention generally is used for translating information conforming to the TCP/IP protocol suite. Thus, the customer premises data networking devices in FIG. 12 are shown as IP devices.

IP devices in FIG. 12 (such as IP devices 1224 and 1234) are customer premise data devices that are capable of using at least one variant of the Internet Protocol (IP). These variants include, but are not limited to, IPv4, IPng, and/or IPv6. At most customer premises, IP devices 1224 and 1234 generally are IP hosts or end systems. However, cable modem with NAT 1100 also will work if the IP devices are intermediate systems with IP protocol stacks for forwarding IP datagrams and/or user applications such as, but not limited to, network management and configuration. Also, even though IP devices in FIG. 12 are represented pictorially as personal computers, this is only for illustrative purposes and is not meant to introduce any limitations on the type of equipment that may be an IP device. IP devices generally may be any device capable of running a process that uses any variant of the IP protocol such as, but not limited to, personal computers, workstations, and telephones. In addition, IP devices may be special purpose processors for applications such as, but not limited to, utility meter reading and home automation. Furthermore, if CM with NAT 1100 follows the DOCSIS standards, then it is also an IP device with an IP address being assigned by the DOCSIS CMTS for configuration and management. However, the IP address assigned to CM with NAT 1100 for configuration and management need not necessarily come from the same subnet as at least one IP address used for network address translation (NAT) processes within CM with NAT 1100.

In addition, FIG. 12 shows CM with NAT 1100 with two external interfaces to customer premise equipment for networking. In general, a cable modem could be connected to more than one communications media in the customer premise for communicating information to and/or from customer premise data devices. FIG. 12 shows CM with NAT 1100 connected over interface 1222 to IP device 1224. The connection defined by interface 1222 may connect directly to the CM processes 1204 and not go through the NAT processes 1206 so that the packets communicated between IP device 1224 and other internet devices connected over RF cable interface 416a are not altered by network address translation in CM with NAT 1100. This type of configuration of bypassing the network address translation (NAT) functions may be useful for some IP devices that run applications that communicate using packets that cannot be transparently translated by NAT processes 1206. In contrast, interface 1232 connects IP device 1234 to cable modem with NAT 1100. As shown in FIG. 12, the information communicated to and/or from IP device 1234 may be altered using network address translation (NAT) processes 1206. However, CM with NAT 1100 may have the ability to provide network address translation for a first set of IP devices while not providing network address translation for a second set of IP devices even though both the first set and second set of IP devices are connected to the same communications medium.

If CM with NAT 1100 is a DOCSIS cable modem, then the DOCSIS standards do not describe how to integrate cable modem functionality with other user processes in the same device. The DOCSIS CMCI specification only describes connecting cable modems to external ethernet and USB interfaces and connecting cable modems to internal PCI interfaces. Integrating other processes into a cable modem or developing additional capabilities such as NAT, while retaining compatibility with the interfaces defined by service providers, generally requires that the new, additional processes and/or capabilities generate and/or receive data that conforms to the interfaces of service providers. In this way the new, additional processes and/or capabilities appear transparent to the service provider's equipment. For DOCSIS cable modems, at least three issues generally should be handled to ensure data packets communicated over the RF cable interface from CM with NAT 1100 conform to the expectations of service provider equipment. These three issues generally involve MAC addresses, IP addresses, and the packet size of the frames communicated on the RF medium.

Furthermore, if CM with NAT 1100 is a DOCSIS cable modem, then the device has a cable modem (CM) MAC address 1244. In addition, DOCSIS cable modems generally are not supposed to use the CM MAC address 1244 for customer devices (or CPE) that communicate information generally considered by DOCSIS to be user data. The data output from NAT processes 1206 for communication over RF cable interface 416a generally appears to service provider equipment as if the data is customer or user data. Thus, the data from the NAT processes 1206 generally will have to appear to be sent from at least one customer premise equipment (CPE) MAC address 1246 when the data is communicated across RF cable interface 416a.

Also, DOCSIS cable modems use a Dynamic Host Configuration Protocol (DHCP) client process to dynamically obtain one cable modem (CM) IP address 1254 during initialization. In addition, DOCSIS cable modems that have a telephony return interface (TRI) may have another cable modem (CM) IP address that is obtained from Point-to-Point Protocol (PPP) Internet Control Protocol (IPCP) negotiation. In general, cable modems that support DOCSIS TRI are designed to communicate over the public-switched telephone network (PSTN) or a telco link using PPP IPCP for upstream communications. However, those skilled in the art will recognize that, in addition to supporting telco PSTN links, the general nature of PPP allows cable modems with DOCSIS TRI capabilities to support other upstream communications technologies, which may carry PPP frames.

The CM IP address obtained through PPP IPCP negotiation need not necessarily be the same value as the CM IP address obtained through DHCP. The DOCSIS TRI specification defines when a cable modem should use which CM IP address of the two CM IP addresses obtained from DHCP and IPCP. In general, according to the DOCSIS TRI specification, cable modems with telco return interfaces should use the CM IP address obtained by IPCP for communications over the PPP link and should use the CM IP address obtained using DHCP for communications over the RF cable interface. To simplify the explanation only one CM IP address 1254 is shown in FIG. 12. However, it should be understood that when a cable modem has two CM IP addresses, CM IP address 1254 represents the appropriate CM IP address to be used for either RF cable communications or for telco PPP link communications.

The CM IP address 1254 may be used for managing and configuring CM with NAT 1100. However, DOCSIS cable modems generally are not supposed to use the CM IP address 1254 for customer devices (or CPE) that communicate information generally considered by DOCSIS to be user data. The data output from NAT processes 1206 for communication over RF cable interface 416a generally appears to service provider equipment as if the data is customer or user data. Thus, the data from the NAT processes 1206 generally will have to appear to be sent from at least one customer premise equipment (CPE) IP address 1256 when the data is communicated across RF cable interface 416a. In fact, CM IP address 1254 and CPE IP address 1256 need not even be from the same IP subnetwork.

Although DOCSIS defines a DHCP process for assigning a CM IP address 1254 to a cable modem such as CM with NAT 1100, DOCSIS does not define the method for assigning at least one CPE IP address 1256. Thus, at least one customer premise equipment (CPE) IP address 1256 may be dynamically assigned to or statically configured for CM with NAT 1100. However, many service providers use DHCP for assigning IP addresses to customer devices connected through a cable modem. Thus, at least one CPE IP address 1256 is likely to be assigned through DHCP.

Thus, CM with NAT 1100 may use at least one DHCP client process to dynamically obtain at least one CPE IP address. The standard RFC 1541 and 2131 DHCP client process may be used to dynamically obtain a single IP address. This standard DHCP client process may be used repetitively by CM with NAT 1100 to obtain multiple CPE IP addresses. Alternatively, U.S. Pat. No. 6,178,455, entitled “Router which dynamically requests a set of logical network addresses and assigns addresses in the set to hosts connected to the router”, describes an extended variation of DHCP that allows a simplified assignment of multiple IP addresses.

Finally, DOCSIS RFI 1.0 defines a MAC frame on the RF cable interface 416a that contains a packet data PDU that generally is capable of carrying 1500 octets (or bytes) of user data. Also, DOCSIS RFI 1.0 defines an ATM MAC frame capable of carrying an integer multiple of fifty-three octet ATM cells. In general, if the user data to be forwarded from the cable modem over the RF cable interface 416a into the service provider's network is less than or equal 1500 octets, then the user data can be placed inside a DOCSIS RFI 1.0 packet data PDU. The DOCSIS CMCI standards limit the types of media to which DOCSIS cable modems may connect. These DOCSIS CMCI media are ethernet, USB, and PCI. In general, the MAC frames generated by customer equipment with interfaces defined in DOCSIS CMCI are ethernet or ethernet-like frames that have user data fields of 1500 octets or less. Thus, the DOCSIS standards ensure that the user data in MAC frames from customer premise equipment will fit in the packet data PDU of MAC frames forwarded over RF cable interface 416a by a DOCSIS cable modem.

In general, the preferred embodiments of the present invention may work with various types of communications media within or at the customer premise. Because some of the communications media may have MAC frames with user data fields larger or smaller than the 1500 octet user data size of DOCSIS RFI 1.0 packet data PDUs, CM with NAT 1100 may have to handle fragmentation of the user data from MAC frames. The user data would be received in MAC frames on one interface and would be fragmented to fit into MAC frames on another interface. Because IP routers generally handle the fragmentation of IP datagrams, implementation of NAT processes 1206 using IP router constructs is one non-limiting way of providing the necessary fragmentation to deal with different frames sizes of various communications media.

Like the DOCSIS RFI 1.0 standard, the DOCSIS RFI 1.1 standard also supports MAC frames with packet data PDUs that have up to 1500 octets of user data. In addition, DOCSIS RFI 1.1 includes a specification for fragmentation at the MAC level. Using this specification, CM with NAT 1100 might be able to connect to various media at the customer premises that have maximum frame sizes with more than 1500 octets of user data by utilizing different packet fragmentation processes than those used in the fragmentation of an IP datagram by an IP router.

In addition to the three issues described above regarding integrating cable modem processes 1204 with customer premise or user processes (such as, but not limited to, NAT processes 1206) within a single device such as CM with NAT 1100, the use of CPE MAC address 1246 should be discussed in more detail. CPE MAC address 1246 is used as a MAC address on RF cable interface 416a for data communicated from some user processes such as, but not limited to, NAT processes 1206.

If the communications medium at interface 1232 also uses MAC addresses, then CM with NAT 1100 also will have a MAC address in the communications medium at interface 1232. It is possible that the communications media at interface 1232 does not have MAC addresses. A non-limiting example of a communications medium that does not need MAC addresses is if interface 1232 defines a point-to-point communications medium that is using the IP Control Protocol (IPCP) of the Point-to-Point Protocol (PPP) to only pass IP datagrams over the communications medium at interface 1232. (RFC 1331, entitled “The Point-to-Point Protocol (PPP) for the Transmission of Multi-protocol Datagrams over Point-to-Point Links”, describes how PPP addresses fields may be compressed or omitted in PPP frames. Also, the IP datagrams inside IPCP packets within PPP frames do not contain MAC addresses.) Generally, if the communications media at interface 1232 and at RF cable interface 416a are isolated from each other, then CM with NAT 1100 only has to use a MAC address on each interface that is different from the MAC addresses of other networking devices connected to that interface. For the stub networks used to provide cable data service to most customer premises, the communication media at interface 1232 commonly is isolated from the communications media at RF cable interface 416a. If the communications media at interface 1232 and at RF cable interface 416a are isolated from each other, then the value used for CPE MAC address 1246 may be the same as the value used for the MAC address of CM with NAT 1100 in the communications medium at interface 1232. In this situation CM with NAT 1100 may use the same standard IEEE forty-eight-bit or six-octet address on each interface. Also, when the communications media at interface 1232 and RF cable interface 416a are isolated from each other, CM with NAT 1100 could have different values for the MAC addresses used in the communications medium at interface 1232 and for the MAC address used in the communications medium at RF cable interface 416a (i.e., CPE MAC address 1246). However, the use of a different MAC address on each interface of CM with NAT 1100 may use up more unique IEEE 48-bit MAC addresses than necessary.

As discussed previously, although NAT functionality is commonly implemented using routing constructs, it may be possible to implement NAT using bridging constructs and/or combinations and hybrids of routing and bridging constructs. Depending on the construct or model that is chosen, NAT processes 1206 may or may not change the MAC addresses of packets as they are communicated across interface 1232 in the customer premise and across RF cable interface 416a. Thus, the selection of bridging, routing, and/or hybrid models or constructs for the NAT processes 1206 may affect the actual MAC addresses used by CM with NAT 1100 when forwarding packets over the RF cable interface 416a and interface 1232.

Furthermore, some cable data systems limit access to the network based on the MAC address of customer premise equipment. Usually, some equipment managed by the service provider maintains this information on allowed MAC addresses for customer premise equipment. As CM with NAT 1100 includes not only cable modem processes 1204, but also customer premise processes such as NAT processes 1206, the lists of allowed MAC addresses likely will have to include CPE MAC address 1246, which is used by CM with NAT 1100 when communicating subscriber or user data over RF cable interface 416a. Often MAC addresses such as CPE MAC address 1246 are hard-coded into the firmware of devices. When new customer devices are connected to cable modems, a customer may have to contact the service provider to modify the list of MAC addresses that are allowed access to the service provider's network through the cable modem.

Because CM with NAT 1100 may be replacing existing cable modems as customers upgrade their network to use NAT functionality, service providers may already have a list of allowed MAC addresses that includes a customer's current IP device. Often the customer's current IP device will be placed behind a newly installed CM with NAT 1100 that may replace the existing cable modem that does not have NAT. To allow the CM with NAT 1100 to operate without having the service provider modify the list of allowed MAC addresses, it may be desirable to allow CPE MAC address 1246 to be configurable. In this way a customer could install CM with NAT 1100 without having to coordinate network changes with the service provider.

This effect may be accomplished by simply using the same value for the CPE MAC address 1246 as the value of the MAC address that was used by the customer's current IP device for pre-existing cable data access and is the MAC address value that is kept by the service provider in its access list. This CPE MAC address 1246 then is utilized by CM with NAT 1100 for communicating over RF cable interface 416a. If CM with NAT 1100 uses the MAC address of IP device 1234 (i.e., the MAC address of the customer's current IP device) as CPE MAC address 1246 for communication over RF cable interface 416a, then CM with NAT 1100 cannot use this same MAC address value for the communications medium with interface 1232. In order to have MAC addresses that allow devices connected to the communication medium with interface 1232 to be individually addressed and/or selected, CM with NAT 1100 generally should use a different MAC address in this communication medium than the MAC address used by IP device 1234.

There are several ways to assign the value of CPE MAC address 1246 if it is configurable in CM with NAT 1100. None of the following examples is meant to be limiting, but only to provide some possibilities for assigning a configurable value for at least one CPE MAC address 1246. First, users might be allowed to manually set CPE MAC address 1246 through a user interface. Next, CM with NAT 1100 might listen to the communications medium with interface 1232 to learn the value of the MAC address of a customer's equipment such as IP device 1234. Also, according to the DOCSIS standards, the configuration file downloaded to a cable modem using TFTP during CM initialization may contain the list of MAC addresses (or CPE ethernet MAC addresses). Though DOCSIS has the capability to communicate the list of allowed MAC addresses to a cable modem, often the cable modem is managed by the service provider and not by the customer or subscriber. Thus, the list of allowed MAC addresses often is not communicated to the customer either directly through access to the configuration of the cable modem or indirectly through a protocol that communicates the list of allowed MAC addresses to customer equipment. However, with the preferred embodiments of the present invention that integrate a cable modem with customer premise processes such as NAT, it may be easier to communicate the information in the allowed list of MAC addresses to the customer and to change CPE MAC address 1246 to match one of the MAC addresses in the allowed list.

Cable modem (CM) processes 1204 may be able to communicate information on the allowed list of MAC addresses to other processes within CM with NAT 1100 by using various mechanisms. These mechanisms need not necessarily use industry standard protocols, but may instead use proprietary, non-standard, or vendor-specific implementations within CM with NAT 1100. As a non-limiting example, the user interface for configuring the CM with NAT device might be used to convey the information to humans on the allowed CPE MAC addresses. Furthermore, the information on the allowed CPE MAC addresses may be communicated to processing devices through various communications protocols instead of or in addition to being communicated to humans. The ability to enable or disable these ways for configuring CPE MAC address 1246 may be needed to implement various security policies of service providers and/or customers.

Also, to simplify the MAC translation processes that may be needed on CM with NAT 1100 for routing and/or bridging, it might be possible for CM with NAT 1100 to communicate the value for CPE MAC address 1246 to IP device 1234. Then IP device 1234 might use this MAC address as a source MAC address when forming frames communicated between IP device 1234 and CM with NAT 1100 over interface 1232. One protocol that allows assignment of MAC addresses is the PPP Bridging Control Protocol (BCP) that also is known as the Bridging Network Control Protocol (BNCP). The BCP protocol is used to communicate ethernet frames using the Point-to-Point Protocol and would commonly be implemented over point-to-point communications media. BCP packets encapsulating ethernet frames may further encapsulate IP datagrams within the ethernet frames.

Finally, although FIG. 12 shows a single CPE MAC address 1246 and a single CPE IP address 1256, in general a cable modem with NAT might have at least one CPE MAC address 1246 and at least one CPE IP address 1256. As a non-limiting example, the NAT processes 1206 may use two globally-valid internet IP addresses. Also, even though the present application has focused on integrating NAT into cable modems, there might be other customer premise processes or functions that could be implemented in a cable modem. Customer premise processes or functions are those functions that are not defined in cable modem specifications such as DOCSIS that specify the interfaces between service provider equipment and customer premise equipment (CPE). These customer premise functions normally have been left to customers to implement and maintain on CPE, generally without the involvement of the service provider. Furthermore, each customer premise or user process generally may be associated with at least one CPE MAC address and/or CPE IP address. Also, if CM with NAT 1100 has multiple user processes, then the multiple user processes may or may not share CPE MAC addresses and/or CPE IP addresses.

In addition to NAT some examples of other customer premise processes or functions that also may be integrated into a cable modem include, but are not limited to, DHCP, firewalls, proxies, tunneling, and/or virtual private networking (VPN). Firewalls, proxies, tunneling, and/or VPN generally work by generating IP datagrams based on some received packets. The received packets may be IP datagrams but could be other protocols. As a non-limiting example, some firewalls and/or proxies may provide protocol conversion services between Novell's IPX network protocol and IP network protocols. In addition, gateway services in a firewall and/or proxy might convert between other protocols that do not include a network layer such as, but not limited to, NetBIOS/NetBEUI. Furthermore, IP tunneling and/or IP VPN technologies encapsulate other protocols inside of IP datagrams for transmission over IP networks. The other protocols actually might be encapsulated within other protocols such as, but not limited to, TCP that then are carried in the IP datagrams. Often the encapsulated protocols may be any other data communications protocols.

In general, gateway technologies for IP connectivity such as NAT, firewalls, proxies, tunneling, and/or VPN generally work by generating and/or modifying IP datagrams that are outbound from the device implementing the technology. IP datagrams transmitted upstream by a cable modem or a set-top box with cable modem functionality would be outbound IP datagrams for a cable modem or set-top box that implements at least one of these gateway services. On inbound IP datagrams the gateway technology performs a generally reverse function. IP datagrams transmitted downstream by a headend and/or distribution hub and received by a cable modem or a set-top box with cable modem are inbound IP datagrams relative to a cable modem or set-top box that implements at least one of these gateway services. In general, the inbound mapping function is not an exact inverse of the outbound mapping function because the functions have to at least account for the calculation of cyclic redundancy checks (CRC) or frame check sequences (FCS). In addition, the two mapping functions generally are not exact inverses because the destination and source IP address fields generally are swapped when inbound IP datagrams are compared to related outbound IP datagrams. Tunneling and VPN technologies that carry encapsulated data inside of IP datagrams generally add an IP header to outbound information and remove an IP header from inbound information. In tunneling and VPN technologies, the mapping that creates outbound packets by adding an IP header generally is an inverse of the mapping used on inbound packets.

For NAT, firewalls, and/or proxies, packets received by a device implementing these gateway services are converted to IP datagrams and transmitted. NAT generally provides a gateway service that converts between IP datagrams. Although firewalls and proxies also may convert between IP datagrams, firewalls and proxies might work by converting other protocols to IP. In addition, tunneling and VPN may place IP as well as other protocols inside of outbound IP datagrams. Because firewall, proxy, tunneling and/or VPN technologies may work with other protocols in addition to or instead of IP, generally the IP devices in FIGS. 1-18 might be any data device connected to a cable modem or a set-top box with cable modem functionality. The data devices might transmit medium access control (MAC) frames carrying other protocols that are not IP. The MAC frames would be received by the cable modem or set-top box. Using integrated gateway services in the cable modem or set-top box, these MAC frames could be converted to IP datagrams for transmission over the RF cable network.

MAC frames generally have some information in the frame that allows the receiving device to determine the beginning and end of the frame. In addition, many types of MAC frames contain protocol identification fields within the MAC frame. These protocol identification fields commonly can be used for uniquely identifying the type of data carried in the MAC frame. Furthermore, protocol identification fields allow MAC frames to be used in multiplexing different protocols into the communications media carrying the MAC frames. Thus, the MAC frames might carry IP and/or other protocols.

Firewalls can be classified into at least three classifications: 1) packet-filtering, 2) circuit-level gateways, and 3) application-level gateways. Packet-filtering firewall processes are different from NAT processes because firewalls generally use more sophisticated methods for inspecting and forwarding packets. These sophisticated methods often maintain additional state information about the communications crossing the firewall. This state-based or state-full packet inspection of firewalls usually offers more protection against malicious network hacking and denial of service attacks than the security protection of NAT. In general, circuit-level gateways relay connections between connection-oriented protocols such as, but not limited to, TCP. Thus, a circuit-level gateway could provide one TCP connection between a source device and the firewall and provide one TCP connection between the firewall and the destination device. Furthermore, because firewalls may work with other protocols, other connection-oriented protocols such as, but not limited to, Novell's sequence packet exchange (SPX) could be used to provide a circuit-level gateway that relays between SPX over IPX and TCP over IP. Application level gateways may provide additional conversions between protocols above the network layer. Also, firewalls implementing circuit-level gateways and application level gateways are often referred to as proxy devices, proxy servers, or proxies.

Like NAT, circuit-level gateways and/or application level gateways often translate IP addresses. Unlike NAT, these circuit-level gateways and/or application-level gateways of firewalls and/or proxies may work with other protocols instead of or in addition to IP and generally are not transparent to users of IP connectivity. Often custom client software or custom user procedures are needed to use IP connectivity through firewalls and/or proxies. For example, most web browsers have to be set up for IP connectivity using proxies. Thus, these circuit-level and/or application-level gateways generally require client devices to be aware of the gateway and to be configured to use the gateway for access. In this way the client devices generally directly inform the gateway about client sessions needing services including address and/or port translation. In contrast, NAT devices often dynamically learn about client sessions without explicit notification from client devices.

IP tunneling generally creates a connection between two IP devices and encapsulates data into IP datagrams for communication between the two IP devices. When the IP datagrams are received at the destination end of tunnel, encapsulated data is extracted and forwarded on towards its final destination. The encapsulated data may be other protocols in addition to or instead of IP. VPNs use tunneling as well as other functions such as, but not limited to, authentication and/or encryption to carry private data through a public network such as, but not limited to, the internet. A cable modem or set-top box may provide an integrated gateway service as the end point of a tunnel or VPN. Various technologies that may be used for tunneling and/or VPN include, but are not limited to, generic routing encapsulation (GRE), Ascend tunnel management protocol (ATMP), point-to-point tunneling protocol (PPTP), layer two forwarding (L2F) protocol, layer two tunneling protocol (L2TP), IP Security (IPSec), and multi-protocol label switching (MPLS).

Any of these example customer premise functions that may be integrated into a cable modem may or may not use the same CPE MAC address 1246 and/or CPE IP address 1256 as any of the other customer premise functions that also may be integrated into a cable modem. In addition to gateway services such as NAT, firewall, proxy, tunneling, and VPN, a DHCP server process might be used in a cable modem or set-top box to distribute private IP addresses to customer premise equipment such as IP device 1234.

In general, the term “integration” in the computer and networking fields involves combining or blending previously separate activities, programs, processes, functions, and/or hardware components into a finctional whole. Within the context of the embodiments of the present invention, the terms integrated and integration generally imply that two items that are integrated together share some resources more than a communications media connecting the items and more than any instances of the algorithms of media access control (MAC) protocols that correspond to the communications media shared by the two items. (Generally communications media are not considered to be communications devices, and thus communications media do not actively retain state information beyond the time it takes to propagate a signal through the media. However, when two communications devices are connected to a communications media, the devices may share some information on the state of the communications media because each device generally may be running processes that are at least one instance of the media access control (MAC) protocol for that communications media.)

For the embodiments of the present invention, two integrated items generally are within the same box or device and/or generally use the same at least one connection to an electrical power outlet. (The power outlet need not necessarily be an alternating current (A.C.) power outlet.) Generally, in addition to sharing at least one power source and/or being in the same box or device, integrated items may share other resources of a device or box such as, but not limited to, processing and/or storage. The shared processing may or may not include the use of at least one microprocessor, and the shared storage may or may not include the use of at least one digital memory. Furthermore, the resources shared by integrated items may include software and/or hardware (such as, but not limited to, circuitry and/or logic). Also, the integration of items into one device or box generally allows the device or box to use at least one common user interface for the integrated items. In effect, the integrated items generally share at least one common user interface for the device or box.

Because the communications media for connecting customer premise data devices to CM with NAT 1100 are not necessarily limited to the DOCSIS CMCI-compliant communications media of ethernet, USB, and PCI, FIG. 12 shows the potential integration of non-DOCSIS communications media into a cable modem that generally may be compliant with DOCSIS RFI and/or DOCSIS TRI. Furthermore, FIG. 12 expressly shows CM with NAT 1100 connected to more than one communications medium for communicating with customer premise data devices such as IP devices 1224 and 1234. Thus, FIG. 12 shows the potential integration of interfaces for more than one communications media into a cable modem. The more than one communications media (represented in FIG. 12 by interfaces 1222 and 1232) generally are used by the cable modem for communicating with customer premise data devices.

As shown in FIG. 12, IP device 1224 is connected to CM with NAT 1100 through interface 1222, and IP device 1234 is connected to CM with NAT 1100 through interface 1232. Although FIG. 12 shows IP device 1234 using NAT processes 1206 and IP device 1224 not using NAT processes 1206, this example is only for illustrative purposes and is not intended to be limiting. In general, customer premise data devices connected to CM with NAT 1100 through any communications media may be able to communicate information over RF cable interface 416a with or without utilizing the network address translation processes 1206 depending on the configuration and/or architecture of CM with NAT 1100 as well as depending on the IP address assignments in the network. Also, a cable modem with multiple communications media for communicating with customer premise data network devices may or may not be compliant with DOCSIS RFI and/or DOCSIS TRI.

In addition, FIG. 12 shows the integration of user processes such as, but not limited to, network address translation into CM with NAT 1100. Other user processes that may or may not be integrated into a cable modem include tasks such as, but not limited to, DHCP server, firewall, and/or proxy. In addition, combinations, variations, and/or subsets of the possible user processes also may be integrated into CM with NAT 1100. The integration of items in the embodiments of the present invention allows for capabilities and/or functions that generally were not available in solutions using separate (non-integrated) devices, components, and/or functions.

In general, the integration of additional functionality into a cable modem may or may not require additional processing capacity and/or storage capacity such as, but not limited to, digital memory. Furthermore, sometimes the integration of additional functionality into a cable modem might require additional software and/or hardware such as, but not limited to, circuitry and logic. Generally, integrating more functionality into a cable modem often increases the amount of hardware and/or software needed in the device, which usually raises the production costs of the device. To have a common platform for cable modems and to maintain a low price point for entry-level cable modem devices with lesser functionality, the additional hardware and/or software, which may be needed to support the integration of more advanced functionality, might be implemented in optional modules. These optional modules might be modular option cards or expansion cards that may be installed at the factory or possibly in the field (e.g., at the customer premise) by service technicians and/or customers. Furthermore, software upgrades might be downloaded to the cable modem through any communications media connected to the cable modem.

Some examples of interfaces that might be used for connecting expansion modules to a cable modem include, but are not limited to, the interfaces that have historically been used for expansion interfaces. A few particular non-limiting examples of these historical expansion interfaces are: 1) the AT/ISA bus (Advanced Technology/Industry Standard Architecture) of older PCs, 2) the PCMCIA (Personal Computer Memory Card International Association or PC Card) standard generally used for laptops, and 3) the PCI (Peripheral Component Interconnect) bus of newer PCs. In addition to industry standard expansion interfaces, many equipment vendors in the computer and networking fields often have designed their own proprietary expansion interfaces. None of these examples of expansion interfaces are meant to be limiting as there are many existing standard and proprietary expansion interfaces, and many new and modified expansion interfaces likely will be developed in the future.

Set-Top Box (STB) and Subscriber Network Customer Premise Equipment (CPE)

U.S. patent application Ser. No. 09/896,390 with Attorney Docket No. 7258 is entitled “SYSTEM AND METHOD FOR ARCHIVING MULTIPLE DOWNLOADED RECORDABLE MEDIA CONTENT”, was filed Jun. 29, 2001, and is incorporated by reference herein. U.S. patent application Ser. No. 09/896,390 shows one potential embodiment of a basic set-top box. Generally, a set-top box has an interface to the RF network, a selector for demultiplexing audio and/or video programs (often the selector comprises a tuner), and an interface for communicating the audio/video programming to playing devices and/or recording devices such as, but not limited to, televisions, video recorders, stereos, and audio recorders. Furthermore, some embodiments of a set-top box have a CPU and memory for running logic to perform the tasks of the set-top box. This is only one potential embodiment of a set-top box and those skilled in the art will be aware of other possible embodiments. Also, set-top boxes need not necessarily be separate from audio/video recording/playing devices. Thus, a set-top box might be incorporated into a television set.

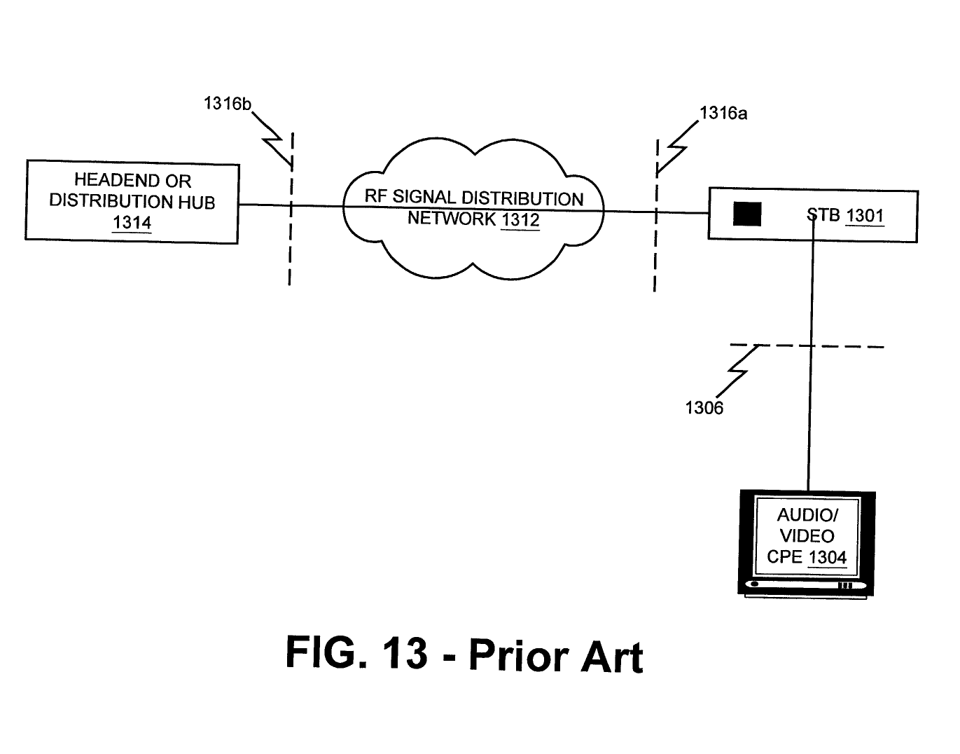

FIG. 13

FIG. 13 shows a set-top box (STB) 1301 connected to audio/video (A/V) customer premise equipment (CPE) 1304. In addition, interface 1306 defines the connectivity between STB 1301 and A/V CPE 1304. The most common example of A/V CPE 1304 is a television set. However, in general A/V CPE 1304 may be any device used for converting signals containing programming into information that may interpreted by human senses such as hearing and/or sight. The signals containing programming generally are broadcast over RF signal distribution network 1312 from headend or distribution hub 1314. Normally, the RF signal distribution network 1312 has an interface 1316a that is known as the subscriber, customer, or user side of the interface because it generally defines the capabilities of customer or subscriber devices, and because it generally may be closer to customer or subscriber devices. In contrast, interface 1316b is often known as the network or service provider side of the interface because it generally defines the capabilities of network or service provider devices, and because it generally may be closer to network or service provider devices.

Historically, the signals in CATV networks have carried broadcast programming that was communicated using analog signals. These analog signals were frequency-division multiplexed (FDM) into a coaxial cable. However newer digital technologies have been replacing these analog FDM systems of RF signal distribution network 1312. Nothing in this specification is intended to limit the embodiments of the present invention to only work with any particular type of RF signal distribution network 1312 such as analog, FDM CATV systems. Furthermore, interface 1306 between STB 1301 and A/V CPE 1304 may use any past, present, or future method of encoding and communicating audio and/or video information. These methods include, but are not limited to, analog technologies such as NTSC (National Television Systems Committee) or PAL (phase alternate line) as well as digital technologies such as some high definition TV (HDTV) encodings. Furthermore, the information communicated from STB 1301 to A/V CPE 1304 over interface 1306 may be encoded utilizing MPEG (Motion Pictures Expert Group) technology that also may use various compression algorithms. In addition, the physical connections of interface 1306 include, but are not limited to, some historical physical connections such as coaxial cable, S-Video, and RCA jacks or phono plugs. Usually a coaxial cable has carried the information from a set-top box to a TV in a channel that is frequency-shifted or modulated onto TV channels 2, 3, or 4. In contrast, some other physical cabling technologies such as RCA jacks or phono plugs generally do not carry a signal that has been frequency-shifted or modulated from its base range of frequencies. In general, the information communicated to A/V CPE 1304 has predominately been in the downstream direction from headend or distribution hub 1314, over RF signal distribution network 1312, through STB 1301, and to A/V CPE 1304. The capabilities of RF signal distribution network 1312 were originally designed for the downstream delivery of broadcast programming or information.

In addition, set-top boxes (STBs) have sometimes used an on-screen user interface that displays menus for configurations and selections on an audio/video CPE device 1304 such as, but not limited to, a television (TV). STBs with on-screen programming usually have some processes or functions for generating graphics that are communicated over interface 1306 to A/V CPE 1304 and are visually displayed to the user. Furthermore, STB users often control the behavior of the STB, adjust the settings in the STB, and setup the configuration of the STB using a remote control. Commonly, the remote control communicates with a set-top box over at least one communications media that generally has properties such as, but not limited to, wireless, infrared, line-of-site transmission between the remote control and the STB. The most common uses for the remote control are to change the TV channel and adjust the audio volume of the TV speakers.

Historically, set-top boxes included functionality to tune to various frequency channels in the FDM CATV RF distribution network. With the movement towards digital transmission in CATV RF networks, STBs will likely still be used to select channels; however, the channels may no longer identify frequencies in the CATV RF distribution network. As a non-limiting example, a newer technology STB connected to a digital CATV distribution network may select various streams of digital programming based on a user's selection of a channel identifier. For older analog, FDM technology, the channel identifier was just a number that caused an STB to tune to a particular range of frequencies. In addition, STBs often are used for descrambling premium CATV channels that are scrambled by the CATV service provider to separately charge for premium channels. Instead of scrambling analog signals, more modem STBs may use digital encryption and decryption. Also, STBs may have to convert from the digital information (such as MPEG packets) transmitted over the RF distribution network into analog signals that can be interpreted by analog audio/video (A/V) CPE 1304 such as an NTSC television set that is ubiquitously deployed throughout North America.

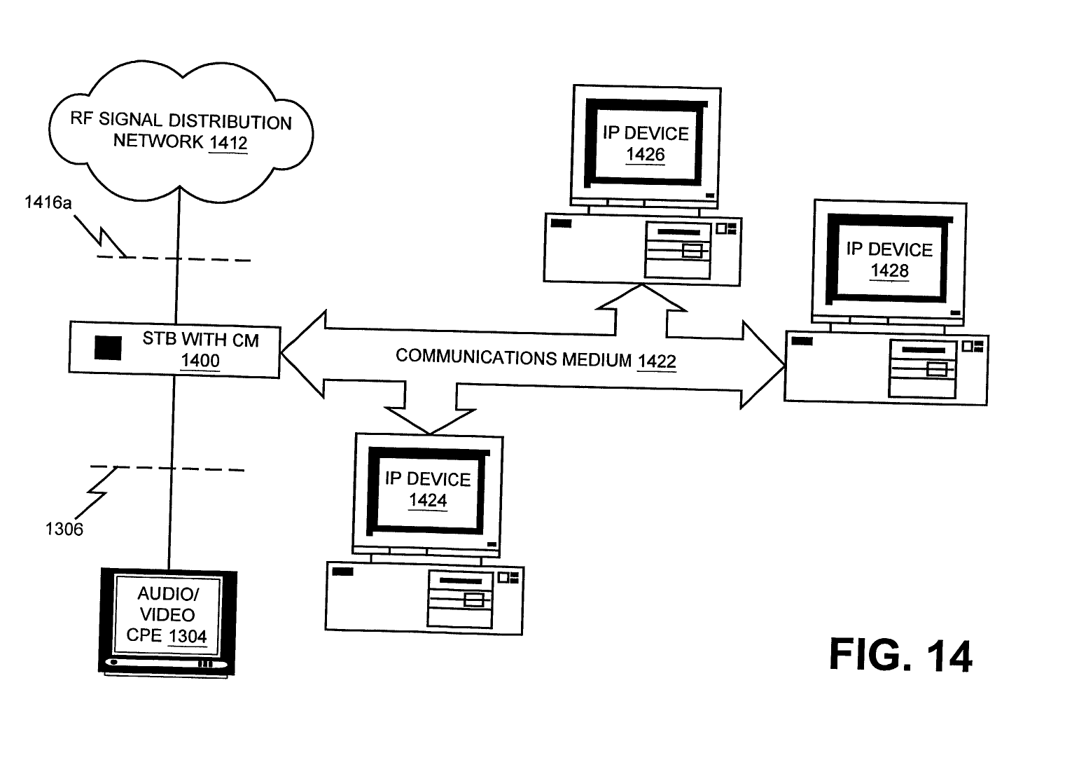

FIG. 14

FIG. 14 shows a set-top box (STB) with cable modem (CM) 1400 connected to audio/video CPE 1304 over interface 1306. A non-limiting example of audio/video CPE 1304 might be a television set. In addition, a non-limiting example of interface 1306 might include an NTSC formatted signal that is modulated into a coax cable on TV channel 3. Furthermore, STB with CM 1400 is connected to RF signal distribution network 1412 over RF cable interface 1416a. RF cable interface 1416a will commonly be a single connection that carries both signals for audio/video customer premise equipment and cable data network customer premise equipment. However, the embodiments of the present invention are not limited to situations in which both audio/video programming and data services are delivered over one connection. As a non-limiting example, STB with CM 1400 may have one RF cable connection for cable audio/video programming and a different RF cable connection for cable data network services. In addition, there might be different RF signal distribution networks 1412 for cable audio/video programming and for cable data network services. Probably the most common non-limiting example of RF cable interface 1416a includes a single coax cable, while the most common non-limiting example of RF signal distribution network 1412 is a hybrid fiber-coax (HFC) system.

In addition to its other connections, STB with CM 1400 is connected to communications medium 1422 at a customer premise. Communications medium 1422 is further connected to three IP devices 1424, 1426, and 1428. Although FIG. 14 shows STB with CM 1400 connected to only communications medium 1422 for communicating with customer premise data devices such as IP devices 1424, 1426, and 1428, in general STB with CM 1400 may be connected to at least one medium at the customer premise that is further connected to customer premise data devices. Thus, STB with CM 1400 may be connected to more than one communications media at the customer premise for communicating with customer premise data devices. Furthermore, if STB with CM 1400 is connected to more than one medium for communicating with customer premise data devices, then the multiple media may or may not be the same type of communications media. As a non-limiting example, STB with CM 1400 may be connected to some customer premise data devices using a wired ethernet medium and to other customer premise data devices using a wireless medium. In addition, the customer premise data devices also might be processes internal to STB with CM 1400. If all the customer premise data devices are internal processes within STB with CM 1400, then STB with CM 1400 might not have any externally connected customer premise communications media for cable modem functionality.

In general, set-top box with cable modem (STB with CM) 1400 is capable of forwarding many network level protocols between RF cable interface 1416a and communications media for connecting customer premise data devices, such as communications medium 1422. (Under DOCSIS a cable modem or a device with cable modem functionality generally uses layer two bridging as a forwarding construct between the RF cable interface and communications media connected to customer premise data networking equipment.) Therefore, customer premise data devices generally may utilize any protocol including other protocols instead of or in addition to the Internet Protocol (IP). However, the network address translation (NAT) utilized in some of the preferred embodiments of the present invention generally is used for translating information conforming to the TCP/IP protocol suite. Thus, the customer premises data networking devices in FIGS. 14-18 are shown as IP devices.

IP devices in FIGS. 14-18 (such as IP devices 1424, 1426, and 1428 in FIG. 14) are customer premise data devices that are capable of using at least one variant of the Internet Protocol (IP). These variants include, but are not limited to, IPv4, IPng, and/or IPv6. At most customer premises, IP devices 1424, 1426, and 1428 generally are IP hosts or end systems. However, set-top box with cable modem (STB with CM) 1400 also will work if the IP devices are intermediate systems with IP protocol stacks for forwarding IP datagrams and/or user applications such as, but not limited to, network management and configuration. Also, even though IP devices in FIGS. 14-18 are represented pictorially as personal computers, this is only for illustrative purposes and is not meant to introduce any limitations on the type of equipment that may be an IP device. IP devices generally may be any device capable of running a process that uses any variant of the IP protocol such as, but not limited to, personal computers, workstations, and telephones. In addition, IP devices may be special purpose processors for applications such as, but not limited to, utility meter reading and home automation. Furthermore, if the cable modem functionality of STB with CM 1400 follows the DOCSIS standards, then it is also an IP device with an IP address being assigned by the DOCSIS CMTS for configuration and management. However, the IP address assigned to the cable modem functionality of STB with CM 1400 for configuration and management need not necessarily come from the same subnet as the IP addresses assigned to other customer or subscriber devices such as IP devices 1424, 1426, and/or 1428.

In general, IP devices 1424, 1426, and 1428 should have globally-valid, internet IP addresses to have simultaneous access to the internet for each device without utilizing network address translation (NAT) or some other form of access gateway, such as, but not limited to, a proxy. A non-limiting example of IP address assignment for FIG. 14 might be or IP device 1424 to have the global, public IP address of 135.100.25.101, for IP device 1426 to have the global, public IP address of 135.100.25.102, and for IP device 1428 to have the global, public IP address of 135.100.25.103. In this way each device could have access to the internet through set-top box with cable modem 1400. However, service providers usually charge for additional globally-valid, public IP addresses beyond the one IP address provided in the basic monthly service charge for an account. Thus, this non-limiting example IP address assignment for FIG. 14 may not be preferred by customers.

In general, the communications media for connecting customer premise data devices in FIGS. 14-18, such as communications medium 1422, might be any form of communications media. However, as the functionality of cable modems generally is designed to connect customer or subscriber premises to service providers, the communications media in FIGS. 14-18, such as communications medium 1422, are likely to use a technology such as, but not limited to, a LAN (local area network) designed for communications within a relatively small geographic area. Often a LAN will be contained within a single building such as a customer's residence or a commercial structure.

The form of communications medium 1422 and the communications media for connecting customer premise data devices in FIGS. 14-18 includes, but is not limited to, wired or wireless as well as point-to-point or shared with contention determined by a centralized algorithm or by a distributed algorithm. Furthermore, the communications media might possibly use multiplexing techniques such as, but not limited to, time-division multiplexing (TDM) and/or frequency-division multiplexing (FDM) as well as possibly use spread spectrum technologies such as, but not limited to, frequency hopping and/or direct sequence techniques. These direct sequence techniques might include, but are not limited to, code division multiple access (CDMA).

However, despite the fact that communications medium 1422 and the communications media in FIGS. 14-18 are generally any communications media, the DOCSIS cable modem to customer premise equipment (CMCI) specification covers a standard for interfacing DOCSIS CMCI-compliant cable modems to some types of CPE. This DOCSIS CMCI standard only describes three interfaces for communications media, such as communications medium 1422 in FIG. 14, that are used for connecting a cable modem or a device with cable modem functionality (such as STB with CM 1400) to customer premise equipment (CPE) such as IP device 1424. DOCSIS CMCI describes a LAN interface using ethernet, an external computer bus interface using universal serial bus (USB), and an internal computer bus interface using the peripheral component interconnect (PCI) bus. Thus, to be compliant with the DOCSIS CMCI specification, a cable modem or a device with cable modem functionality should interface to CPE using ethernet (including IEEE 802.3), USB, or PCI.

The general system level cable data network architecture for connecting IP devices to cable modems is covered in DOCSIS. However, the DOCSIS CMCI specifications heretofore have limited the communications medium 1522 for DOCSIS cable modems to only ethernet (as well as IEEE 802.3), USB, and PCI.

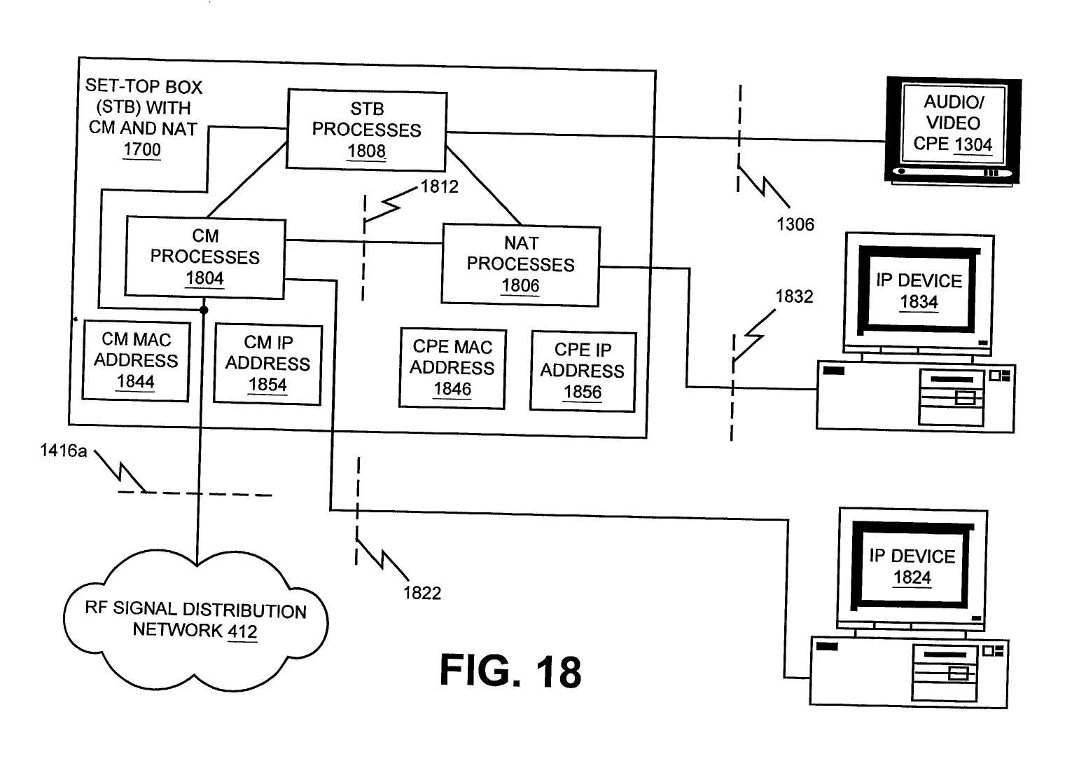

Despite these limitations of DOCSIS CMCI, in the embodiments of the present invention, communications medium 1422 may be any form of communications medium for connecting customer premise data devices. If STB with CM 1400 uses some other communications media than ethernet, USB, or PCI for communications medium 1422, then STB with CM 1400 will not be compliant with the DOCSIS CMCI standard. However, such a device with cable modem functionality might still comply with the DOCSIS CM RFI (cable modem radio frequency interface) specifications and/or the DOCSIS CM TRI (cable modem telephony return interface) specification. STB with CM 1400 could use technologies other than ethernet, USB, and PCI for communications medium 1422 and still comply with these DOCSIS standards by appearing no different than an ethernet attached cable modem, when viewed from its RF cable interface (CM RFI). The details of a device such as STB with CM 1400 appearing no different than an ethernet attached DOCSIS cable modem are further covered in the description below generally regarding FIG. 18.

Also, STB with CM 1400 may include processes that utilize DOCSIS to communicate information with processing systems that are not related to providing cable modem connectivity to customer premise data devices. As a non-limiting example, STB with CM 1400 generally may utilize DOCSIS to allow STB with CM 1400 to have IP connectivity as an end-system IP device for the purpose of obtaining advertising messages using IP datagrams and displaying the advertising through interface 1306 on A/V CPE 1304 (e.g., a television). Such use of IP connectivity by STB with CM 1400 is not a normal cable modem function within DOCSIS. Thus, this non-limiting example use of IP connectivity by STB with CM 1400 would be considered to be a customer or user application that is not defined by the DOCSIS standards.

However, for STB with CM 1400 to run such user applications or user processes and to appear no different than an ethernet attached DOCSIS cable modem, STB with CM 1400 generally should have a CPE MAC address and a CPE IP address that are different from a cable modem (CM) MAC address and a cable modem (CM) IP address. A cable modem (CM) MAC address and a cable modem (CM) IP address are used by DOCSIS for tasks such as, but not limited to, configuring and maintaining a cable modem or a device with cable modem functionality (e.g., STB with CM 1400). A CM MAC address and a CM IP address generally are not supposed to be utilized for user applications. More details on CPE MAC addresses, on CPE IP addresses, and on running user processes on STB with CM 1400 are covered in the description of FIG. 18, which describes integrated network address translation (NAT) in an STB with cable modem functionality. Generally, processes for network address translation (NAT) appear to the DOCSIS standards as user processes.

In addition, integrating cable modem functionality within a set-top box may allow additional or different user interfaces from the standard user interfaces for setting up data devices such as cable modems. These new user interfaces may simplify tasks such as, but not limited to, set-up, configuration, and/or diagnostics of the cable modem functionality within a set-top box. Furthermore, these tasks might be capable of being performed through user interfaces normally associated with set-top boxes including, but not limited to, on screen programming using an infrared remote control for input and using an audio/video (A/V) CPE 1304 for output. As a non-limiting example, displaying output on audio/video (A/V) CPE 1304 may provide users or subscribers with much more diagnostic feedback on the status and performance of the cable modem functionality of a set-top box than the simplified feedback status provided by some cable modems currently available in the market. Some of the currently available cable modems only use a limited number of LEDs (light emitting diodes) on the front of the cable modem to provide user feedback.

In general, the term “integration” in the computer and networking fields involves combining or blending previously separate activities, programs, processes, functions, and/or hardware components into a functional whole. Within the context of the embodiments of the present invention, the terms integrated and integration generally imply that two items that are integrated together share some resources more than a communications media connecting the items and more than any instances of the algorithms of media access control (MAC) protocols that correspond to the communications media shared by the two items. (Generally communications media are not considered to be communications devices, and thus communications media do not actively retain state information beyond the time it takes to propagate a signal through the media. However, when two communications devices are connected to a communications media, the devices may share some information on the state of the communications media because each device generally may be running processes that are at least one instance of the media access control (MAC) protocol for that communications media.)

For the embodiments of the present invention, two integrated items generally are within the same box or device and/or generally use the same at least one connection to an electrical power outlet. (The power outlet need not necessarily be an alternating current (A.C.) power outlet.) Generally, in addition to sharing at least one power source and/or being in the same box or device, integrated items may share other resources of a device or box such as, but not limited to, processing and/or storage. The shared processing may or may not include the use of at least one microprocessor, and the shared storage may or may not include the use of at least one digital memory. Furthermore, the resources shared by integrated items may include software and/or hardware (such as, but not limited to, circuitry and/or logic). Also, the integration of items into one device or box generally allows the device or box to use at least one common user interface for the integrated items. In effect, the integrated items generally share at least one common user interface for the device or box.

Because communications medium 1422 is not necessarily limited to the DOCSIS CMCI-compliant communications media of ethernet, USB, and PCI, FIG. 14 shows the potential integration of non-DOCSIS communications media into a set-top box with cable modem functionality that generally may be compliant with DOCSIS RFI and/or DOCSIS TRI. Furthermore, because communications medium 1422 for communicating with customer premise data devices is at least one communications medium, FIG. 14 shows the potential integration of interfaces for more than one communications media into a set-top box with cable modem functionality. The more than one communications media (represented in FIG. 14 by communications medium 1422) connected to the set-top box generally are used for communicating with customer premise data devices. Also, a set-top box with cable modem functionality that further has multiple communications media for communicating with customer premise data network devices may or may not be compliant with DOCSIS RFI and/or DOCSIS TRI.

In addition, FIG. 14 shows the integration of cable modem functionality into a set-top box. The cable modem functionality of a set-top box may or may not be DOCSIS cable modem functionality. The integration of items in the embodiments of the present invention allows for capabilities and/or functions that generally were not available in solutions using separate (non-integrated) devices, components, and/or functions.

In general, the integration of additional functionality into a set-top box may or may not require additional processing capacity and/or storage capacity such as, but not limited to, digital memory. Furthermore, sometimes the integration of additional functionality into a set-top box might require additional software and/or hardware such as, but not limited to, circuitry and logic. Generally, integrating more functionality into a set-top box often increases the amount of hardware and/or software needed in the device, which usually raises the production costs of the device. To have a common platform for set-top boxes and to maintain a low price point for entry-level set-top box devices with lesser functionality, the additional hardware and/or software, which may be needed to support the integration of more advanced functionality, might be implemented in optional modules. These optional modules might be modular option cards or expansion cards that may be installed at the factory or possibly in the field (e.g., at the customer premise) by service technicians and/or customers. Furthermore, software upgrades might be downloaded to the set-top box through any communications media connected to the cable modem.

Some examples of interfaces that might be used for connecting expansion modules to a set-top box include, but are not limited to, the interfaces that have historically been used for expansion interfaces. A few particular non-limiting examples of these historical expansion interfaces are: 1) the AT/ISA bus (Advanced Technology/Industry Standard Architecture) of older PCs, 2) the PCMCIA (Personal Computer Memory Card International Association or PC Card) standard generally used for laptops, and 3) the PCI (Peripheral Component Interconnect) bus of newer PCs. In addition to industry standard expansion interfaces, many equipment vendors in the computer and networking fields often have designed their own proprietary expansion interfaces. None of these examples of expansion interfaces are meant to be limiting as there are many existing standard and proprietary expansion interfaces, and many new and modified expansion interfaces likely will be developed in the future.

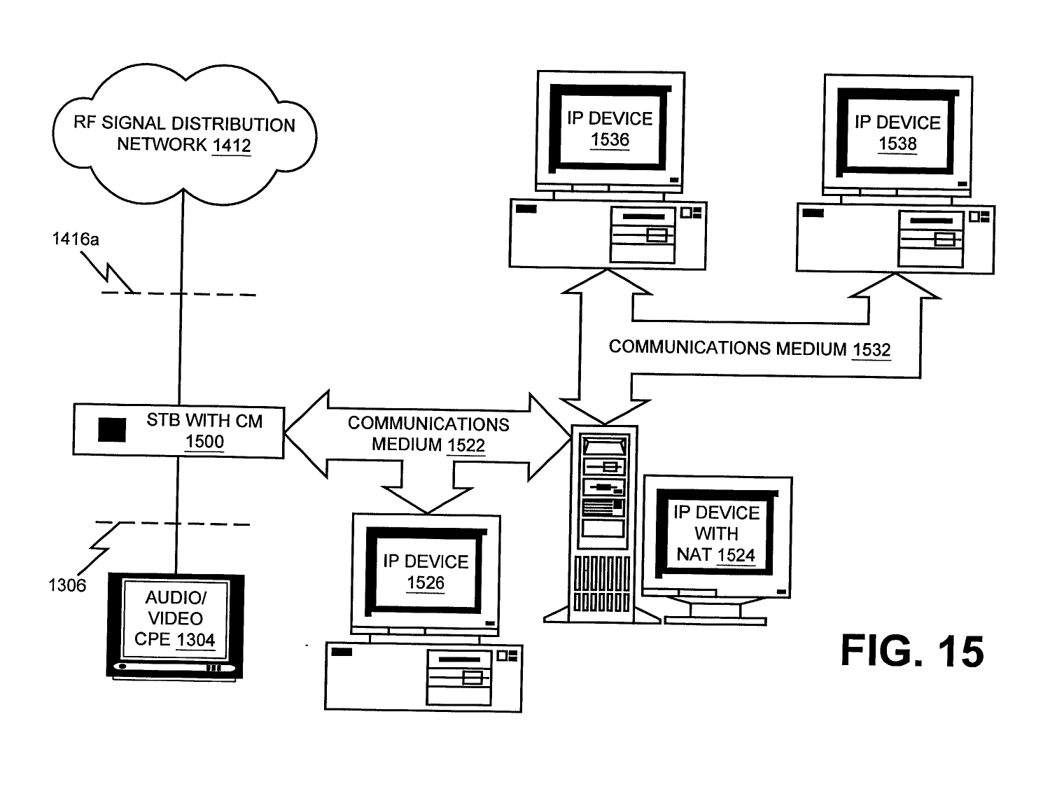

FIG. 15

FIG. 15 shows a set-top box (STB) with cable modem (CM) 1500 connected to audio/video CPE 1304 over interface 1306. A non-limiting example of audio/video CPE 1304 might be a television set. In addition, a non-limiting example of interface 1306 might include an NTSC formatted signal that is modulated into a coax cable on TV channel 3. Furthermore, STB with CM 1500 is connected to RF signal distribution network 1412 over RF cable interface 1416a. RF cable interface 1416a will commonly be a single connection that carries both signals for audio/video customer premise equipment and cable data network customer premise equipment. However, the embodiments of the present invention are not limited to situations in which both audio/video programming and data services are delivered over one connection. As a non-limiting example, STB with CM 1500 may have one RF cable connection for cable audio/video programming and a different RF cable connection for cable data network services. In addition, there might be different RF signal distribution networks 1412 for cable audio/video programming and for cable data network services. Probably the most common non-limiting example of RF cable interface 1416a includes a single coax cable, while the most common non-limiting example of RF signal distribution network 1412 is a hybrid fiber-coax (HFC) system.

Furthermore, FIG. 15 shows a non-limiting example of how an external, non-integrated NAT device might be used in a customer or subscriber network to provide internet access to more IP devices than have been assigned internet-valid, public IP addresses. In FIG. 15 set-top box (STB) with cable modem (CM) 1500 is connected to RF signal distribution network 1412, which conforms to interface 1416a. In addition, CM 1500 is connected to communications medium 1522, which is further connected to IP device with NAT 1524 and IP device 1526. Although FIG. 15 shows STB with CM 1500 connected to only communications medium 1522 for communicating with customer premise data devices such as IP devices 1524 and 1526, in general STB with CM 1500 may be connected to at least one medium at the customer premise that is further connected to customer premise data devices. Thus, STB with CM 1500 may be connected to more than one communications media at the customer premise for communicating with customer premise data devices. Furthermore, if STB with CM 1500 is connected to more than one medium for communicating with customer premise data devices, then the multiple media may or may not be the same type of communications media. As a non-limiting example, STB with CM 1500 may be connected to some customer premise data devices using a wired ethernet medium and to other customer premise data devices using a wireless medium. In addition, the customer premise data devices also might be processes internal to STB with CM 1500. If all the customer premise data devices are internal processes within STB with CM 1500, then STB with CM 1500 might not have any externally connected customer premise communications media for cable modem functionality.

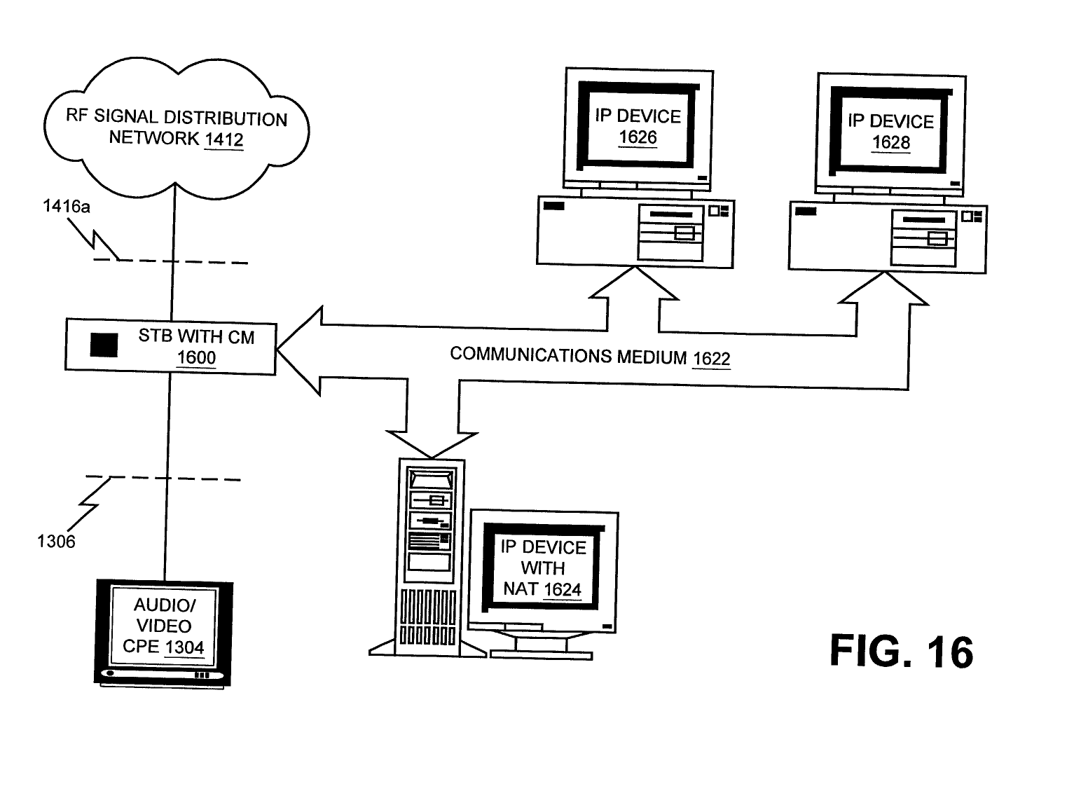

Although FIGS. 15 and 16 show the non-integrated IP devices with NAT (such as IP device with NAT 1524) pictorially as tower/server computers as opposed to the desktop computers used to represent the other IP devices, this pictorial difference in the figures between tower/server computers and desktop computers is not meant to have any functional significance and is only used to more quickly identify the devices in the figures that are functioning as NAT devices. IP device with NAT 1524 is connected to both communications medium 1522 and communications medium 1532. IP devices 1536 and 1538 are connected to communications medium 1532.

In general, set-top box with cable modem (STB with CM) 1500 is capable of forwarding many network level protocols between RF cable interface 1416a and communications media for connecting customer premise data devices, such as communications medium 1522. (Under DOCSIS a cable modem or a device with cable modem functionality generally uses layer two bridging as a forwarding construct between the RF cable interface and communications media connected to customer premise data networking equipment.) Therefore, customer premise data devices generally may utilize other protocols instead of or in addition to the Internet Protocol (IP). However, the network address translation (NAT) utilized in some of the preferred embodiments of the present invention generally is used for translating information conforming to the TCP/IP protocol suite. Thus, the customer premise data devices in FIG. 15 are shown as IP devices.

IP devices 1524, 1526, 1536, and 1538 in FIG. 15 are customer premise data devices that are capable of using at least one variant of the Internet Protocol (IP). These variants include, but are not limited to, IPv4, IPng, and/or IPv6. At most customer premises, IP devices 1526, 1536, and 1538 generally are IP hosts or end systems. However, set-top box with cable modem 1500 also will work if the IP devices are intermediate systems with IP protocol stacks for forwarding IP datagrams and/or user applications such as, but not limited to, network management and configuration. Also, even though IP devices in FIG. 15 are represented pictorially as personal computers, this is only for illustrative purposes and is not meant to introduce any limitations on the type of equipment that may be an IP device. IP devices generally may be any device capable of running a process that uses any variant of the IP protocol such as, but not limited to, personal computers, workstations, and telephones. In addition, IP devices may be special purpose processors for applications such as, but not limited to, utility meter reading and home automation. Although IP device with NAT 1524 could utilize the networking constructs or models of other intermediate systems, usually IP device with NAT 1524 generally functions as an IP router with the additional functionality of network address translation (NAT). Furthermore, if the cable modem functionality of STB with CM 1500 follows the DOCSIS standards, then it is also an IP device with an IP address being assigned by the DOCSIS CMTS for configuration and management. However, the IP address assigned to the cable modem functionality of STB with CM 1500 for configuration and management need not necessarily come from the same subnet as the IP addresses assigned to other customer or subscriber devices such as IP devices 1524 and/or 1526.

A non-limiting example of IP address assignment for FIG. 15 might be for IP device 1526 to have the global, public IP address of 135.100.25.101, while IP device with NAT 1524 has the global, public IP address of 135.100.25.102 for its interface in communications medium 1522. Because both IP device 1526 and IP device with NAT 1524 have internet-valid, public IP addresses, both of these devices may transparently access the internet without needing network address translation (NAT) functionality. In contrast, suppose IP device with NAT 1524 has private IP address 10.0.0.124 on its interface in communications medium 1532 and suppose that IP device 1536 and IP device 1538 have private IP addresses 10.0.0.136 and 10.0.0.138, respectively. Then to access the internet, IP devices 1536 and 1538 might use IP device with NAT 1524 to provide network address translation on all packets communicated between IP devices 1536 and 1538 and the internet. Because in this example IP device with NAT 1524 has only one internet-valid, public IP address of 135.100.25.102, IP device with NAT 1524 generally should use NAPT (Network Address Port Translation) to allow the two IP devices 1536 and 1538 to access the internet simultaneously.

In general, the communications media such as communications medium 1522 and communications medium 1532 might be any form of communications media for connecting customer premise data devices. However, as the functionality of cable modems generally is designed to connect customer or subscriber premises to service providers, communications media 1522 and 1532 in FIG. 15 are likely to use a technology such as, but not limited to, a LAN (local area network) designed for communications within a relatively small geographic area. Often a LAN will be contained within a single building such as a customer's residence or a commercial structure.

The form of communications media 1522 and 1532 for connecting customer premise data devices includes, but is not limited to, wired or wireless as well as point-to-point or shared with contention determined by a centralized algorithm or by a distributed algorithm. Furthermore, the communications media might possibly use multiplexing techniques such as, but not limited to, time-division multiplexing (TDM) and/or frequency-division multiplexing (FDM) as well as possibly use spread spectrum technologies such as, but not limited to, frequency hopping and/or direct sequence techniques. These direct sequence techniques might include, but are not limited to, code division multiple access (CDMA).

However, despite the fact that communications media 1522 and 1532 are generally any communications media for connecting customer premise data devices, the DOCSIS cable modem to customer premise equipment (CMCI) specification covers a standard for interfacing DOCSIS CMCI-compliant cable modems to some types of CPE. This DOCSIS CMCI standard only describes three interfaces for communications media, such as communications medium 1522 in FIG. 15, that are used for connecting a cable modem or a device with cable modem functionality (such as STB with CM 1500) to customer premise equipment (CPE) such as IP device 1526. DOCSIS CMCI describes a LAN interface using ethernet, an external computer bus interface using universal serial bus (USB), and an internal computer bus interface using the peripheral component interconnect (PCI) bus. Thus, to be compliant with the DOCSIS CMCI specification, a cable modem or a device with cable modem functionality should interface to CPE using ethernet (including IEEE 802.3), USB, or PCI.

The general system level cable data network architecture for connecting IP devices to cable modems is covered in DOCSIS. Also, the use of a non-integrated, NAT router with external connections to a cable modem in one communications medium and to other IP devices in another communications medium commonly has been deployed by users. However, the DOCSIS CMCI specifications heretofore have limited the communications medium 1522 for DOCSIS cable modems to only ethernet (as well as IEEE 802.3), USB, and PCI.

Despite these limitations of DOCSIS CMCI, in the embodiments of the present invention, communications medium 1522 may be any form of communications medium for connecting customer premise data devices. If set-top box with cable modem 1500 uses some other communications media than ethernet, USB, or PCI for communications medium 1522, then set-top box with cable modem 1500 will not be compliant with the DOCSIS CMCI standard. However, such a device with cable modem functionality might still comply with the DOCSIS CM RFI (cable modem radio frequency interface) specifications and/or the DOCSIS CM TRI (cable modem telephony return interface) specification. Set-top box with cable modem 1500 could use technologies other than ethernet, USB, and PCI for communications medium 1522 and still comply with these DOCSIS standards by appearing no different than an ethernet attached cable modem, when viewed from its RF cable interface (CM RFI). The details of a CM appearing no different than an ethernet attached DOCSIS cable modem are further covered in the description below generally regarding FIG. 18. In contrast to communications medium 1522, communications medium 1532 is not defined by DOCSIS and may be any type of communications medium that might be used for distributing signals at a customer premise.

Also, STB with CM 1500 may include processes that utilize DOCSIS to communicate information with processing systems that are not related to providing cable modem connectivity to customer premise data devices. As a non-limiting example, STB with CM 1500 generally may utilize DOCSIS to allow STB with CM 1500 to have IP connectivity as an end-system IP device for the purpose of obtaining advertising messages using IP datagrams and displaying the advertising through interface 1306 on A/V CPE 1304 (e.g., a television). Such use of IP connectivity by STB with CM 1500 is not a normal cable modem function within DOCSIS. Thus, this non-limiting example use of IP connectivity by STB with CM 1500 would be considered to be a customer or user application that is not defined by the DOCSIS standards.

However, for STB with CM 1500 to run such user applications or user processes and to appear no different than an ethernet attached DOCSIS cable modem, STB with CM 1500 generally should have a CPE MAC address and a CPE IP address that are different from a cable modem (CM) MAC address and a cable modem (CM) IP address. A cable modem (CM) MAC address and a cable modem (CM) IP address are used by DOCSIS for tasks such as, but not limited to, configuring and maintaining a cable modem or a device with cable modem functionality (e.g., STB with CM 1500). A CM MAC address and a CM IP address generally are not supposed to be utilized for user applications. More details on CPE MAC addresses, on CPE IP addresses, and on running user processes on STB with CM 1500 are covered in the description of FIG. 18, which describes integrated network address translation (NAT) in an STB with cable modem functionality. Generally, processes for network address translation (NAT) appear to the DOCSIS standards as user processes.

In addition, integrating cable modem functionality within a set-top box may allow additional or different user interfaces from the standard user interfaces for setting up data devices such as cable modems. These new user interfaces may simplify tasks such as, but not limited to, set-up, configuration, and/or diagnostics of the cable modem functionality within a set-top box. Furthermore, these tasks might be capable of being performed through user interfaces normally associated with set-top boxes including, but not limited to, on screen programming using an infrared remote control for input and using an audio/video (A/V) CPE 1304 for output. As a non-limiting example, displaying output on audio/video (A/V) CPE 1304 may provide users or subscribers with much more diagnostic feedback on the status and performance of the cable modem functionality of a set-top box than the simplified feedback status provided by some cable modems currently available in the market. Some of the currently available cable modems only use a limited number of LEDs (light emitting diodes) on the front of the cable modem to provide user feedback. Also, the user interfaces from a set-top box might be used for processes such as, but not limited to, configuring some packet filters that affect the cable modem functionality of a set-top box with an integrated cable modem.

In general, the term “integration” in the computer and networking fields involves combining or blending previously separate activities, programs, processes, functions, and/or hardware components into a functional whole. Within the context of the embodiments of the present invention, the terms integrated and integration generally imply that two items that are integrated together share some resources more than a communications media connecting the items and more than any instances of the algorithms of media access control (MAC) protocols that correspond to the communications media shared by the two items. (Generally communications media are not considered to be communications devices, and thus communications media do not actively retain state information beyond the time it takes to propagate a signal through the media. However, when two communications devices are connected to a communications media, the devices may share some information on the state of the communications media because each device generally may be running processes that are at least one instance of the media access control (MAC) protocol for that communications media.)

For the embodiments of the present invention, two integrated items generally are within the same box or device and/or generally use the same at least one connection to an electrical power outlet. (The power outlet need not necessarily be an alternating current (A.C.) power outlet.) Generally, in addition to sharing at least one power source and/or being in the same box or device, integrated items may share other resources of a device or box such as, but not limited to, processing and/or storage. The shared processing may or may not include the use of at least one microprocessor, and the shared storage may or may not include the use of at least one digital memory. Furthermore, the resources shared by integrated items may include software and/or hardware (such as, but not limited to, circuitry and/or logic). Also, the integration of items into one device or box generally allows the device or box to use at least one common user interface for the integrated items. In effect, the integrated items generally share at least one common user interface for the device or box.

Because communications medium 1522 is not necessarily limited to the DOCSIS CMCI-compliant communications media of ethernet, USB, and PCI, FIG. 15 shows the potential integration of non-DOCSIS communications media into a set-top box with cable modem functionality that generally may be compliant with DOCSIS RFI and/or DOCSIS TRI. Furthermore, because communications medium 1522 for communicating with customer premise data devices is at least one communications medium, FIG. 15 shows the potential integration of interfaces for more than one communications media into a set-top box with cable modem functionality. The more than one communications media (represented in FIG. 15 by communications medium 1522) connected to the set-top box generally are used for communicating with customer premise data devices. Also, a set-top box with cable modem functionality that further has multiple communications media for communicating with customer premise data network devices may or may not be compliant with DOCSIS RFI and/or DOCSIS TRI.

In addition, FIG. 15 shows the integration of cable modem functionality into a set-top box. The cable modem functionality of a set-top box may or may not be DOCSIS cable modem functionality. The integration of items in the embodiments of the present invention allows for capabilities and/or functions that generally were not available in solutions using separate (non-integrated) devices, components, and/or functions.

In general, the integration of additional functionality into a set-top box may or may not require additional processing capacity and/or storage capacity such as, but not limited to, digital memory. Furthermore, sometimes the integration of additional functionality into a set-top box might require additional software and/or hardware such as, but not limited to, circuitry and logic. Generally, integrating more functionality into a set-top box often increases the amount of hardware and/or software needed in the device, which usually raises the production costs of the device. To have a common platform for set-top boxes and to maintain a low price point for entry-level set-top box devices with lesser functionality, the additional hardware and/or software, which may be needed to support the integration of more advanced functionality, might be implemented in optional modules. These optional modules might be modular option cards or expansion cards that may be installed at the factory or possibly in the field (e.g., at the customer premise) by service technicians and/or customers. Furthermore, software upgrades might be downloaded to the set-top box through any communications media connected to the cable modem.

Some examples of interfaces that might be used for connecting expansion modules to a set-top box include, but are not limited to, the interfaces that have historically been used for expansion interfaces. A few particular non-limiting examples of these historical expansion interfaces are: 1) the AT/ISA bus (Advanced Technology/Industry Standard Architecture) of older PCs, 2) the PCMCIA (Personal Computer Memory Card International Association or PC Card) standard generally used for laptops, and 3) the PCI (Peripheral Component Interconnect) bus of newer PCs. In addition to industry standard expansion interfaces, many equipment vendors in the computer and networking fields often have designed their own proprietary expansion interfaces. None of these examples of expansion interfaces are meant to be limiting as there are many existing standard and proprietary expansion interfaces, and many new and modified expansion interfaces likely will be developed in the future.

FIG. 16

FIG. 16 shows a set-top box (STB) with cable modem (CM) 1600 connected to audio/video CPE 1304 over interface 1306. A non-limiting example of audio/video CPE 1304 might be a television set. In addition, a non-limiting example of interface 1306 might include an NTSC formatted signal that is modulated into a coax cable on TV channel 3. Furthermore, STB with CM 1600 is connected to RF signal distribution network 1412 over RF cable interface 1416a. RF cable interface 1416a will commonly be a single connection that carries both signals for audio/video customer premise equipment and cable data network customer premise equipment. However, the embodiments of the present invention are not limited to situations in which both audio/video programming and data services are delivered over one connection. As a non-limiting example, STB with CM 1600 may have one RF cable connection for cable audio/video programming and a different RF cable connection for cable data network services. In addition, there might be different RF signal distribution networks 1412 for cable audio/video programming and for cable data network services. Probably the most common non-limiting example of RF cable interface 1416a includes a single coax cable, while the most common non-limiting example of RF signal distribution network 1412 is a hybrid fiber-coax (HFC) system.

FIG. 16 shows another non-limiting example of how an external, non-integrated NAT device might be used in a customer or subscriber network to provide internet access to more IP devices than have been assigned internet-valid, public IP addresses. In FIG. 16 set-top box (STB) with cable modem (CM) 1600 is connected to RF signal distribution network 1412, which conforms to interface 1416a. In addition, STB with CM 1600 is connected to communications medium 1622, which is further connected to IP device with NAT 1624 as well as IP devices 1626 and 1628. Although FIG. 16 shows STB with CM 1600 connected to only communications medium 1622 for communicating with customer premise data devices such as IP devices 1624, 1626, and 1628, in general STB with CM 1600 may be connected to at least one medium at the customer premise that is further connected to customer premise data devices. Thus, STB with CM 1600 may be connected to more than one communications media at the customer premise for communicating with customer premise data devices. Furthermore, if STB with CM 1600 is connected to more than one medium for communicating with customer premise data devices, then the multiple media may or may not be the same type of communications media. As a non-limiting example, STB with CM 1600 may be connected to some customer premise data devices using a wired ethernet medium and to other customer premise data devices using a wireless medium. In addition, the customer premise data devices also might be processes internal to STB with CM 1600. If all the customer premise data devices are internal processes within STB with CM 1600, then STB with CM 1600 might not have any externally connected customer premise communications media for cable modem functionality.

Although FIG. 16 shows non-integrated IP device with NAT 1624 pictorially as a tower/server computer as opposed to a desktop computer that is used to represent the other IP devices, this pictorial difference in the figures between tower/server computers and desktop computers is not meant to have any functional significance and is only used to more quickly identify the device in the figure that is functioning as a NAT device.

In general, set-top box with cable modem 1600 is capable of forwarding many network level protocols between RF cable interface 1416a and communications media for connecting customer premise data devices, such as communications medium 1622. (Under DOCSIS a cable modem or a device with cable modem functionality generally uses layer two bridging as a forwarding construct between the RF cable interface and communications media connected to customer premise data networking equipment.) Therefore, customer premise data devices generally may utilize other protocols instead of or in addition to the Internet Protocol (IP). However, the network address translation (NAT) utilized in some of the preferred embodiments of the present invention generally is used for translating information conforming to the TCP/IP protocol suite. Thus, the customer premise data devices in FIG. 16 are shown as IP devices.

IP devices 1624, 1626, and 1628 in FIG. 16 are customer premise data devices that are capable of using at least one variant of the Internet Protocol (IP). These variants include, but are not limited to, IPv4, IPng, and/or IPv6. At most customer premises, IP devices 1626 and 1628 generally are IP hosts or end systems. However, set-top box with cable modem 1600 also will work if the IP devices are intermediate systems with IP protocol stacks for forwarding IP datagrams and/or user applications such as, but not limited to, network management and configuration. Also, even though IP devices in FIG. 16 are represented pictorially as personal computers, this is only for illustrative purposes and is not meant to introduce any limitations on the type of equipment that may be an IP device. IP devices generally may be any device capable of running a process that uses any variant of the IP protocol such as, but not limited to, personal computers, workstations, and telephones. In addition, IP devices may be special purpose processors for applications such as, but not limited to, utility meter reading and home automation. Although IP device with NAT 1624 could utilize the networking constructs or models of other intermediate systems, usually IP device with NAT 1624 generally functions as an IP router with the additional functionality of network address translation (NAT). Furthermore, if CM 1600 follows the DOCSIS standards, then it is also an IP device with an IP address being assigned by the DOCSIS CMTS for configuration and management. However, the IP address assigned to CM 1600 for configuration and management need not necessarily come from the same subnet as the IP addresses assigned to other customer or subscriber devices such as IP device 1624.

FIG. 16 shows IP device with NAT 1624 as a one-arm NAT device that has an interface to only one communications medium 1622. This one-arm configuration of FIG. 16 is in contrast to the “two-arm” configuration of FIG. 15, where IP device with NAT 1524 has one connection to communications medium 1522 and one connection to communications medium 1532. Generally, most routers have at least two arms. In other words, such “two-arm” or “multiple arm” routers are connected to at least two separate media. These “two-arm” or “multiple-arm” routers generally route data between and among the at least two separate media usually using at most one IP address within each media. In contrast, a one-arm router has two or more network-level, IP addresses within one data-link-level communications medium.

A one-arm router is commonly implemented by assigning multiple IP addresses to a single interface that is connected to one data-link-level communications medium. This type of one-arm router may be supported by the software in the router to allow the assignment of multiple IP addresses to a single data-link-level interface. In addition, for processing systems running routing software that does not support assigning multiple IP addresses to a single data-link-level interface, a one-arm routing configuration might be obtained by connecting two or more data-link-level interfaces of the processing system to the same communications medium. This configuration allows the processing system running the routing software to route packets between the two data-link interfaces that are each assigned with one different IP address and that are both connected to the same communications medium. A NAT device such as IP device with NAT 1624 may be implemented as a one-arm device that might be only connected to a single communications medium 1622 but has multiple IP addresses associated with the at least one connection to a single communications medium 1622.

A non-limiting example of IP address assignment for FIG. 16 might be for IP device with NAT 1624 to have the global, public IP address of 135.100.25.101 as well as the private IP address of 10.0.0.124 both associated with the device's at least one connection to communications medium 1622. Because IP device with NAT 1624 has an internet-valid, public IP address, this device may transparently access the internet without needing network address translation (NAT) functionality. In contrast, suppose IP devices 1626 and 1628 have private IP addresses 10.0.0.126 and 10.0.0.128, respectively. Then to access the internet, IP devices 1626 and 1628 might use IP device with NAT 1624 to provide network address translation (NAT) on all packets communicated between IP devices 1626 and 1628 and the internet. Because in this example IP device with NAT 1624 has only one internet-valid, public IP address of 135.100.25.101, IP device with NAT 1624 generally should use NAPT (Network Address Port Translation) to allow the two IP devices 1626 and 1628 to access the internet simultaneously.

Cable modems that follow the DOCSIS RFI 1.0 and/or RFI 1.1 standards generally implement layer two bridging as the forwarding algorithm. In addition, cable modems following DOCSIS RFI 1.0 and/or RFI 1.1 are supposed to filter out (or not forward) frames that are received by the cable modem on the cable modem to CPE interface (CMCI) and that have source MAC addresses that are not provisioned or learned as supported CPE devices. Such filtering prevents data link frames from devices that are not allowed access to the service provider's network from transversing across the cable modem from the CMCI interface (generally represented by communications medium 1622) to the RFI interface 1416a. In addition, the DOCSIS RFI 1.0 and/or RFI 1.1 standards specify that compliant cable modems are capable of filtering based upon network layer protocol numbers so that a DOCSIS cable modem may be configured to only forward the network layer protocols associated with the TCP/IP suite (such as, but not limited to, IP with a protocol ID of 0800 hexadecimal, ARP with a protocol ID of 0806 hexadecimal, and/or RARP (reverse ARP) with a protocol ID of 8035 hexadecimal).

These cable modem filtering mechanisms and/or forwarding algorithms generally are used to prevent unauthorized access to the service provider's RF cable network by CPE devices with unauthorized MAC addresses and by CPE devices running unauthorized network protocols. However, these filtering/forwarding mechanisms are not perfect. For example, suppose IP device with NAT 1624 has a MAC address that is authorized for access through set-top box with cable modem 1600 onto the service provider's RF network. Further suppose that IP device with NAT 1624 is a one-arm router that has both a globally-valid, public IP address of 135.100.25.101 and a private IP address of 10.0.0.124 that are both associated with the MAC address that is authorized to communicate through set-top box with cable modem 1600 onto the service provider's RF network. In this situation set-top box with cable modem 1600 would not block or filter frames with a source MAC address corresponding to the authorized MAC address of IP device with NAT 1624 but with a source IP address of the private IP value of 10.0.0.124. Thus, a cable modem that is compliant with DOCSIS RFI 1.0 and/or RFI 1.1 would forward IP datagrams into the service provider's network that have invalid private IP addresses. One solution to this problem is for the cable modem to use additional filter criteria to prevent IP datagrams with private IP addresses from transversing the cable modem and entering into the service provider's network. A cable modem utilizing such filters would be a hybrid device with some characteristics of the bridge construct and some characteristics of the routing construct related to making forwarding decisions based upon network layer IP addresses. Thus, the one-arm NAT configuration of FIG. 16 identifies the potential need for more sophisticated filtering capabilities for cable modems or for devices with cable modem functionality than are defined in DOCSIS RFI 1.0 and/or RFI 1.1.

In general, communications medium 1622 might be any form of communications media for connecting customer premise data devices. However, as the functionality of cable modems generally is designed to connect customer or subscriber premises to service providers, communications medium 1622 in FIG. 16 is likely to use a technology such as, but not limited to, a LAN (local area network) designed for communications within a relatively small geographic area. Often a LAN will be contained within a single building such as a customer's residence or a commercial structure.

The form of communications medium 1622 for connecting customer premise data devices includes, but is not limited to, wired or wireless as well as point-to-point or shared with contention determined by a centralized algorithm or by a distributed algorithm. Furthermore, the communications media might possibly use multiplexing techniques such as, but not limited to, time-division multiplexing (TDM) and/or frequency-division multiplexing (FDM) as well as possibly use spread spectrum technologies such as, but not limited to, frequency hopping and/or direct sequence techniques. These direct sequence techniques might include, but are not limited to, code division multiple access (CDMA).

However, despite the fact that communications medium 1622 is generally any communications media for connecting customer premise data devices, the DOCSIS cable modem to customer premise equipment (CMCI) specification covers a standard for interfacing DOCSIS CMCI-compliant cable modems to some types of CPE. This DOCSIS CMCI standard only describes three interfaces for communications media, such as communications medium 1622 in FIG. 16, that are used for connecting a cable modem or a device with cable modem functionality (such as STB with CM 1600) to customer premise equipment (CPE) such as IP device 1626. DOCSIS CMCI describes a LAN interface using ethernet, an external computer bus interface using universal serial bus (USB), and an internal computer bus interface using the peripheral component interconnect (PCI) bus. Thus, to be compliant with the DOCSIS CMCI specification, a cable modem or a device with cable modem functionality should interface to CPE using ethernet (including IEEE 802.3), USB, or PCI.

The general system level cable data network architecture for connecting IP devices to cable modems is covered in DOCSIS. Also, the use of a non-integrated, NAT router with external connections to a cable modem in one communications medium and to other IP devices in another communications medium commonly has been deployed by users. Unlike FIG. 16, the non-integrated, external NAT router commonly deployed in cable data networks by users has connections to two different communications media (i.e., it is a two-arm router) as opposed to the connection of IP device with NAT 1624 to a single communications medium. In addition, the DOCSIS CMCI specifications heretofore have limited the communications medium 1622 for DOCSIS cable modems to only ethernet (as well as IEEE 802.3), USB, and PCI.

Despite these limitations of DOCSIS CMCI, in the embodiments of the present invention, communications medium 1622 may be any form of communications medium for connecting customer premise data devices. If set-top box with cable modem 1600 uses some other communications media than ethernet, USB, or PCI for communications medium 1622, then set-top box with cable modem 1600 will not be compliant with the DOCSIS CMCI standard. However, such a device with cable modem functionality might still comply with the DOCSIS CM RFI (cable modem radio frequency interface) specifications and/or the DOCSIS CM TRI (cable modem telephony return interface) specification. Set-top box with cable modem 1600 could use technologies other than ethernet, USB, and PCI for communications medium 1622 and still comply with these DOCSIS standards by appearing no different than an ethernet attached cable modem, when viewed from its RF cable interface (CM RFI). The details of a CM appearing no different than an ethernet attached DOCSIS cable modem are further covered in the description below generally regarding FIG. 18.

Also, STB with CM 1600 may include processes that utilize DOCSIS to communicate information with processing systems that are not related to providing cable modem connectivity to customer premise data devices. As a non-limiting example, STB with CM 1600 generally may utilize DOCSIS to allow STB with CM 1600 to have IP connectivity as an end-system IP device for the purpose of obtaining advertising messages using IP datagrams and displaying the advertising through interface 1306 on A/V CPE 1304 (e.g., a television). Such use of IP connectivity by STB with CM 1600 is not a normal cable modem function within DOCSIS. Thus, this non-limiting example use of IP connectivity by STB with CM 1600 would be considered to be a customer or user application that is not defined by the DOCSIS standards.

However, for STB with CM 1600 to run such user applications or user processes and to appear no different than an ethernet attached DOCSIS cable modem, STB with CM 1600 generally should have a CPE MAC address and a CPE IP address that are different from a cable modem (CM) MAC address and a cable modem (CM) IP address. A cable modem (CM) MAC address and a cable modem (CM) IP address are used by DOCSIS for tasks such as, but not limited to, configuring and maintaining a cable modem or a device with cable modem functionality (e.g., STB with CM 1600). A CM MAC address and a CM IP address generally are not supposed to be utilized for user applications. More details on CPE MAC addresses, on CPE IP addresses, and on running user processes on STB with CM 1600 are covered in the description of FIG. 18, which describes integrated network address translation (NAT) in an STB with cable modem functionality. Generally, processes for network address translation (NAT) appear to the DOCSIS standards as user processes.

In addition, integrating cable modem functionality within a set-top box may allow additional or different user interfaces from the standard user interfaces for setting up data devices such as cable modems. These new user interfaces may simplify tasks such as, but not limited to, set-up, configuration, and/or diagnostics of the cable modem functionality within a set-top box. Furthermore, these tasks might be capable of being performed through user interfaces normally associated with set-top boxes including, but not limited to, on screen programming using an infrared remote control for input and using an audio/video (A/V) CPE 1304 for output. As a non-limiting example, displaying output on audio/video (A/V) CPE 1304 may provide users or subscribers with much more diagnostic feedback on the status and performance of the cable modem functionality of a set-top box than the simplified feedback status provided by some cable modems currently available in the market. Some of the currently available cable modems only use a limited number of LEDs (light emitting diodes) on the front of the cable modem to provide user feedback. Also, the user interfaces from a set-top box might be used for processes such as, but not limited to, configuring some packet filters that affect the cable modem functionality of a set-top box with an integrated cable modem.

In general, the term “integration” in the computer and networking fields involves combining or blending previously separate activities, programs, processes, functions, and/or hardware components into a functional whole. Within the context of the embodiments of the present invention, the terms integrated and integration generally imply that two items that are integrated together share some resources more than a communications media connecting the items and more than any instances of the algorithms of media access control (MAC) protocols that correspond to the communications media shared by the two items. (Generally communications media are not considered to be communications devices, and thus communications media do not actively retain state information beyond the time it takes to propagate a signal through the media. However, when two communications devices are connected to a communications media, the devices may share some information on the state of the communications media because each device generally may be running processes that are at least one instance of the media access control (MAC) protocol for that communications media.)

For the embodiments of the present invention, two integrated items generally are within the same box or device and/or generally use the same at least one connection to an electrical power outlet. (The power outlet need not necessarily be an alternating current (A.C.) power outlet.) Generally, in addition to sharing at least one power source and/or being in the same box or device, integrated items may share other resources of a device or box such as, but not limited to, processing and/or storage. The shared processing may or may not include the use of at least one microprocessor, and the shared storage may or may not include the use of at least one digital memory. Furthermore, the resources shared by integrated items may include software and/or hardware (such as, but not limited to, circuitry and/or logic). Also, the integration of items into one device or box generally allows the device or box to use at least one common user interface for the integrated items. In effect, the integrated items generally share at least one common user interface for the device or box.

Because communications medium 1622 is not necessarily limited to the DOCSIS CMCI-compliant communications media of ethernet, USB, and PCI, FIG. 16 shows the potential integration of non-DOCSIS communications media into a set-top box with cable modem functionality that generally may be compliant with DOCSIS RFI and/or DOCSIS TRI. Furthermore, because communications medium 1622 for communicating with customer premise data devices is at least one communications medium, FIG. 16 shows the potential integration of interfaces for more than one communications media into a set-top box with cable modem functionality. The more than one communications media (represented in FIG. 16 by communications medium 1622) connected to the set-top box generally are used for communicating with customer premise data devices. Also, a set-top box with cable modem functionality that further has multiple communications media for communicating with customer premise data network devices may or may not be compliant with DOCSIS RFI and/or DOCSIS TRI.

In addition, FIG. 16 shows the integration of cable modem functionality into a set-top box. The cable modem functionality of a set-top box may or may not be DOCSIS cable modem functionality. The integration of items in the embodiments of the present invention allows for capabilities and/or functions that generally were not available in solutions using separate (non-integrated) devices, components, and/or functions.

In general, the integration of additional functionality into a set-top box may or may not require additional processing capacity and/or storage capacity such as, but not limited to, digital memory. Furthermore, sometimes the integration of additional functionality into a set-top box might require additional software and/or hardware such as, but not limited to, circuitry and logic. Generally, integrating more functionality into a set-top box often increases the amount of hardware and/or software needed in the device, which usually raises the production costs of the device. To have a common platform for set-top boxes and to maintain a low price point for entry-level set-top box devices with lesser functionality, the additional hardware and/or software, which may be needed to support the integration of more advanced functionality, might be implemented in optional modules. These optional modules might be modular option cards or expansion cards that may be installed at the factory or possibly in the field (e.g., at the customer premise) by service technicians and/or customers. Furthermore, software upgrades might be downloaded to the set-top box through any communications media connected to the cable modem.

Some examples of interfaces that might be used for connecting expansion modules to a set-top box include, but are not limited to, the interfaces that have historically been used for expansion interfaces. A few particular non-limiting examples of these historical expansion interfaces are: 1) the AT/ISA bus (Advanced Technology/Industry Standard Architecture) of older PCs, 2) the PCMCIA (Personal Computer Memory Card International Association or PC Card) standard generally used for laptops, and 3) the PCI (Peripheral Component Interconnect) bus of newer PCs. In addition to industry standard expansion interfaces, many equipment vendors in the computer and networking fields often have designed their own proprietary expansion interfaces. None of these examples of expansion interfaces are meant to be limiting as there are many existing standard and proprietary expansion interfaces, and many new and modified expansion interfaces likely will be developed in the future.

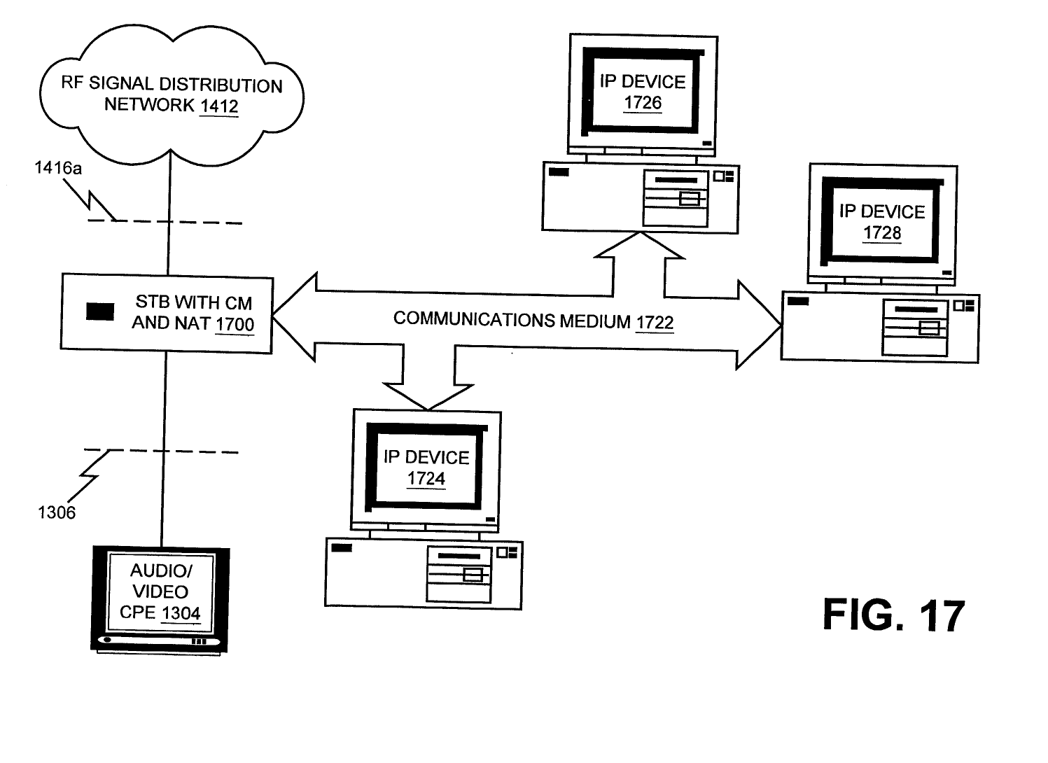

FIG. 17

FIG. 17 shows a set-top box (STB) with cable modem (CM) and NAT 1700 connected to audio/video CPE 1304 over interface 1306. A non-limiting example of audio/video CPE 1304 might be a television set. In addition, a non-limiting example of interface 1306 might include an NTSC formatted signal that is modulated into a coax cable on TV channel 3. Furthermore, STB with CM and NAT 1700 is connected to RF signal distribution network 1412 over RF cable interface 1416a. RF cable interface 1416a will commonly be a single connection that carries both signals for audio/video customer premise equipment and cable data network customer premise equipment. However, the embodiments of the present invention are not limited to situations in which both audio/video programming and data services are delivered over one connection. As a non-limiting example, STB with CM and NAT 1700 may have one RF cable connection for cable audio/video programming and a different RF cable connection for cable data network services. In addition, there might be different RF signal distribution networks 1412 for cable audio/video programming and for cable data network services. Probably the most common non-limiting example of RF cable interface 1416a includes a single coax cable, while the most common non-limiting example of RF signal distribution network 1412 is a hybrid fiber-coax (HFC) system.

Furthermore, FIG. 17 shows a non-limiting example of how integrated NAT functionality might be included in a cable modem to provide internet access to more IP devices than have been assigned internet-valid, public IP addresses. In FIG. 17 STB with cable modem (CM) and NAT 1700 is connected to RF signal distribution network 1412, which conforms to interface 1416a. In addition, STB with CM and NAT 1700 is connected to communications medium 1722, which is further connected to IP devices 1724, 1726, and 1728. Although FIG. 17 shows STB with CM and NAT 1700 connected to only communications medium 1722 for communicating with customer premise data devices such as IP devices 1724, 1726, and 1728, in general STB with CM and NAT 1700 may be connected to at least one medium at the customer premise that is further connected to customer premise data devices. Thus, STB with CM and NAT 1700 may be connected to 10, more than one communications media at the customer premise for communicating with customer premise data devices. Furthermore, if STB with CM and NAT 1700 is connected to more than one medium for communicating with customer premise data devices, then the multiple media may or may not be the same type of communications media. As a non-limiting example, STB with CM and NAT 1700 may be connected to some customer premise data devices using a wired ethernet medium and to other customer premise data devices using a wireless medium. In addition, the customer premise data devices also might be processes internal to STB with CM and NAT 1700. If all the customer premise data devices are internal processes within STB with CM and NAT 1700, then STB with CM and NAT 1700 might not have any externally connected customer premise communications media for cable modem functionality.

In general, STB with cable modem (CM) and NAT 1700 is capable of forwarding many network level protocols between RF cable interface 1416a and communications media for connecting customer premise data devices, such as communications medium 1722. (Under DOCSIS a cable modem or a device with cable modem functionality generally uses layer two bridging as a forwarding construct between the RF cable interface and communications media connected to customer premise data networking equipment.) Therefore, customer premise data devices generally may utilize other protocols instead of or in addition to the Internet Protocol (IP). However, the network address translation (NAT) utilized in some of the preferred embodiments of the present invention generally is used for translating information conforming to the TCP/IP protocol suite. Thus, the customer premise data devices in FIG. 17 are shown as IP devices.

IP devices 1724, 1726, and 1728 in FIG. 17 are customer premise data devices that are capable of using at least one variant of the Internet Protocol (IP). These variants include, but are not limited to, IPv4, IPng, and/or IPv6. At most customer premises, IP devices 1724, 1726, and 1728 generally are IP hosts or end systems. However, set-top box with cable modem 1700 also will work if the IP devices are intermediate systems with IP protocol stacks for forwarding IP datagrams and/or user applications such as, but not limited to, network management and configuration. Also, even though IP devices in FIG. 17 are represented pictorially as personal computers, this is only for illustrative purposes and is not meant to introduce any limitations on the type of equipment that may be an IP device. IP devices generally may be any device capable of running a process that uses any variant of the IP protocol such as, but not limited to, personal computers, workstations, and telephones. In addition, IP devices may be special purpose processors for applications such as, but not limited to, utility meter reading and home automation. Furthermore, if CM with NAT 1700 follows the DOCSIS standards, then it is also an IP device with an IP address being assigned by the DOCSIS CMTS for configuration and management. However, the IP address assigned to CM with NAT 1700 for configuration and management need not necessarily come from the same subnet as at least one IP address used for network address translation (NAT) processes within STB with CM and NAT 1700.

A non-limiting example of IP address assignment for FIG. 17 might be for STB with CM and NAT 1700 to have the global, public IP address of 135.100.25.101 as an IP address used for the NAT processes within STB with CM and NAT 1700. For a device that has DOCSIS cable modem functionality and that also performs NAT, the IP address used for NAT processes generally would be in addition to the IP address assigned by the cable network for initializing and managing the cable modem processes. For STB with CM and NAT 1700 to transparently appear to be no different than an ethernet attached cable modem, when viewed from its RF cable interface (CM RFI), the IP address or IP addresses used for NAT processes within STB with CM and NAT 1700 should appear to be the IP address of customer premise IP devices and not the IP address used for initializing and managing DOCSIS cable modem functionality within STB with CM and NAT 1700.

Furthermore, service providers may not necessarily use IP addresses from the same subnets for both the IP address used for initializing and managing a cable modem and the IP address or IP addresses used for customer premise devices. Service providers may specifically choose different IP subnets for the IP address used for initializing and managing a cable modem so as to make it impossible for subscribers or customers to access the cable modem to adjust features such as network security and/or statistics. A device such as STB with CM and NAT 1700 might need to take into account the differing security and control needs of service providers and subscribers in accessing and configuring the settings of cable modem processes as opposed to customer premise processes such as network address translation (NAT) when both cable modem processes and customer premise processes are within the same device such as STB with CM and NAT 1100.

In addition to STB with CM and NAT 1700 having a globally-valid, public IP address of 135.100.25.101 for customer premise processes such as NAT, IP device 1724 may have a globally-valid, public IP address of 135.100.25.102 for its interface in communications medium 1722. Thus, IP device 1724 could access the internet through STB with CM and NAT 1700 without needing network address translation (NAT) of the IP datagrams sent and received by IP device 1724. Thus, a STB with CM and NAT 1700 may provide network address translation for some customer premise IP devices and may not provide network address translation for other customer premise IP devices.

In contrast, suppose IP device 1726 has private IP address 10.0.0.126 and IP device 1728 has private IP address 10.0.0.128. Then to access the internet, IP devices 1726 and 1728 might use STB with CM and NAT 1700 to provide network address translation on all packets communicated between the internet and IP devices 1726 and 1728. Because in this example STB with CM and NAT 1700 has only one internet-valid, public IP address of 135.100.25.101, STB with CM and NAT 1700 generally should use NAPT (Network Address Port Translation) to allow the two IP devices 1726 and 1728 to access the internet simultaneously.

In general, communications medium 1722 might be any form of communications media for connecting customer premise data devices. However, as the functionality of cable modems generally is designed to connect customer or subscriber premises to service providers, communications medium 1722 in FIG. 17 is likely to use a technology such as, but not limited to, a LAN (local area network) designed for communications within a relatively small geographic area. Often a LAN will be contained within a single building such as a customer's residence or a commercial structure.

The form of communications medium 1722 for connecting customer premise data devices includes, but is not limited to, wired or wireless as well as point-to-point or shared with contention determined by a centralized algorithm or by a distributed algorithm. Furthermore, the communications media might possibly use multiplexing techniques such as, but not limited to, time-division multiplexing (TDM) and/or frequency-division multiplexing (FDM) as well as possibly use spread spectrum technologies such as, but not limited to, frequency hopping and/or direct sequence techniques. These direct sequence techniques might include, but are not limited to, code division multiple access (CDMA).

However, despite the fact that communications medium 1722 is generally any communications media, the DOCSIS cable modem to customer premise equipment (CMCI) specification covers a standard for interfacing DOCSIS CMCI-compliant cable modems to some types of CPE. This DOCSIS CMCI standard only describes three interfaces for connecting DOCSIS CMCI compliant cable modems to customer premise equipment (CPE) such as IP device 1724. DOCSIS CMCI describes a LAN interface using ethernet, an external computer bus interface using universal serial bus (USB), and an internal computer bus interface using the peripheral component interconnect (PCI) bus. Thus, to be compliant with the DOCSIS CMCI specification, a cable modem or a device with cable modem functionality should interface to CPE using ethernet, USB, or PCI. In general, to be compliant with the layer two bridging paradigm for forwarding defined in DOCSIS RFI 1.0 and/or RFI 1.1, the NAT functionality of STB with CM and NAT 1700 generally should operate as a layer two bridge.

Although set-top box with cable modem 1700 might use some other communications media than ethernet, USB, or PCI for communications medium 1722, then set-top box with cable modem 1700 would not be compliant with the DOCSIS CMCI standard. However, such a device with cable modem functionality could still comply with the DOCSIS CM RFI (cable modem radio frequency interface) specifications and/or the DOCSIS CM TRI (cable modem telephony return interface) specification. Set-top box with cable modem 1700 could use technologies other than ethernet, USB, and PCI for communications medium 1722 and still comply with these DOCSIS standards by appearing no different than an ethernet attached cable modem, when viewed from its RF cable interface (CM RFI). In addition, although DOCSIS RFI 1.0 and/or 1.1 generally describe a layer two, bridge forwarding algorithm for cable modems or devices with cable modem functionality, a set-top box with cable modem and NAT may implement bridging, routing, and/or hybrid combinations and subsets of bridging and/or routing, still maintaining transparent behavior to the RF cable interface. This transparency to the RF cable interface is accomplished by appearing no different than an ethernet attached cable modem, when viewed from its RF cable interface (CM RFI). To a service provider, such a cable modem would appear no different than a DOCSIS-compliant cable modem.

Thus, communications medium 1722 may or may not be a DOCSIS CMCI compliant communications media such as ethernet, USB, or PCI. Furthermore, STB with CM and NAT 1700 may or may not be compliant with the DOCSIS forwarding algorithm that generally specifies layer two bridging between the DOCSIS cable modem to CPE interface (CMCI) and the DOCSIS RF cable interface (RFI). Still with the proper functionality, STB with CM and NAT 1700 may appear to service provider's equipment no different than an ethernet attached cable modem generally using layer two, bridging, when viewed from its RF cable interface (CM RFI).

Also, STB with CM and NAT 1700 may include processes that utilize DOCSIS to communicate information with processing systems that are not related to providing cable modem connectivity to customer premise data devices. As a non-limiting example, STB with CM and NAT 1700 generally may utilize DOCSIS to allow STB with CM and NAT 1700 to have IP connectivity as an end-system IP device for the purpose of obtaining advertising messages using IP datagrams and displaying the advertising through interface 1306 on A/V CPE 1304 (e.g., a television). Such use of IP connectivity by STB with CM and NAT 1700 is not a normal cable modem function within DOCSIS. Thus, this non-limiting example use of IP connectivity by STB with CM and NAT 1700 would be considered to be a customer or user application that is not defined by the DOCSIS standards.

However, for STB with CM and NAT 1700 to run such user applications or user processes and to appear no different than an ethernet attached DOCSIS cable modem, STB with CM and NAT 1700 generally should have a CPE MAC address and a CPE IP address that are different from a cable modem (CM) MAC address and a cable modem (CM) IP address. A cable modem (CM) MAC address and a cable modem (CM) IP address are used by DOCSIS for tasks such as, but not limited to, configuring and maintaining a cable modem or a device with cable modem functionality (e.g., STB with CM and NAT 1700). A CM MAC address and a CM IP address generally are not supposed to be utilized for user applications. More details on CPE MAC addresses, on CPE IP addresses, and on running user processes on STB with CM and NAT 1700 are covered in the description of FIG. 18, which describes integrated network address translation (NAT) in an STB with cable modem functionality. Generally, processes for network address translation (NAT) appear to the DOCSIS standards as user processes.

In addition, integrating cable modem functionality within a set-top box may allow additional or different user interfaces from the standard user interfaces for setting up data devices such as cable modems. These new user interfaces may simplify tasks such as, but not limited to, set-up, configuration, and/or diagnostics of the cable modem functionality within a set-top box. Furthermore, these tasks might be capable of being performed through user interfaces normally associated with set-top boxes including, but not limited to, on screen programming using an infrared remote control for input and using an audio/video (A/V) CPE 1304 for output. As a non-limiting example, displaying output on audio/video (A/V) CPE 1304 may provide users or subscribers with much more diagnostic feedback on the status and performance of the cable modem functionality of a set-top box than the simplified feedback statuls provided by some cable modems currently available in the market. Some of the currently available cable modems only use a limited number of LEDs (light emitting diodes) on the front of the cable modem to provide user feedback. Also, the user interfaces from a set-top box might be used for processes such as, but not limited to, configuring some packet filters that affect the cable modem functionality of a set-top box with an integrated cable modem. Moreover, the user interfaces from a set-top box might be used for tasks such as, but not limited to, configuring various user processes on a set-top box with cable modem. In general, these various user processes may include functions such as, but not limited to, network address translation (NAT), firewall, proxy, and DHCP server.

In general, the term “integration” in the computer and networking fields involves combining or blending previously separate activities, programs, processes, functions, and/or hardware components into a functional whole. Within the context of the embodiments of the present invention, the terms integrated and integration generally imply that two items that are integrated together share some resources more than a communications media connecting the items and more than any instances of the algorithms of media access control (MAC) protocols that correspond to the communications media shared by the two items. (Generally communications media are not considered to be communications devices, and thus communications media do not actively retain state information beyond the time it takes to propagate a signal through the media. However, when two communications devices are connected to a communications media, the devices may share some information on the state of the communications media because each device generally may be running processes that are at least one instance of the media access control (MAC) protocol for that communications media.)

For the embodiments of the present invention, two integrated items generally are within the same box or device and/or generally use the same at least one connection to an electrical power outlet. (The power outlet need not necessarily be an alternating current (A.C.) power outlet.) Generally, in addition to sharing at least one power source and/or being in the same box or device, integrated items may share other resources of a device or box such as, but not limited to, processing and/or storage. The shared processing may or may not include the use of at least one microprocessor, and the shared storage may or may not include the use of at least one digital memory. Furthermore, the resources shared by integrated items may include software and/or hardware (such as, but not limited to, circuitry and/or logic). Also, the integration of items into one device or box generally allows the device or box to use at least one common user interface for the integrated items. In effect, the integrated items generally share at least one common user interface for the device or box.

Because communications medium 1722 is not necessarily limited to the DOCSIS CMCI-compliant communications media of ethernet, USB, and PCI, FIG. 17 shows the potential integration of non-DOCSIS communications media into a set-top box with cable modem functionality that generally may be compliant with DOCSIS RFI and/or DOCSIS TRI. Furthermore, because communications medium 1722 for communicating with customer premise data devices is at least one communications medium, FIG. 17 shows the potential integration of interfaces for more than one communications media into a set-top box with cable modem functionality. The more than one communications media (represented in FIG. 17 by communications medium 1722) connected to the set-top box generally are used for communicating with customer premise data devices. Also, a set-top box with cable modem functionality that further has multiple communications media for communicating with customer premise data network devices may or may not be compliant with DOCSIS RFI and/or DOCSIS TRI.

In addition, FIG. 17 shows the integration of cable modem functionality into a set-top box. The cable modem functionality of a set-top box may or may not be DOCSIS cable modem functionality. Furthermore, FIG. 17 shows the integration of user processes such as, but not limited to, network address translation into the STB with CM and NAT 1700. Other user processes that may or may not be integrated into a cable modem include tasks such as, but not limited to, firewall, proxy, tunneling, VPN (Virtual Private Networking), and/or DHCP. In addition, combinations, variations, and/or subsets of the possible user processes also may be integrated into STB with CM and NAT 1700. The integration of items in the embodiments of the present invention allows for capabilities and/or functions that generally were not available in solutions using separate (non-integrated) devices, components, and/or functions.

In general, the integration of additional functionality into a set-top box may or may not require additional processing capacity and/or storage capacity such as, but not limited to, digital memory. Furthermore, sometimes the integration of additional functionality into a set-top box might require additional software and/or hardware such as, but not limited to, circuitry and logic. Generally, integrating more functionality into a set-top box often increases the amount of hardware and/or software needed in the device, which usually raises the production costs of the device. To have a common platform for set-top boxes and to maintain a low price point for entry-level set-top box devices with lesser functionality, the additional hardware and/or software, which may be needed to support the integration of more advanced functionality, might be implemented in optional modules. These optional modules might be modular option cards or expansion cards that may be installed at the factory or possibly in the field (e.g., at the customer premise) by service technicians and/or customers. Furthermore, software upgrades might be downloaded to the set-top box through any communications media connected to the cable modem.

Some examples of interfaces that might be used for connecting expansion modules to a set-top box include, but are not limited to, the interfaces that have historically been used for expansion interfaces. A few particular non-limiting examples of these historical expansion interfaces are: 1) the AT/ISA bus (Advanced Technology/Industry Standard Architecture) of older PCs, 2) the PCMCIA (Personal Computer Memory Card International Association or PC Card) standard generally used for laptops, and 3) the PCI (Peripheral Component Interconnect) bus of newer PCs. In addition to industry standard expansion interfaces, many equipment vendors in the computer and networking fields often have designed their own proprietary expansion interfaces. None of these examples of expansion interfaces are meant to be limiting as there are many existing standard and proprietary expansion interfaces, and many new and modified expansion interfaces likely will be developed in the future.

FIG. 18

FIG. 18 shows a more detailed diagram of set-top box (STB) with cable modem (CM) and NAT 1700. STB with CM and NAT 1700 is connected to RF signal distribution network 1412, which conforms to interface 1416a. The processes and entities shown in FIG. 18 are only for illustration purposes and are not meant to limit the software and/or hardware architecture of STB with CM and NAT 1700. Commonly, a STB with CM and NAT 1700 will have some processes that generally handle cable modem functionality (shown in the figure as CM processes 1804), some processes that generally handle NAT functionality (shown in the figure as NAT processes 1806), and some processes that generally handle set-top box functionality (shown in the figure as STB processes 1808). Within STB with CM and NAT 1700, the CM processes 1804, the NAT processes 1806, and the STB processes 1808 generally are capable of communicating with each as shown by the connections that connect each pair of processes. These connections between pairs of processes within STB with CM and NAT 1700 are only for illustrative purposes. The connections between processes in FIG. 18 are not meant to limit the manner in which the processes may or may not communicate and are not meant to limit the manner in which the processes may or may not be interconnected. Furthermore, FIG. 18 shows interface 1812 defining the interface of the connection between CM processes 1804 and NAT processes 1806.

Generally, when multiple processes are integrated into a single device the processes may communicate with each other. Some non-limiting examples of ways that processes within STB with CM and NAT 1700 may communicate with each other include, but are not limited to, communication over a bus interface and/or communication through access to shared memory. However, nothing in the embodiments of the present invention is meant to limit the methods, mechanisms, and/or interfaces that are used for communication between and among processes within STB with CM and NAT 1700.

In addition, FIG. 18 shows CM processes 1804 connected to RF signal distribution network 1412 over RF cable interface 1416a. This connection in FIG. 18 is only used to illustrate that the cable modem (CM) processes 1804 generally should be able to communicate using RF signal distribution network 1412 over RF cable interface 1416a. The connection of CM processes 1804 to RF signal distribution network 1412 over RF cable interface 1416a is not meant to limit CM processes 1804 to only being directly connected to RF cable interface 1416a. In general, other processes in STB with CM and NAT 1700 may provide hardware and/or software that facilitates the ability of CM processes 1804 to send information via RF signal distribution network 1412 and/or to receive information via RF signal distribution network 1412 over RF cable interface 1416a.

Furthermore, FIG. 18 shows STB processes 1808 connected to RF signal distribution network 1412 over RF cable interface 1416a. This connection in FIG. 18 is only used to illustrate that the set-top box (STB) processes 1808 generally should be able to communicate using RF signal distribution network 1412 over RF cable interface 1416a. The connection of STB processes 1808 to RF signal distribution network 1412 over RF cable interface 1416a is not meant to limit STB processes 1808 to only being directly connected to RF cable interface 1416a. In general, other processes in STB with CM and NAT 1700 may provide hardware and/or software that facilitates the ability of STB processes 1808 to utilize information communicated via RF signal distribution network 1412 over RF cable interface 1416a.

Also, STB processes 1808 generally utilize programming signals communicated via RF signal distribution network 1412 over RF cable interface 1416a to communicate programming with devices such as audio/video (A/V) CPE 1304, which is connected to STB with CM and NAT 1700 over interface 1306. Again, FIG. 18 shows STB processes 1808 connected to A/V CPE 1304 through interface 1306. This connection in FIG. 18 is only used to illustrate that the set-top box (STB) processes 1808 generally should be able to communicate information to A/V CPE 1304. The connection of STB processes 1808 to A/V CPE 1304 over interface 1306 is not meant to limit STB processes 1808 to only being directly connected to interface 1306. In general, other processes in STB with CM and NAT 1700 may provide hardware and/or software that facilitates the ability of STB processes 1808 to communicate programming with A/V CPE 1304. Generally, the STB processes 1808 will communicate CATV programming to A/V CPE 1304, which commonly is a device such as, but not limited to, a television.

Although FIG. 18 shows both CM processes 1804 and STB processes 1808 connected to the same RF signal distribution network 1412 over the same RF cable interface 1416a, this is only a common, but non-limiting, example of how a single cable from an RF signal distribution network 1412 might be used to provide communications for information utilized by both CM processes 1804 and STB processes 1808. However, generally the network for communicating signals with CM processes 1804 for cable data connectivity may or may not be the same as the network for communicating signals with STB processes 1808 for A/V programming connectivity (such as, but not limited to, CATV).

In general, set-top box with CM and NAT 1700 is capable of forwarding many network level protocols. (Under DOCSIS a cable modem generally uses layer two bridging as a forwarding construct between the RF cable interface and communications media connected to customer premise data networking equipment.) Therefore, customer premise data devices generally may utilize any protocol including other protocols instead of or in addition to the Internet Protocol (IP). However, the network address translation (NAT) utilized in some of the preferred embodiments of the present invention generally is used for translating information conforming to the TCP/IP protocol suite. Thus, the customer premises data networking devices in FIG. 18 are shown as IP devices.

IP devices in FIG. 18 (such as IP devices 1824 and 1834) are customer premise data devices that are capable of using at least one variant of the Internet Protocol (IP). These variants include, but are not limited to, IPv4, IPng, and/or IPv6. At most customer premises, IP devices 1824 and 1834 generally are IP hosts or end systems. However, set-top box with cable modem and NAT 1700 also will work if the IP devices are intermediate systems with IP protocol stacks for forwarding IP datagrams and/or user applications such as, but not limited to, network management and configuration. Also, even though IP devices in FIG. 18 are represented pictorially as personal computers, this is only for illustrative purposes and is not meant to introduce any limitations on the type of equipment that may be an IP device. IP devices generally may be any device capable of running a process that uses any variant of the IP protocol such as, but not limited to, personal computers, workstations, and telephones. In addition, IP devices may be special purpose processors for applications such as, but not limited to, utility meter reading and home automation. Furthermore, if STB with CM and NAT 1700 follows the DOCSIS standards, then it is also an IP device with an IP address being assigned by the DOCSIS CMTS for configuration and management. However, the IP address assigned to STB with CM and NAT 1700 for configuration and management need not necessarily come from the same subnet as at least one IP address used for network address translation (NAT) processes within STB with CM and NAT 1700.

In addition, FIG. 18 shows STB with CM and NAT 1700 with two external interfaces to customer premise equipment for networking. In general, a device with cable modem functionality could be connected to more than one communications media in the customer premise for communicating information to and/or from customer premise data devices. FIG. 18 shows STB with CM and NAT 1700 connected over interface 1822 to IP device 1824. The connection defined by interface 1822 may connect directly to the CM processes 1804 and not go through the NAT processes 1806 so that the packets communicated between IP device 1824 and other internet devices connected over RF cable interface 1416a are not altered by network address translation in STB with CM and NAT 1700. This type of configuration of bypassing the network address translation (NAT) functions may be useful for some IP devices that run applications that communicate using packets that cannot be transparently translated by NAT processes 1806. In contrast, interface 1832 connects IP device 1834 to set-top box (STB) with cable modem (CM) and NAT 1700. As shown in FIG. 18, the information communicated to and/or from IP device 1834 may be altered using network address translation (NAT) processes 1806. However, STB with CM and NAT 1700 may have the ability to provide network address translation for a first set of IP devices while not providing network address translation for a second set of IP devices even though both the first set and second set of IP devices are connected to the same communications medium.

If STB with CM and NAT 1700 is a DOCSIS cable modem, then the DOCSIS standards do not describe how to integrate cable modem functionality with other user processes in the same device. The DOCSIS CMCI specification only describes connecting cable modems to external ethernet and USB interfaces and connecting cable modems to internal PCI interfaces. Integrating other processes into a device with cable modem functionality or developing additional capabilities such as NAT, while retaining compatibility with the interfaces defined by service providers, generally requires that the new, additional processes and/or capabilities generate and/or receive data that conforms to the interfaces of service providers. In this way the new, additional processes and/or capabilities appear transparent to the service provider's equipment. For DOCSIS cable modems or devices with DOCSIS cable modem functionality, at least three issues generally should be handled to ensure data packets communicated over the RF cable interface from STB with CM and NAT 1700 conform to the expectations of service provider equipment. These three issues generally involve MAC addresses, IP addresses, and the packet size of the frames communicated on the RF medium.

Furthermore, if STB with CM and NAT 1700 has DOCSIS cable modem functionality, then the device has a cable modem (CM) MAC address 1844. In addition, DOCSIS cable modems generally are not supposed to use the CM MAC address 1844 for customer devices (or CPE) that communicate information generally considered by DOCSIS to be user data. The data output from NAT processes 1806 for communication over RF cable interface 1416a generally appears to service provider equipment as if the data is customer or user data. Thus, the data from the NAT processes 1806 generally will have to appear to be sent from at least one customer premise equipment (CPE) MAC address 1846 when the data is communicated across RF cable interface 1416a.

Furthermore, if STB processes 1808 utilize the cable data network connectivity provided by the cable modem functionality of STB with CM and NAT 1700, then STB processes generally should use a CPE MAC address that is different from CM MAC address 1844 for data that is communicated across RF cable interface 1416a. The CPE MAC address utilized for cable data network connectivity by STB processes 1808 may be the same at least one CPE MAC address 1846 that is utilized for data connectivity by NAT processes 1806. Alternatively, STB processes 1808 may use a different at least one CPE MAC address than the at least one CPE MAC address 1846 utilized by NAT processes 1806 for communicating data over RF cable interface 1416a.

Also, devices with DOCSIS cable modem functionality use a Dynamic Host Configuration Protocol (DHCP) client process to dynamically obtain one cable modem (CM) IP address 1854 during initialization. In addition, devices with DOCSIS cable modem functionality that have a telephony return interface (TRI) may have another cable modem (CM) IP address that is obtained from Point-to-Point Protocol (PPP) Internet Control Protocol (IPCP) negotiation. In general, devices that support DOCSIS TRI are designed to communicate over the public-switched telephone network (PSTN) or a telco link using PPP IPCP for upstream communications. However, those skilled in the art will recognize that, in addition to supporting telco PSTN links, the general nature of PPP allows cable modems with DOCSIS TRI capabilities to support other upstream communications technologies, which may carry PPP frames.

The CM IP address obtained through PPP IPCP negotiation need not necessarily be the same value as the CM IP address obtained through DHCP. The DOCSIS TRI specification defines when a device with cable modem functionality should use which CM IP address of the two CM IP addresses obtained from DHCP and IPCP. In general, according to the DOCSIS TRI specification, devices with cable modem functionality and telco return interfaces should use the CM IP address obtained by IPCP for communications over the PPP link and should use the CM IP address obtained using DHCP for communications over the RF cable interface. To simplify the explanation only one CM IP address 1854 is shown in FIG. 18. However, it should be understood that when a device with cable modem functionality has two CM IP addresses, CM IP address 1854 represents the appropriate CM IP address to be used for either RF cable communications or for telco PPP link communications.

The CM IP address 1854 may be used for managing and configuring the cable modem functionality of STB with CM and NAT 1700. However, devices with DOCSIS cable modem functionality generally are not supposed to use the CM IP address 1854 for customer devices (or CPE) that communicate information generally considered by DOCSIS to be user data. The data output from NAT processes 1806 for communication over RF cable interface 1416a generally appears to service provider equipment as if the data is customer or user data. Thus, the data from the NAT processes 1806 generally will have to appear to be sent from at least one customer premise equipment (CPE) IP address 1856 when the data is communicated across RF cable interface 1416a. In fact, CM IP address 1854 and CPE IP address 1856 need not even be from the same IP subnetwork.

Furthermore, if STB processes 1808 utilize the cable data network connectivity provided by the cable modem functionality of STB with CM and NAT 1700, then STB processes generally should use a CPE IP address that is different from CM IP address 1854 for data that is communicated across RF cable interface 1416a. The CPE IP address utilized for cable data network connectivity by STB processes 1808 may be the same at least one CPE IP address 1856 that is utilized for data connectivity by NAT processes 1806. Alternatively, STB processes 1808 may use a different at least one CPE IP address than the at least one CPE IP address 1856 utilized by NAT processes 1806 for communicating data over RF cable interface 1416a.

Although DOCSIS defines a DHCP process for assigning a CM IP address 1854 to a cable modem or a device with cable modem functionality such as STB with CM and NAT 1700, DOCSIS does not define the method for assigning at least one CPE IP address 1856. Thus, at least one customer premise equipment (CPE) IP address 1856 may be dynamically assigned to or statically configured for STB with CM and NAT 1700. However, many service providers use DHCP for assigning IP addresses to customer devices connected through a cable modem. Thus, at least one CPE IP address 1856 is likely to be assigned through DHCP.

Thus, STB with CM and NAT 1700 may use at least one DHCP client process to dynamically obtain at least one CPE IP address. The standard RFC 1541 and 2131 DHCP client process may be used to dynamically obtain a single IP address. This standard DHCP client process may be used repetitively by STB with CM and NAT 1700 to obtain multiple CPE IP addresses. Alternatively, U.S. Pat. No. 6,178,455, entitled “Router which dynamically requests a set of logical network addresses and assigns addresses in the set to hosts connected to the router”, describes an extended variation of DHCP that allows a simplified assignment of multiple IP addresses.

Finally, DOCSIS RFI 1.0 defines a MAC frame on the RF cable interface 1416a that contains a packet data PDU that generally is capable of carrying1500 octets (or bytes) of user data. Also, DOCSIS RFI 1.0 defines an ATM MAC frame capable of carrying an integer multiple of fifty-three octet ATM cells. In general, if the user data to be forwarded from the cable modem over the RF cable interface 1416a into the service provider's network is less than or equal 1500 octets, then the user data can be placed inside a DOCSIS RFI 1.0 packet data PDU. The DOCSIS CMCI standards limit the types of media to which DOCSIS cable modems may connect. These DOCSIS CMCI media are ethernet, USB, and PCI. In general, the MAC frames generated by customer equipment with interfaces defined in DOCSIS CMCI are ethernet or ethernet-like frames that have user data fields of 1500 octets or less. Thus, the DOCSIS standards ensure that the user data in MAC frames from customer premise equipment will fit in the packet data PDU of MAC frames forwarded over RF cable interface 1416a by a DOCSIS cable modem.

In general, the preferred embodiments of the present invention may work with various types of communications media within or at the customer premise. Because some of the communications media may have MAC frames with user data fields larger or smaller than the 1500 octet user data size of DOCSIS RFI 1.0 packet data PDUs, STB with CM and NAT 1700 may have to handle fragmentation of the user data from MAC frames. The user data would be received in MAC frames on one interface and would be fragmented to fit into MAC frames on another interface. Because IP routers generally handle the fragmentation of IP datagrams, implementation of NAT processes 1806 using IP router constructs is one non-limiting way of providing the necessary fragmentation to deal with different frames sizes of various communications media.

Like the DOCSIS RFI 1.0 standard, the DOCSIS RFI 1.1 standard also supports MAC frames with packet data PDUs that have up to 1500 octets of user data. In addition, DOCSIS RFI 1.1 includes a specification for fragmentation at the MAC level. Using this specification, STB with CM and NAT 1700 might be able to connect to various media at the customer premises that have maximum frame sizes with more than 1500 octets of user data by utilizing different packet fragmentation processes than those used in the fragmentation of an IP datagram by an IP router.

In addition to the three issues described above regarding integrating cable modem 155 processes 1804 with customer premise or user processes (such as, but not limited to, NAT processes 1806 and/or STB processes 1808) within a single device such as STB with CM and NAT 1700, the use of CPE MAC address 1846 should be discussed in more detail. CPE MAC address 1846 is used as a MAC address on RF cable interface 1416a for data communicated from some user processes such as, but not limited to, NAT processes 1806 and/or STB processes 1808.

If the communications medium at interface 1832 also uses MAC addresses, then STB with CM and NAT 1700 also will have a MAC address in the communications medium at interface 1832. It is possible that the communications media at interface 1832 does not have MAC addresses. A non-limiting example of a communications medium that does not need MAC addresses is if interface 1832 defines a point-to-point communications medium that is using the IP Control Protocol (IPCP) of the Point-to-Point Protocol (PPP) to only pass IP datagrams over the communications medium at interface 1832. (RFC 1331, entitled “The Point-to-Point Protocol (PPP) for the Transmission of Multi-protocol Datagrams over Point-to-Point Links”, describes how PPP addresses fields may be compressed or omitted in PPP frames. Also, the IP datagrams inside IPCP packets within PPP frames do not contain MAC addresses.)

Generally, if the communications media at interface 1832 and at RF cable interface 1416a are isolated from each other, then STB with CM and NAT 1700 only has to use a MAC address on each interface that is different from the MAC addresses of other networking devices connected to that interface. For the stub networks used to provide cable data service to most customer premises, the communication media at interface 1832 commonly is isolated from the communications media at RF cable interface 1416a. If the communications media at interface 1832 and at RF cable interface 1416a are isolated from each other, then the value used for CPE MAC address 1846 may be the same as the value used for the MAC address of STB with CM and NAT 1700 in the communications medium at interface 1832. In this situation STB with CM and NAT 1700 may use the same standard IEEE forty-eight-bit or six-octet address on each interface. Also, when the communications media at interface 1832 and RF cable interface 1416a are isolated from each other, STB with CM and NAT 1700 could have different values for the MAC addresses used in the communications medium at interface 1832 and for the MAC address used in the communications medium at RF cable interface 1416a (i.e., CPE MAC address 1846). However, the use of a different MAC address on each interface of STB with CM and NAT 1700 may use up more unique IEEE 48-bit MAC addresses than necessary.

As discussed previously, although NAT functionality is commonly implemented using routing constructs, it may be possible to implement NAT using bridging constructs and/or combinations and hybrids of routing and bridging constructs. Depending on the construct or model that is chosen, NAT processes 1806 may or may not change the MAC addresses of packets as they are communicated across interface 1832 in the customer premise and across RF cable interface 1416a. Thus, the selection of bridging, routing, and/or hybrid models or constructs for the NAT processes 1806 may affect the actual MAC addresses used by STB with CM and NAT 1700 when forwarding packets over the RF cable interface 1416a and interface 1832.

Furthermore, some cable data systems limit access to the network based on the MAC address of customer premise equipment. Usually, some equipment managed by the service provider maintains this information on allowed MAC addresses for customer premise equipment. As STB with CM and NAT 1700 includes not only cable modem processes 1804, but also customer premise processes such as NAT processes 1806, the lists of allowed MAC addresses likely will have to include CPE MAC address 1846, which is used by STB with CM and NAT 1700 when communicating subscriber or user data over RF cable interface 1416a. Often MAC addresses such as CPE MAC address 1846 are hard-coded into the firmware of devices. When new customer devices are connected to cable modems, a customer may have to contact the service provider to modify the list of MAC addresses that are allowed access to the service provider's network through the cable modem.

Because STB with CM and NAT 1700 may be replacing existing cable modems as customers upgrade their network to use NAT functionality, service providers may already have a list of allowed MAC addresses that includes a customer's current IP device. Often the customer's current IP device will be placed behind a newly installed STB with CM and NAT 1700 that may replace the existing cable modem that does not have NAT. To allow the STB with CM and NAT 1700 to operate without having the service provider modify the list of allowed MAC addresses, it may be desirable to allow CPE MAC address 1846 to be configurable. In this way a customer could install STB with CM and NAT 1700 without having to coordinate network changes with the service provider.

This effect may be accomplished by simply using the same value for the CPE MAC address 1846 as the value of the MAC address that was used by the customer's current IP device for pre-existing cable data access and is the MAC address value that is kept by the service provider in its access list. This CPE MAC address 1846 then is utilized by STB with CM and NAT 1700 for communicating over RF cable interface 1416a. If STB with CM and NAT 1700 uses the MAC address of IP device 1834 (i.e., the MAC address of the customer's current IP device) as CPE MAC address 1846 for communication over RF cable interface 1416a, then STB with CM and NAT 1700 cannot use this same MAC address value for the communications medium with interface 1832. In order to have MAC addresses that allow devices connected to the communication medium with interface 1832 to be individually addressed and/or selected, STB with CM and NAT 1700 generally should use a different MAC address in this communication medium than the MAC address used by IP device 1834.

There are several ways to assign the value of CPE MAC address 1846 if it is configurable in STB with CM and NAT 1700. None of the following examples is meant to be limiting, but only to provide some possibilities for assigning a configurable value for at least one CPE MAC address 1846. First, users might be allowed to manually set CPE MAC address 1846 through a user interface. Next, STB with CM and NAT 1700 might listen to the communications medium with interface 1832 to learn the value of the MAC address of a customer's equipment such as IP device 1834. Also, according to the DOCSIS standards, the configuration file downloaded to a device with cable modem functionality using TFTP during CM initialization may contain the list of MAC addresses (or CPE ethernet MAC addresses). Though DOCSIS has the capability to communicate the list of allowed MAC addresses to a cable modem, often the cable modem is managed by the service provider and not by the customer or subscriber. Thus, the list of allowed MAC addresses often is not communicated to the customer either directly through access to the configuration of the cable modem or indirectly through a protocol that communicates the list of allowed MAC addresses to customer equipment. However, with the preferred embodiments of the present invention that integrate a cable modem with customer premise processes such as set-top box processes and NAT, it may be easier to communicate the information in the allowed list of MAC addresses to the customer and to change CPE MAC address 1846 to match one of the MAC addresses in the allowed list.

Cable modem (CM) processes 1804 may be able to communicate information on the allowed list of MAC addresses to other processes within STB with CM and NAT 1700 by using various mechanisms. These mechanisms may use industry standard protocols, or alternatively they may instead use proprietary, non-standard, or vendor-specific implementations within STB with CM and NAT 1700. As a non-limiting example, the user interface for configuring the CM with NAT device might be used to convey the information to humans on the allowed CPE MAC addresses. In addition, the on-screen programming user interface of a set-top box is another potential non-limiting example of communicating to humans the information on the allowed CPE MAC addresses. Furthermore, the information on the allowed CPE MAC addresses may be communicated to processing devices through various communications protocols instead of or in addition to being communicated to humans. The ability to enable or disable these ways for configuring CPE MAC address 1846 may be needed to implement various security policies of service providers and/or customers.

Also, to simplify the MAC translation processes that may be needed on STB with CM and NAT 1700 for routing and/or bridging, it might be possible for STB with CM and NAT 1700 to communicate the value for CPE MAC address 1846 to IP device 1834. Then IP device 1834 might use this MAC address as a source MAC address when forming frames communicated between IP device 1834 and STB with CM and NAT 1700 over interface 1832. One protocol that allows assignment of MAC addresses is the PPP Bridging Control Protocol (BCP) that also is known as the Bridging Network Control Protocol (BNCP). The BCP protocol is used to communicate ethernet frames using the Point-to-Point Protocol and would commonly be implemented over point-to-point communications media. BCP packets encapsulating ethernet frames may further encapsulate IP datagrams within the ethernet frames.

Finally, although FIG. 18 shows a single CPE MAC address 1846 and a single CPE IP address 1856, in general a set-top box with cable modem and NAT might have at least one CPE MAC address 1846 and at least one CPE IP address 1856. As a non-limiting example, the NAT processes 1806 may use two globally-valid internet IP addresses. Also, even though the present application has focused on integrating NAT into cable modems, there might be other customer premise processes or functions that could be implemented in a cable modem. Customer premise processes or functions are those functions that are not defined in cable modem specifications such as DOCSIS that specify the interfaces between service provider equipment and customer premise equipment (CPE). These customer premise functions normally have been left to customers to implement and maintain on CPE, generally without the involvement of the service provider. Furthermore, each customer premise or user process may be associated with at least one CPE MAC address and/or CPE IP address. Also, if STB with CMA and NAT 1700 has multiple user processes, then the multiple user processes may or may not share CPE MAC addresses and/or CPE IP addresses. In addition, if STB processes 1808 utilize IP connectivity for such functions as obtaining advertising to display on A/V CPE 1304, then STB processes generally should use at least one CPE MAC address and at least one CPE IP address that may or may not be shared with other user processes within STB with CM and NAT 1700.

In addition to NAT some examples of other customer premise processes or functions that also may be integrated into a cable modem include, but are not limited to, DHCP, firewalls, proxies, tunneling, and/or virtual private networking (VPN). Firewalls, proxies, tunneling, and/or VPN generally work by generating IP datagrams based on some received packets. The received packets may be IP datagrams but could be other protocols. As a non-limiting example, some firewalls and/or proxies may provide protocol conversion services between Novell's IPX network protocol and IP network protocols. In addition, gateway services in a firewall and/or proxy might convert between other protocols that do not include a network layer such as, but not limited to, NetBIOS/NetBEUI. Furthermore, IP tunneling and/or IP VPN technologies encapsulate other protocols inside of IP datagrams for transmission over IP networks. The other protocols actually might be encapsulated within other protocols such as, but not limited to, TCP that then are carried in the IP datagrams. Often the encapsulated protocols may be any other data communications protocols.

In general, gateway technologies for IP connectivity such as NAT, firewalls, proxies, tunneling, and/or VPN generally work by generating and/or modifying IP datagrams that are outbound from the device implementing the technology. IP datagrams transmitted upstream by a cable modem or a set-top box with cable modem functionality would be outbound IP datagrams for a cable modem or set-top box that implements at least one of these gateway services. On inbound IP datagrams the gateway technology performs a generally reverse function. IP datagrams transmitted downstream by a headend and/or distribution hub and received by a cable modem or a set-top box with cable modem are inbound IP datagrams relative to a cable modem or set-top box that implements at least one of these gateway services. In general, the inbound mapping function is not an exact inverse of the outbound mapping function because the functions have to at least account for the calculation of cyclic redundancy checks (CRC) or frame check sequences (FCS). In addition, the two mapping functions generally are not exact inverses because the destination and source IP address fields generally are swapped when inbound IP datagrams are compared to related outbound IP datagrams. Tunneling and VPN technologies that carry encapsulated data inside of IP datagrams generally add an IP header to outbound information and remove an IP header from inbound information. In tunneling and VPN technologies, the mapping that creates outbound packets by adding an IP header generally is an inverse of the mapping used on inbound packets.

For NAT, firewalls, and/or proxies, packets received by a device implementing these gateway services are converted to IP datagrams and transmitted. NAT generally provides a gateway service that converts between IP datagrams. Although firewalls and proxies also may convert between IP datagrams, firewalls and proxies might work by converting other protocols to IP. In addition, tunneling and VPN may place IP as well as other protocols inside of outbound IP datagrams. Because firewall, proxy, tunneling and/or VPN technologies may work with other protocols in addition to or instead of IP, generally the IP devices in FIGS. 1-18 might be any data device connected to a cable modem or a set-top box with cable modem functionality. The data devices might transmit medium access control (MAC) frames carrying other protocols that are not IP. The MAC frames would be received by the cable modem or set-top box. Using integrated gateway services in the cable modem or set-top box, these MAC frames could be converted to IP datagrams for transmission over the RF cable network.

MAC frames generally have some information in the frame that allows the receiving device to determine the beginning and end of the frame. In addition, many types of MAC frames contain protocol identification fields within the MAC frame. These protocol identification fields commonly can be used for uniquely identifying the type of data carried in the MAC frame. Furthermore, protocol identification fields allow MAC frames to be used in multiplexing different protocols into the communications media carrying the MAC frames. Thus, the MAC frames might carry IP and/or other protocols.

Firewalls can be classified into at least three classifications: 1) packet-filtering, 2) circuit-level gateways, and 3) application-level gateways. Packet-filtering firewall processes are different from NAT processes because firewalls generally use more sophisticated methods for inspecting and forwarding packets. These sophisticated methods often maintain additional state information about the communications crossing the firewall. This state-based or state-full packet inspection of firewalls usually offers more protection against malicious network hacking and denial of service attacks than the security protection of NAT. In general, circuit-level gateways relay connections between connection-oriented protocols such as, but not limited to, TCP. Thus, a circuit-level gateway could provide one TCP connection between a source device and the firewall and provide one TCP connection between the firewall and the destination device. Furthermore, because firewalls may work with other protocols, other connection-oriented protocols such as, but not limited to, Novell's sequence packet exchange (SPX) could be used to provide a circuit-level gateway that relays between SPX over IPX and TCP over IP. Application level gateways may provide additional conversions between protocols above the network layer. Also, firewalls implementing circuit-level gateways and application level gateways are often referred to as proxy devices, proxy servers, or proxies.

Like NAT, circuit-level gateways and/or application level gateways often translate IP addresses. Unlike NAT, these circuit-level gateways and/or application-level gateways of firewalls and/or proxies may work with other protocols instead of or in addition to IP and generally are not transparent to users of IP connectivity. Often custom client software or custom user procedures are needed to use IP connectivity through firewalls and/or proxies. For example, most web browsers have to be set up for IP connectivity using proxies. Thus, these circuit-level and/or application-level gateways generally require client devices to be aware of the gateway and to be configured to use the gateway for access. In this way the client devices generally directly inform the gateway about client sessions needing services including address and/or port translation. In contrast, NAT devices often dynamically learn about client sessions without explicit notification from client devices.

IP tunneling generally creates a connection between two IP devices and encapsulates data into IP datagrams for communication between the two IP devices. When the IP datagrams are received at the destination end of tunnel, encapsulated data is extracted and forwarded on towards its final destination. The encapsulated data may be other protocols in addition to or instead of IP. VPNs use tunneling as well as other functions such as, but not limited to, authentication and/or encryption to carry private data through a public network such as, but not limited to, the internet. A cable modem or set-top box may provide an integrated gateway service as the end point of a tunnel or VPN. Various technologies that may be used for tunneling and/or VPN include, but are not limited to, generic routing encapsulation (GRE), Ascend tunnel management protocol (ATMP), point-to-point tunneling protocol (PPTP), layer two forwarding (L2F) protocol, layer two tunneling protocol (L2TP), IP Security (IPSec), and multi-protocol label switching (MPLS).

Any of these example customer premise functions that may be integrated into a cable modem may or may not use the same CPE MAC address 1846 and/or CPE IP 1856 address as any of the other customer premise functions that also may be integrated into a set-top box with a cable modem. In addition to gateway services such as NAT, firewall, proxy, tunneling, and VPN, a DHCP server process might be used in a cable modem or set-top box to distribute private IP addresses to customer premise equipment such as IP device 1834.

In general, the term “integration” in the computer and networking fields involves combining or blending previously separate activities, programs, processes, functions, and/or hardware components into a functional whole. Within the context of the embodiments of the present invention, the terms integrated and integration generally imply that two items that are integrated together share some resources more than a communications media connecting the items and more than any instances of the algorithms of media access control (MAC) protocols that correspond to the communications media shared by the two items. (Generally communications media are not considered to be communications devices, and thus communications media do not actively retain state information beyond the time it takes to propagate a signal through the media. However, when two communications devices are connected to a communications media, the devices may share some information on the state of the communications media because each device generally may be running processes that are at least one instance of the media access control (MAC) protocol for that communications media.)

For the embodiments of the present invention, two integrated items generally are within the same box or device and/or generally use the same at least one connection to an electrical power outlet. (The power outlet need not necessarily be an alternating current (A.C.) power outlet.) Generally, in addition to sharing at least one power source and/or being in the same box or device, integrated items may share other resources of a device or box such as, but not limited to, processing and/or storage. The shared processing may or may not include the use of at least one microprocessor, and the shared storage may or may not include the use of at least one digital memory. Furthermore, the resources shared by integrated items may include software and/or hardware (such as, but not limited to, circuitry and/or logic). Also, the integration of items into one device or box generally allows the device or box to use at least one common user interface for the integrated items. In effect, the integrated items generally share at least one common user interface for the device or box.

Because the communications media for connecting customer premise data devices to STB with CM and NAT 1700 are not necessarily limited to the DOCSIS CMCI-compliant communications media of ethernet, USB, and PCI, FIG. 18 shows the potential integration of non-DOCSIS communications media into a set-top box with cable modem functionality that generally may be compliant with DOCSIS RFI and/or DOCSIS TRI. Furthermore, FIG. 18 expressly shows STB with CM and NAT 1700 connected to more than one communications medium for communicating with customer premise data devices such as IP devices 1824 and 1834. Thus, FIG. 18 shows the potential integration of interfaces for more than one communications media into a set-top box with cable modem functionality. The more than one communications media (represented in FIG. 18 by interfaces 1822 and 1832) generally are used by the set-top box with cable modem functionality for communicating with customer premise data devices.

As shown in FIG. 18, IP device 1824 is connected to STB with CM and NAT 1700 through interface 1822, and IP device 1834 is connected to STB with CM and NAT 1700 through interface 1832. Although FIG. 18 shows IP device 1834 using NAT processes 1806 and IP device 1824 not using NAT processes 1806, this example is only for illustrative purposes and is not intended to be limiting. In general, customer premise data devices connected to STB with CM and NAT 1700 through any communications media may be able to communicate information over RF cable interface 1416a with or without utilizing the network address translation processes 1806 depending on the configuration and/or architecture of STB with CM and NAT 1700 as well as depending on the IP address assignments in the network. Also, a set-top box with cable modem functionality that further has multiple communications media for communicating with customer premise data network devices may or may not be compliant with DOCSIS RFI and/or DOCSIS TRI.

In addition, FIG. 18 shows the integration of cable modem functionality into a set-top box. The cable modem functionality of a set-top box may or may not be DOCSIS cable modem functionality. Furthermore, FIG. 18 shows the integration of user processes such as, but not limited to, network address translation into the STB with CM and NAT 1700. Other user processes that may or may not be integrated into a cable modem include tasks such as, but not limited to, DHCP servers, firewalls, and/or proxies. In addition, combinations, variations, and/or subsets of the possible user processes also may be integrated into STB with CM and NAT 1700. The integration of items in the embodiments of the present invention allows for capabilities and/or functions that generally were not available in solutions using separate (non-integrated) devices, components, and/or functions.

In general, the integration of additional functionality into a set-top box may or may not require additional processing capacity and/or storage capacity such as, but not limited to, digital memory. Furthermore, sometimes the integration of additional functionality into a set-top box might require additional software and/or hardware such as, but not limited to, circuitry and logic. Generally, integrating more functionality into a set-top box often increases the amount of hardware and/or software needed in the device, which usually raises the production costs of the device. To have a common platform for set-top boxes and to maintain a low price point for entry-level set-top box devices with lesser functionality, the additional hardware and/or software, which may be needed to support the integration of more advanced functionality, might be implemented in optional modules. These optional modules might be modular option cards or expansion cards that may be installed at the factory or possibly in the field (e.g., at the customer premise) by service technicians and/or customers. Furthermore, software upgrades might be downloaded to the set-top box through any communications media connected to the cable modem.

Some examples of interfaces that might be used for connecting expansion modules to a set-top box include, but are not limited to, the interfaces that have historically been used for expansion interfaces. A few particular non-limiting examples of these historical expansion interfaces are: 1) the AT/ISA bus (Advanced Technology/Industry Standard Architecture) of older PCs, 2) the PCMCIA (Personal Computer Memory Card International Association or PC Card) standard generally used for laptops, and 3) the PCI (Peripheral Component Interconnect) bus of newer PCs. In addition to industry standard expansion interfaces, many equipment vendors in the computer and networking fields often have designed their own proprietary expansion interfaces. None of these examples of expansion interfaces are meant to be limiting as there are many existing standard and proprietary expansion interfaces, and many new and modified expansion interfaces likely will be developed in the future.

Functionality of various preferred embodiments of the present invention can be implemented in hardware, software, firmware, or a combination thereof. In the preferred embodiments, the functionality is implemented in software or firmware that is stored in a memory and that is executed by a suitable instruction execution system. If implemented in hardware, as in an alternative embodiment, the functionality can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In addition, any process descriptions should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

Furthermore, in embodiments including ordered listings of executable instructions for implementing logical functions, such ordered listings can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

It should also be emphasized that the above-described embodiments of the present invention, are merely possible examples, among many others, of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

Now, therefore, at least the following is claimed:

1. A radio frequency cable network device that implements at least one gateway service, the device comprising:
at least one RF cable interface that is attachable to at least one RF cable, the at least one RF cable being at least part of an RF cable data network, the at least one RF cable at least providing downstream communications in the RF cable data network, the RF cable data network providing bi-directional data connectivity between the RF cable network device at a customer premise and a cable modem termination device;
at least one customer premise data interface that is electromagnetically connectable to at least one customer premise data communications medium, the at least one customer premise data communications medium further being electromagnetically connectable to at least one first customer premise equipment (CPE) data device, the at least one RF cable interface and the at least one customer premise data interface capable of providing at least part of a communications facility that can be used in a conveyance of data between the at least one first CPE data device and the at least one RF cable interface;
logic configured to store information identifying at least one IP address, the at least one IP address being assigned to the RF cable network device;
logic configured to forward packets containing IP datagrams between the RF cable network and at least one first customer premise equipment (CPE) data device; and
logic configured to provide at least one gateway service to the at least one first CPE data device, the at least one gateway service facilitating communications of the at least one first CPE data device that are carried in IP datagrams over the RF cable data network.

2. The RF cable network device of claim 1, wherein the RF cable data network further comprises at least one telco return path that at least provides upstream communications in the RF cable data network.

3. The RF cable network device of claim 1, wherein the at least one gateway service is selected from the group consisting of: network address translation (NAT), firewall, proxy, tunneling, and virtual private networking (VPN).

4. The RF cable network device of claim 3, wherein the NAT gateway service performs at least one type of NAT selected from the group consisting of: traditional NAT, basic NAT, network address-port translation (NAPT), bi-directional NAT, and twice NAT.

5. The RF cable network device of claim 1, wherein the at least one gateway service is selected the group consisting of: firewall and proxy.

6. The RF cable network device of claim 5, wherein the firewall gateway service performs at least one of the firewall types selected from the group consisting of: packet-filtering, circuit-level gateway, and application layer gateway.

7. The RF cable network device of claim 6, wherein the packet-filtering firewall type provides network security utilizing a state-based packet inspection to protect the at least first CPE data device.

8. The RF cable network device of claim 5, wherein the at least one gateway service performs at least one of the gateway service types selected from the group consisting of: circuit-level gateway and application layer gateway.

9. The RF cable network device of claim 8, wherein the at least one gateway service proxies at least one session of the at least one first CPE data device, the at least one session communicated by the at least one first CPE data device over the at least one customer premise data communications medium, and the at least one session communicated through the RF cable network device and into the RF cable network.

10. The RF cable network device of claim 3 further comprising logic configured dynamically assign at least one customer network IP address to the at least one first CPE data device.

11. The RF cable network device of claim 10, wherein the logic configured to dynamically assign at least one customer network IP address comprises Dynamic Host Configuration Protocol (DHCP) server logic.

12. The RF cable network device of claim 10, wherein the at least one customer network IP address is from a different IP address realm than the at least one IP address for RF cable data network access.

13. The RF cable network device of claim 3, wherein the RF cable network device appears on the RF cable data network to be the same as an ethernet attached cable modem that conforms to at least one version of a DOCSIS (Data-Over-Cable Service Interface Specification) standard.

14. The RF cable network device of claim 3, wherein the RF cable network device is a set-top box (STB) that further comprises:
at least one audio/video (A/V) customer premise equipment (CPE) interface that is electromagnetically connectable to at least one customer premise audio/video (A/V) communications medium;
logic configured to select at least one audio/video (A/V) program that is communicated to the at least one RF cable interface over at least one RF cable audio/visual (A/V) network;
logic configured to receive the selected at least one A/V program from the RF cable A/V network; and
logic configured to provide the received at least one A/V program to at least one audio/video (A/V) customer premise equipment (CPE) device that is electromagnetically connectable to the at least one customer premise A/V communications medium, the at least one A/V program communicated through the at least one A/V CPE interface and over the at least one customer premise A/V communications medium.

15. The set-top box of claim 14, wherein the at least one A/V CPE device is selected from the group consisting of: a television, a video recorder, a stereo, and an audio recorder.

16. The set-top box of claim 14, wherein the set-top box appears on the RF cable data network to be the same as an ethernet attached cable modem that conforms to at least one version of a DOCSIS (Data-Over-Cable Service Interface Specification) standard.

17. The set-top box of claim 16, wherein the at least one IP address is at least one DOCSIS customer premise equipment (CPE) IP address, the set-top box further comprising logic configured to store information identifying at least one DOCSIS cable modem (CM) IP address, the at least one DOCSIS CM IP address also considered to be assigned to the set-top box, the at least one DOCSIS CPE IP address being different from the at least one DOCSIS CM IP address.

18. The set-top box of claim 14, wherein the set-top box appears on the RF cable data network to conform to at least one version of a DAVIC (Digital Audio Visual Council) cable modem standard.

19. The set-top box of claim 14, wherein at least one option card is added to a base unit of the set-top box to provide at least support to the at least one gateway service.

20. The RF cable network device of claim 3, wherein the RF cable network device is a cable modem (CM).

21. The cable modem of claim 20, wherein the cable modem (CM) appears on the RF cable data network to be the same as an ethernet attached cable modem that conforms to at least one version of a DOCSIS (Data-Over-Cable Service Interface Specification) standard.

22. The cable modem of claim 21, wherein the at least one IP address is at least one DOCSIS customer premise equipment (CPE) IP address, the cable modem further comprising logic configured to store information identifying at least one DOCSIS cable modem (CM) IP address, the at least one DOCSIS CM IP address also considered to be assigned to the cable modem, the at least one DOCSIS CPE IP address being different from the at least one DOCSIS CM IP address.

23. The cable modem of claim 20, wherein the cable modem (CM) appears on the RF cable data network to conform to at least one version of a DAVIC (Digital Audio Visual Council) cable modem standard.

24. The cable modem of claim 20, wherein at least one option card is added to a base unit of the cable modem to provide at least support to the at least one gateway service.

25. A radio frequency (RF) cable network device configured to provide data connectivity over an RF cable network, the device comprising:
at least one RF cable interface that is attachable to at least one RF cable, the at least one RF cable being at least part of an RF cable data network, the at least one RF cable at least providing downstream communications in the RF cable data network, the RF cable data network providing bi-directional data connectivity between the RF cable network device at a customer premise and a cable modem termination device;
at least one customer premise data interface that is electromagnetically connectable to at least one customer premise data communications medium, the at least one customer premise data communications medium further being electromagnetically connectable to at least one first customer premise equipment (CPE) data device, the at least one RF cable interface and the at least one customer premise data interface capable of providing at least part of a communications facility that can be used in a conveyance of data between the at least one first CPE data device and the at least one RF cable interface;
logic configured to forward data between the at least one RF cable interface and the at least one customer premise data interface;
logic configured to frequency-division multiplex the data over the at least one customer premise data communications medium, which is at least one wired customer premise data communications medium.

26. The RF cable network device of claim 25, wherein option cards are added to a base unit of the RF cable network device to support the at least one wired customer premise data communications medium.

27. The RF cable network device of claim 25, wherein the RF cable network device appears on the RF cable data network to be the same as an ethernet attached cable modem that conforms to at least one version of a DOCSIS (Data-Over-Cable Service Interface Specification) standard.

28. The RF cable network device of claim 25, wherein the at least one wired customer premise data communications medium is telephone wiring at the customer premise, and wherein the data is frequency-division multiplexed with a signal for carrying an analog POTS voice-frequency band signal.

29. The RF cable network device of claim 25, wherein the at least one wired customer premise data communications medium is electrical power wiring at the customer premise, and wherein the data is frequency-division multiplexed with a signal for carrying electrical power to appliances at the customer premise.

30. The RF cable network device of claim 25, wherein the RF cable network device is a set-top box (STB) that further comprises:
at least one audio/video (A/V) customer premise equipment (CPE) interface that is electromagnetically connectable to at least one customer premise audio/video (A/V) communications medium;
logic configured to select at least one audio/video (A/V) program that is communicated to the at least one RF cable interface over at least one RF cable audio/visual (A/V) network;
logic configured to receive the selected at least one A/V program from the RF cable A/V network; and
logic configured to provide the received at least one A/V program to at least one audio/video (A/V) customer premise equipment (CPE) device that is electromagnetically connectable to the at least one customer premise A/V communications medium, the at least one A/V program communicated through the at least one A/V CPE interface and over the at least one customer premise A/V communications medium.

31. The set-top box of claim 30, wherein the at least one A/V CPE device is selected from the group consisting of: a television, a video recorder, a stereo, and an audio recorder.

32. The set-top box of claim 30 that implements at least one gateway service by further comprising:
logic configured to provide at least one gateway service to the at least one first CPE data device, the at least one gateway service facilitating communications of the at least one first CPE data device that are carried in IP datagrams over the RF cable data network.

33. The set-top box of claim 32, wherein the at least one gateway service is selected from the group consisting of: network address translation (NAT), firewall, proxy, tunneling, and virtual private networking (VPN).

34. The set-top box of claim 33, wherein the RF cable network device appears on the RF cable data network to be the same as an ethernet attached cable modem that conforms to at least one version of a DOCSIS (Data-Over-Cable Service Interface Specification) standard.

35. The RF cable network device of claim 25, wherein the RF cable network device is a cable modem (CM).

36. The cable modem of claim 35 that implements at least one gateway service by further comprising:
logic configured to provide at least one gateway service to the at least one first CPE data device, the at least one gateway service facilitating communications of the at least one first CPE data device that are carried in IP datagrams over the RF cable data network.

37. The cable modem of claim 36, wherein the at least one gateway service is selected from the group consisting of: network address translation (NAT), firewall, proxy, tunneling, and virtual private networking (VPN).

38. The cable modem of claim 37, wherein the RF cable network device appears on the RF cable data network to be the same as an ethernet attached cable modem that conforms to at least one version of a DOCSIS (Data-Over-Cable Service Interface Specification) standard.

39. A radio frequency (RF) cable network device configured to provide data connectivity over an RF cable network, the device comprising:
at least one RF cable interface that is attachable to at least one RF cable, the at least one RF cable being at least part of an RF cable data network, the at least one RF cable at least providing downstream communications in the RF cable data network, the RF cable data network providing bi-directional data connectivity between the RF cable network device at a customer premise and a cable modem termination device;
at least one customer premise data interface that is electromagnetically connectable to at least one customer premise data communications medium, the at least one customer premise data communications medium further being electromagnetically connectable to at least one first customer premise equipment (CPE) data device, the at least one RF cable interface and the at least one customer premise data interface capable of providing at least part of a communications facility that can be used in a conveyance of data between the at least one first CPE data device and the at least one RF cable interface;
logic configured to forward data between the at least one RF cable interface and the at least one customer premise data interface, the at least one customer premise data communications medium being at least one wireless customer premise data communications medium.

40. The RF cable network device of claim 39, wherein option cards are added to a base unit of the RF cable network device to support the at least one wireless customer premise data communications medium.

41. The RF cable network device of claim 39, wherein the RF cable network device appears on the RF cable data network to be the same as an ethernet attached cable modem that conforms to at least one version of a DOCSIS (Data-Over-Cable Service Interface Specification) standard.

42. The RF cable network device of claim 41, wherein the at least one wireless customer premise data communications medium conforms to at least one version of at least one protocol selected from the group consisting of: Bluetooth, IEEE 802.11a, IEEE 802.11b, and HomeRF.

43. The RF cable network device of claim 39, wherein the at least one wireless customer premise data communications medium conforms to at least one version of at least one protocol selected from the group consisting of: Bluetooth, IEEE 802.11a, IEEE 802.11b, and HomeRF.

44. A set-top box (STB) comprising:
at least one RF cable interface that is attachable to at least one RF cable audio/visual (A/V) network;
at least one audio/video (A/V) customer premise equipment (CPE) interface that is electromagnetically connectable to at least one customer premise audio/video (A/V) communications medium;
logic configured to select at least one audio/video (A/V) program that is communicated to the at least one RF cable interface over the at least one RF cable audio/visual (A/V) network;
logic configured to receive the selected at least one A/V program from the RF cable A/V network;
logic configured to provide the received at least one A/V program to at least one audio/video (A/V) customer premise equipment (CPE) device that is electromagnetically connectable to the at least one customer premise A/V communications medium, the at least one A/V program communicated through the at least one A/V CPE interface and over the at least one customer premise A/V communications medium;
at least one RF cable interface that is attachable to at least one RF cable, the at least one RF cable being at least part of an RF cable data network, the at least one RF cable at least providing downstream communications in the RF cable data network, the RF cable data network providing bi-directional data connectivity between the RF cable network device at a customer premise and a cable modem termination device;
logic configured to store information identifying at least one IP address, the at least one IP address being assigned to the set-top box; and
logic configured to forward packets containing IP datagrams from the set-top box over the RF cable data network.

45. The set-top box of claim 44, wherein the at least one A/V CPE device is selected from the group consisting of: a television, a video recorder, a stereo, and an audio recorder.

46. The set-top box of claim 44, wherein the set-top box appears on the RF cable data network to be the same as an ethernet attached cable modem that conforms to at least one version of a DOCSIS (Data-Over-Cable Service Interface Specification) standard.

47. The set-top box of claim 46, wherein the at least one IP address is at least one DOCSIS customer premise equipment (CPE) IP address, the set-top box further comprising logic configured to store information identifying at least one DOCSIS cable modem (CM) IP address, the at least one DOCSIS CM IP address also considered to be assigned to the set-top box, the at least one DOCSIS CPE IP address being different from the at least one DOCSIS CM IP address.

48. The set-top box of claim 44 further comprising:
at least one customer premise data interface that is electromagnetically connectable to at least one customer premise data communications medium, the at least one customer premise data communications medium further being electromagnetically connectable to at least one first customer premise equipment (CPE) data device, the at least one RF cable interface and the at least one customer premise data interface capable of providing at least part of a communications facility that can be used in a conveyance of data between the at least one first CPE data device and the at least one RF cable interface.

49. The set-top box of claim 48, wherein the set-top box appears on the RF cable data network to be the same as an ethernet attached cable modem that conforms to at least one version of a DOCSIS (Data-Over-Cable Service Interface Specification) standard.

50. The set-top box of claim 49, wherein the at least one IP address is at least one DOCSIS customer premise equipment (CPE) IP address, the set-top box further comprising logic configured to store information identifying at least one DOCSIS cable modem (CM) IP address, the at least one DOCSIS CM IP address also considered to be assigned to the set-top box, the at least one DOCSIS CPE IP address being different from the at least one DOCSIS CM IP address.

51. The set-top box of claim 48 further comprising:
logic configured to provide at least one gateway service to the at least one first CPE data device, the at least one gateway service facilitating communications of the at least one first CPE data device that are carried in IP datagrams over the RF cable data network.

52. The set-top box of claim 51, wherein the at least one gateway service is selected from the group consisting of: network address translation (NAT), firewall, proxy, tunneling, and virtual private networking (VPN).

53. The set-top box of claim 52, wherein the set-top box appears on the RF cable data network to be the same as an ethernet attached cable modem that conforms to at least one version of a DOCSIS (Data-Over-Cable Service Interface Specification) standard.

54. The set-top box of claim 53, wherein the at least one IP address is at least one DOCSIS customer premise equipment (CPE) IP address, the set-top box further comprising logic configured to store information identifying at least one DOCSIS cable modem (CM) IP address, the at least one DOCSIS CM IP address also considered to be assigned to the set-top box, the at least one DOCSIS CPE IP address being different from the at least one DOCSIS CM IP address.

55. A method of implementing at least one gateway service in a radio frequency (RF) cable network device, the method comprising the steps performed in the RF cable network device of:
providing at least one RF cable interface that is attachable to at least one RF cable, the at least one RF cable being at least part of an RF cable data network, the at least one RF cable at least providing downstream communications in the RF cable data network, the RF cable data network providing bi-directional data connectivity between the RF cable network device at a customer premise and a cable modem termination device;
providing at least one customer premise data interface that is electromagnetically connectable to at least one customer premise data communications medium, the at least one customer premise data communications medium further being electromagnetically connectable to at least one first customer premise equipment (CPE) data device, the at least one RF cable interface and the at least one customer premise data interface capable of providing at least part of a communications facility that can be used in a conveyance of data between the at least one first CPE data device and the at least one RF cable interface;
storing information identifying at least one IP address, the at least one IP address being assigned to the RF cable network device;
forwarding packets containing IP datagrams between the RF cable network and at least one first customer premise equipment (CPE) data device; and
providing at least one gateway service to the at least one first CPE data device, the at least one gateway service facilitating communications of the at least one first CPE data device that are carried in IP datagrams over the RF cable data network.

56. The method of claim 55, wherein the RF cable data network further comprises at least one telco return path that at least provides upstream communications in the RF cable data network.

57. The method of claim 55, wherein the at least one gateway service is selected from the group consisting of: network address translation (NAT), firewall, proxy, tunneling, and virtual private networking (VPN).

58. The method of claim 55, wherein the RF cable network device appears on the RF cable data network to be the same as an ethernet attached cable modem that conforms to at least one version of a DOCSIS (Data-Over-Cable Service Interface Specification) standard.

59. A method of providing data connectivity over an RF cable network, the method comprising the steps performed in a radio frequency (RF) cable network device of:
providing at least one RF cable interface that is attachable to at least one RF cable, the at least one RF cable being at least part of an RF cable data network, the at least one RF cable at least providing downstream communications in the RF cable data network, the RF cable data network providing bi-directional data connectivity between the RF cable network device at a customer premise and a cable modem termination device;
providing at least one customer premise data interface that is electromagnetically connectable to at least one customer premise data communications medium, the at least one customer premise data communications medium further being electromagnetically connectable to at least one first customer premise equipment (CPE) data device, the at least one RF cable interface and the at least one customer premise data interface capable of providing at least part of a communications facility that can be used in a conveyance of data between the at least one first CPE data device and the at least one RF cable interface;
forwarding data between the at least one RF cable interface and the at least one customer premise data interface;
multiplexing the data over the at least one customer premise data communications medium using frequency-division multiplexing, the at least one customer premise data communications medium being at least one wired customer premise data communications medium.

60. The method of claim 59, wherein the RF cable network device appears on the RF cable data network to be the same as an ethernet attached cable modem that conforms to at least one version of a DOCSIS (Data-Over-Cable Service Interface Specification) standard.

61. The method of claim 59, wherein the at least one wired customer premise data communications medium is telephone wiring at the customer premise, and wherein the data is frequency-division multiplexed with a signal for carrying an analog POTS voice-frequency band signal.

62. The method of claim 59, wherein the at least one wired customer premise data communications medium is electrical power wiring at the customer premise, and wherein the data is frequency-division multiplexed with a signal for carrying electrical power to appliances at the customer premise.

63. A method of providing data connectivity over an RF cable network, the method comprising the steps performed in a radio frequency (RF) cable network device of:
providing at least one RF cable interface that is attachable to at least one RF cable, the at least one RF cable being at least part of an RF cable data network, the at least one RF cable at least providing downstream communications in the RF cable data network, the RF cable data network providing bi-directional data connectivity between the RF cable network device at a customer premise and a cable modem termination device;
providing at least one customer premise data interface that is electromagnetically connectable to at least one customer premise data communications medium, the at least one customer premise data communications medium further being electromagnetically connectable to at least one first customer premise equipment (CPE) data device, the at least one RF cable interface and the at least one customer premise data interface capable of providing at least part of a communications facility that can be used in a conveyance of data between the at least one first CPE data device and the at least one RF cable interface;
forwarding data between the at least one RF cable interface and the at least one customer premise data interface, the at least one customer premise data communications medium being at least one wireless customer premise data communications medium.

64. The method of claim 63, wherein the RF cable network device appears on the RF cable data network to be the same as an ethernet attached cable modem that conforms to at least one version of a DOCSIS (Data-Over-Cable Service Interface Specification) standard.

65. The method of claim 63, wherein the at least one wireless customer premise data communications medium conforms to at least one version of at least one protocol selected from the group consisting of: Bluetooth, IEEE 802.11a, IEEE 802.11b, and HomeRF.

66. A method of providing IP connectivity to a set-top box (STB), the method comprising the steps performed in the set-top box of:
providing at least one RF cable interface that is attachable to at least one RF cable audio/visual (A/V) network;
providing at least one audio/video (A/V) customer premise equipment (CPE) interface that is electromagnetically connectable to the at least one customer premise audio/video (A/V) communications medium;
selecting at least one audio/video (A/V) program that is communicated to the at least one RF cable interface over at least one RF cable audio/visual (A/V) network;
receiving the selected at least one A/V program from the RF cable A/V network;
providing the received at least one A/V program to at least one audio/video (A/V) customer premise equipment (CPE) device that is electromagnetically connectable to the at least one customer premise A/V communications medium, the at least one A/V program communicated through the at least one A/V CPE interface and over the at least one customer premise A/V communications medium;
providing at least one RF cable interface that is attachable to at least one RF cable, the at least one RF cable being at least part of an RF cable data network, the at least one RF cable at least providing downstream communications in the RF cable data network, the RF cable data network providing bi-directional data connectivity between the RF cable network device at a customer premise and a cable modem termination device;
storing information identifying at least one IP address, the at least one IP address being assigned to the set-top box; and
forwarding packets containing IP datagrams from the set-top box over the RF cable data network.

67. The method of claim 66, wherein the at least one A/V CPE device is selected from the group consisting of: a television, a video recorder, a stereo, and an audio recorder.

68. The method of claim 66 further comprising the step performed in the set-top box of: providing at least one customer premise data interface that is electromagnetically connectable to at least one customer premise data communications medium, the at least one customer premise data communications medium further being electromagnetically connectable to at least one first customer premise equipment (CPE) data device, the at least one RF cable interface and the at least one customer premise data interface capable of providing at least part of a communications facility that can be used in a conveyance of data between the at least one first CPE data device and the at least one RF cable interface.

69. The method of claim 68 further comprising the step performed in the set-top box of:
providing at least one gateway service to the at least one first CPE data device, the at least one gateway service facilitating communications of the at least one first CPE data device that are carried in IP datagrams over the RF cable data network.

70. The method of claim 69, wherein the at least one gateway service is selected from the group consisting of: network address translation (NAT), firewall, proxy, tunneling, and virtual private networking (VPN).

71. The method of claim 70, wherein the set-top box appears on the RF cable data network to be the same as an ethernet attached cable modem that conforms to at least one version of a DOCSIS (Data-Over-Cable Service Interface Specification) standard.

72. A radio frequency (RF) cable network device that implements at least one integrated gateway service, the device comprising:
at least one RF cable interface that is attachable to at least one RF cable, the at least one RF cable being at least part of an RF cable data network, the at least one RF cable at least providing downstream communications in the RF cable data network, the RF cable data network providing bi-directional data connectivity between the RF cable network device at a customer premise and a cable modem termination device;
at least one customer premise data interface that is electromagnetically connectable to at least one customer premise data communications medium, the at least one customer premise data communications medium further being electromagnetically connectable to at least one first customer premise equipment (CPE) data device, the at least one RF cable interface and the at least one customer premise data interface capable of providing at least part of a communications facility that can be used in a conveyance of data between the at least one first CPE data device and the at least one RF cable interface;
logic configured to store information identifying at least one IP address, the at least one IP address being assigned to the RF cable network device;
logic configured to maintain information that provides a forward direction mapping between first upstream data and second upstream data, the first upstream data being received on the at least one customer premise data interface and being received from the at least one first CPE data device, the second upstream data being transmitted into the RF cable data network and being transmitted by the RF cable network device;
logic configured to maintain information that provides a reverse direction mapping between first downstream data and second downstream data, the first downstream data being received on the at least one RF cable interface and being received from the RF cable data network, the second downstream data being transmitted on the at least one customer premise data interface and being transmitted by the RF cable network device;
logic configured to receive at least one first medium access control (MAC) frame that is at least part of the first upstream data;
logic configured to form at least one first IP datagram at least based upon the at least one first MAC frame, at least based upon the at least one IP address, and at least based upon the forward direction mapping, the at least one first IP datagram comprising a source IP address field, the at least one IP address being placed into the source IP address field of the at least one first IP datagram;
logic configured to transmit the at least one first IP datagram that is at least part of the second upstream data;
logic configured to receive at least one second IP datagram that is at least part of the first downstream data, the at least one second IP datagram comprising a destination IP address field that contains the at least one IP address;
logic configured to form at least one second medium access control (MAC) frame at least based upon the at least one second IP datagram, at least based upon the at least one IP address, and at least based upon the reverse direction mapping; and
logic configured to transmit the at least one second MAC frame that is at least part of the second downstream data.

73. The RF cable network device of claim 72, wherein the RF cable data network further comprises at least one telco return path that at least provides upstream communications in the RF cable data network.

74. The RF cable network device of claim 72, wherein the at least one first MAC frame comprises a third IP datagram, wherein the at least one second MAC frame comprises a fourth IP datagram, and wherein the RF cable network device is configured to perform network address translation (NAT), NAT being a gateway service that translates information in IP datagrams.

75. The RF cable network device of claim 74, wherein the NAT performed is at least one type of NAT selected from the group consisting of: traditional NAT, basic NAT, network address-port translation (NAPT), bi-directional NAT, and twice NAT.

76. The RF cable network device of claim 74 being further configured to perform at least one application layer gateway (ALG) service.

77. The RF cable network device of claim 76, wherein the application layer gateway service provides gateway services to at least one version of at least one TCP/IP (transmission control protocol/internet protocol) suite application protocol that is selected from the group of consisting of: telnet, rlogin, file transfer protocol (FTP), trivial file transfer protocol (TFTP), network file system (NFS), electronic mail, simple mail transfer protocol (SMTP), post office protocol (POP), internet message access protocol (IMAP), multipurpose internet mail extensions (MIME), hyper-text transfer protocol (HTTP), real-time transport protocol (RTP), and simple network management protocol (SNMP).

78. The RF cable network device of claim 74, wherein the at least one customer premise communications medium is further electromagnetically connectable to at least one second customer premise equipment (CPE) data device that has IP connectivity through the RF cable network device to the RF cable data network without utilizing NAT.

79. The RF cable network device of claim 74, wherein the at least one customer premise communications medium is further electromagnetically connectable to at least one second customer premise equipment (CPE) data device, the RF cable network device further comprising logic configured to block IP connectivity between the at least one second customer premise equipment (CPE) data device and the RF cable data network.

80. The RF cable network device of claim 74, wherein the RF cable network device is a set-top box (STB) that further comprises:
at least one audio/video (A/V) customer premise equipment (CPE) interface that is electromagnetically connectable to at least one customer premise audio/video (A/V) communications medium;
logic configured to select at least one audio/video (A/V) program that is communicated to the at least one RF cable interface over at least one RF cable audio/visual (A/V) network;
logic configured to receive the selected at least one A/V program from the RF cable A/V network; and
logic configured to provide the received at least one A/V program to at least one audio/video (A/V) customer premise equipment (CPE) device that is electromagnetically connectable to the at least one customer premise A/V communications medium, the at least one A/V program in communicated through the at least one A/V CPE interface and over the at least one customer premise A/V communications medium.

81. The set-top box of claim 80, wherein the at least one A/V CPE device is selected from the group consisting of: a television, a video recorder, a stereo, and an audio recorder.

82. The set-top box of claim 80, wherein the set-top box appears on the RF cable data network to be the same as an ethernet attached cable modem that conforms to at least one version of a DOCSIS (Data-Over-Cable Service Interface Specification) standard.

83. The set-top box of claim 82, wherein the at least one IP address is at least one DOCSIS customer premise equipment (CPE) IP address, the set-top box further comprising logic configured to store information identifying at least one DOCSIS cable modem (CM) IP address, the at least one DOCSIS CM IP address also considered to be assigned to the set-top box, the at least one DOCSIS CPE IP address being different from the at least one DOCSIS CM IP address.

84. The set-top box of claim 80, wherein the set-top box appears on the RF cable data network to conform to at least one version of a DAVIC (Digital Audio Visual Council) cable modem standard.

85. The set-top box of claim 80, wherein at least one option card is added to a base unit of the set-top box to provide at least support for the performance of NAT by the set-top box.

86. The RF cable network device of claim 74, wherein the RF cable network device is a cable modem (CM).

87. The cable modem of claim 86, wherein the cable modem (CM) appears on the RF cable data network to be the same as an ethernet attached cable modem that conforms to at least one version of a DOCSIS (Data-Over-Cable Service Interface Specification) standard.

88. The cable modem of claim 87, wherein the at least one IP address is at least one DOCSIS customer premise equipment (CPE) IP address, the cable modem further comprising logic configured to store information identifying at least one DOCSIS cable modem (CM) IP address, the at least one DOCSIS CM IP address also considered to be assigned to the cable modem, the at least one DOCSIS CPE IP address being different from the at least one DOCSIS CM IP address.

89. The cable modem of claim 86, wherein the cable modem (CM) appears on the RF cable data network to conform to at least one version of a DAVIC (Digital Audio Visual Council) cable modem standard.

90. The cable modem of claim 86, wherein at least one option card is added to a base unit of the cable modem to provide at least support for the performance of NAT by the cable modem.

91. The RF cable network device of claim 74, wherein the at least one customer premise data communications medium is at least one wired customer premise data communications medium.

92. The RF cable network device of claim 91, wherein at least one option card is added to a base unit of the RF cable network device to provide at least support for the at least one wired customer premise data communications medium.

93. The RF cable network device of claim 91, wherein the at least one wired customer premise data communications medium is at least one communications medium that at least utilizes time-division multiplexing.

94. The RF cable network device of claim 93, wherein the at least one wired customer premise data communications medium is at least one selection from the group consisting of: RS-232, RS-449, V.35, universal serial bus (USB), ethernet, and token ring.

95. The RF cable network device of claim 93, wherein the RF cable network device is a set-top box (STB) that further comprises:
at least one audio/video (A/V) customer premise equipment (CPE) interface that is electromagnetically connectable to at least one customer premise audio/video (A/V) communications medium;
logic configured to select at least one audio/video (A/V) program that is communicated to the at least one RF cable interface over at least one RF cable audio/visual (A/V) network;
logic configured to receive the selected at least one A/V program from the RF lose cable A/V network; and
logic configured to provide the received at least one A/V program to at least one audio/video (A/V) customer premise equipment (CPE) device that is electromagnetically connectable to the at least one customer premise A/V communications medium, the at least one A/V program communicated through the at least one A/V CPE interface and over the at least one customer premise A/V communications medium.

96. The set-top box of claim 95, wherein the at least one A/V CPE device is selected from the group consisting of: a television, a video recorder, a stereo, and an audio recorder.

97. The set-top box of claim 95, wherein the set-top box appears on the RF cable data network to be the same as an ethernet attached cable modem that conforms to at least one version of a DOCSIS (Data-Over-Cable Service Interface Specification) standard.

98. The set-top box of claim 97, wherein the at least one IP address is at least one DOCSIS customer premise equipment (CPE) IP address, the set-top box further comprising logic configured to store information identifying at least one DOCSIS cable modem (CM) IP address, the at least one DOCSIS CM IP address also considered to be assigned to the set-top box, the at least one DOCSIS CPE IP address being different from the at least one DOCSIS CM IP address.

99. The set-top box of claim 95, wherein the set-top box appears on the RF cable data network to conform to at least one version of a DAVIC (Digital Audio Visual Council) cable modem standard.

100. The RF cable network device of claim 93, wherein the RF cable network device is a cable modem (CM).

101. The cable modem of claim 100, wherein the cable modem (CM) appears on the RF cable data network to be the same as an ethernet attached cable modem that conforms to at least one version of a DOCSIS (Data-Over-Cable Service Interface Specification) standard.

102. The cable modem of claim 101, wherein the at least one IP address is at least one DOCSIS customer premise equipment (CPE) IP address, the cable modem further comprising logic configured to store information identifying at least one DOCSIS cable modem (CM) IP address, the at least one DOCSIS CM IP address also considered to be assigned to the cable modem, the at least one DOCSIS CPE IP address being different from the at least one DOCSIS CM IP address.

103. The cable modem of claim 100, wherein the cable modem (CM) appears on the RF cable data network to conform to at least one version of a DAVIC (Digital Audio Visual Council) cable modem standard.

104. The RF cable network device of claim 91, wherein the at least one wired customer premise data communications medium at least utilizes frequency-division multiplexing.

105. The RF cable network device of claim 104, wherein the at least one wired customer premise data communications medium is telephone wiring at the customer premise, and wherein IP datagrams are frequency-division multiplexed with a signal for carrying an analog POTS voice-frequency band signal.

106. The RF cable network device of claim 105, wherein the at least one wired customer premise data communications medium conforms to at least one version of a Home Phoneline Networking Alliance (HPNA) standard.

107. The RF cable network device of claim 105, wherein the RF cable network device is a set-top box (STB) that further comprises:
at least one audio/video (A/V) customer premise equipment (CPE) interface that is electromagnetically connectable to at least one customer premise audio/video (A/V) communications medium;
logic configured to select at least one audio/video (A/V) program that is communicated to the at least one RF cable interface over at least one RF cable audio/visual (A/V) network;
logic configured to receive the selected at least one A/V program from the RF cable A/V network; and
logic configured to provide the received at least one A/V program to at least one audio/video (A/V) customer premise equipment (CPE) device that is electromagnetically connectable to the at least one customer premise A/V communications medium, the at least one A/V program communicated through the at least one A/V CPE interface and over the at least one customer premise A/V communications medium.

108. The set-top box of claim 107, wherein the at least one A/V CPE device is selected from the group consisting of: a television, a video recorder, a stereo, and an audio recorder.

109. The set-top box of claim 107, wherein the set-top box appears on the RF cable data network to be the same as an ethernet attached cable modem that conforms to at least one version of a DOCSIS (Data-Over-Cable Service Interface Specification) standard.

110. The set-top box of claim 109, wherein the at least one IP address is at least one DOCSIS customer premise equipment (CPE) IP address, the set-top box further comprising logic configured to store information identifying at least one DOCSIS cable modem (CM) IP address, the at least one DOCSIS CM IP address also considered to be assigned to the set-top box, the at least one DOCSIS CPE IP address being different from the at least one DOCSIS CM IP address.

111. The set-top box of claim 107, wherein the set-top box appears on the RF cable data network to conform to at least one version of a DAVIC (Digital Audio Visual Council) cable modem standard.

112. The RF cable network device of claim 105, wherein the RF cable network device is a cable modem (CM).

113. The cable modem of claim 112, wherein the cable modem (CM) appears on the RF cable data network to be the same as an ethernet attached cable modem that conforms to at least one version of a DOCSIS (Data-Over-Cable Service Interface Specification) standard.

114. The cable modem of claim 113, wherein the at least one IP address is at least one DOCSIS customer premise equipment (CPE) IP address, the cable modem further comprising logic configured to store information identifying at least one DOCSIS cable modem (CM) IP address, the at least one DOCSIS CM IP address also considered to be assigned to the cable modem, the at least one DOCSIS CPE IP address being different from the at least one DOCSIS CM IP address.

115. The cable modem of claim 112, wherein the cable modem (CM) appears on the RF cable data network to conform to at least one version of a DAVIC (Digital Audio Visual Council) cable modem standard.

116. The RF cable network device of claim 104, wherein the at least one wired customer premise data communications medium is electrical power wiring at the customer premise, and wherein IP datagrams is frequency-division multiplexed with a signal for carrying electrical power to appliances at the customer premise.

117. The RF cable network device of claim 116, wherein the at least one wired customer premise data communications medium conforms to at least one version of at least one protocol selected from the group consisting of: X.10, CEBus, and PowerPacket.

118. The RF cable network device of claim 116, wherein the RF cable network device is a set-top box (STB) that further comprises:
at least one audio/video (A/V) customer premise equipment (CPE) interface that is electromagnetically connectable to at least one customer premise audio/video (A/V) communications medium;
logic configured to select at least one audio/video (A/V) program that is communicated to the at least one RF cable interface over at least one RF cable audio/visual (A/V) network;
logic configured to receive the selected at least one A/V program from the RF cable A/V network; and
logic configured to provide the received at least one A/V program to at least one audio/video (A/V) customer premise equipment (CPE) device that is electromagnetically connectable to the at least one customer premise A/V communications medium, the at least one A/V program communicated through the at least one A/V CPE interface and over the at least one customer premise A/V communications medium.

119. The set-top box of claim 18, wherein the at least one A/V CPE device is selected from the group consisting of: a television, a video recorder, a stereo, and an audio recorder.

120. The set-top box of claim 118, wherein the set-top box appears on the RF cable data network to be the same as an ethernet attached cable modem that conforms to at least one version of a DOCSIS (Data-Over-Cable Service Interface Specification) standard.

121. The set-top box of claim 120, wherein the at least one IP address is at least one DOCSIS customer premise equipment (CPE) IP address, the set-top box further comprising logic configured to store information identifying at least one DOCSIS cable modem (CM) IP address, the at least one DOCSIS CM IP address also considered to be assigned to the set-top box, the at least one DOCSIS CPE IP address being different from the at least one DOCSIS CM IP address.

122. The set-top box of claim 118, wherein the set-top box appears on the RF cable data network to conform to at least one version of a DAVIC (Digital Audio Visual Council) cable modem standard.

123. The RF cable network device of claim 116, wherein the RF cable network device is a cable modem (CM).

124. The cable modem of claim 123, wherein the cable modem (CM) appears on the RF cable data network to be the same as an ethernet attached cable modem that conforms to at least one version of a DOCSIS (Data-Over-Cable Service Interface Specification) standard.

125. The cable modem of claim 124, wherein the at least one IP address is at least one DOCSIS customer premise equipment (CPE) IP address, the cable modem further comprising logic configured to store information identifying at least one DOCSIS cable modem (CM) IP address, the at least one DOCSIS CM IP address also considered to be assigned to the cable modem, the at least one DOCSIS CPE IP address being different from the at least one DOCSIS CM IP address.

126. The cable modem of claim 123, wherein the cable modem (CM) appears on the RF cable data network to conform to at least one version of a DAVIC (Digital Audio Visual Council) cable modem standard.

127. The RF cable network device of claim 74, wherein the at least one customer premise data communications medium is at least one wireless customer premise data communications medium.

128. The RF cable network device of claim 127, wherein at least one option card is added to a base unit of the RF cable network device to provide at least support for the at least one wireless customer premise data communications medium.

129. The RF cable network device of claim 128, wherein the at least one wireless customer premise data communications medium conforms to at least one version of at least one protocol selected from the group consisting of: Bluetooth, IEEE 802.11a, IEEE 802.11b, and HomeRF.

130. The RF cable network device of claim 127, wherein the RF cable network device is a set-top box (STB) that further comprises:
at least one audio/video (A/V) customer premise equipment (CPE) interface that is electromagnetically connectable to at least one customer premise audio/video (A/V) communications medium;
logic configured to select at least one audio/video (A/V) program that is communicated to the at least one RF cable interface over at least one RF cable audio/visual (A/V) network;
logic configured to receive the selected at least one A/V program from the RF cable A/V network; and
logic configured to provide the received at least one A/V program to at least one audio/video (A/V) customer premise equipment (CPE) device that is electromagnetically connectable to the at least one customer premise A/V communications medium, the at least one A/V program communicated through the at least one A/V CPE interface and over the at least one customer premise A/V communications medium.

131. The set-top box of claim 130, wherein the at least one A/V CPE device is selected from the group consisting of: a television, a video recorder, a stereo, and an audio recorder.

132. The set-top box of claim 130, wherein the set-top box appears on the RF cable data network to be the same as an ethernet attached cable modem that conforms to at least one version of a DOCSIS (Data-Over-Cable Service Interface Specification) standard.

133. The set-top box of claim 132, wherein the at least one IP address is at least one DOCSIS customer premise equipment (CPE) IP address, the set-top box further comprising logic configured to store information identifying at least one DOCSIS cable modem (CM) IP address, the at least one DOCSIS CM IP address also considered to be assigned to the set-top box, the at least one DOCSIS CPE IP address being different from the at least one DOCSIS CM IP address.

134. The set-top box of claim 132, wherein the set-top box appears on the RF cable data network to conform to at least one version of a DAVIC (Digital Audio Visual Council) cable modem standard.

135. The RF cable network device of claim 127, wherein the RF cable network device is a cable modem (CM).

136. The cable modem of claim 135, wherein the cable modem (CM) appears on the RF cable data network to be the same as an ethernet attached cable modem that conforms to at least one version of a DOCSIS (Data-Over-Cable Service Interface Specification) standard.

137. The cable modem of claim 136, wherein the at least one IP address is at least one DOCSIS customer premise equipment (CPE) IP address, the cable modem further comprising logic configured to store information identifying at least one DOCSIS cable modem (CM) IP address, the at least one DOCSIS CM IP address also considered to be assigned to the cable modem, the at least one DOCSIS CPE IP address being different from the at least one DOCSIS CM IP address.

138. The cable modem of claim 135, wherein the cable modem (CM) appears on the RF cable data network to conform to at least one version of a DAVIC (Digital Audio Visual Council) cable modem standard.

139. The RF cable network device of claim 74, wherein the RF cable network device further comprises logic configured to implement a Dynamic Host Configuration Protocol (DHCP) client that dynamically obtains the assignment of the least one IP address.

140. The RF cable network device of claim 139, wherein the RF cable network device is a set-top box (STB) that further comprises:
least one audio/video (A/V) customer premise equipment (CPE) interface that is electromagnetically connectable to at least one customer premise audio/video (A/V) communications medium;
logic configured to select at least one audio/video (A/V) program that is communicated to the at least one RF cable interface over at least one RF cable audio/visual (A/V) network;
logic configured to receive the selected at least one A/V program from the RF cable A/V network; and
logic configured to provide the received at least one A/V program to at least one audio/video (A/V) customer premise equipment (CPE) device that is electromagnetically connectable to the at least one customer premise A/V communications medium, the at least one A/V program communicated through the at least one A/V CPE interface and over the at least one customer premise A/V communications medium.

141. The set-top box of claim 140, wherein the at least one A/V CPE device is selected from the group consisting of: a television, a video recorder, a stereo, and an audio recorder.

142. The set-top box of claim 140, wherein the set-top box appears on the RF cable data network to be the same as an ethernet attached cable modem that conforms to at least one version of a DOCSIS (Data-Over-Cable Service Interface Specification) standard.

143. The set-top box of claim 142, wherein the at least one IP address is at least one DOCSIS customer premise equipment (CPE) IP address, the set-top box further comprising logic configured to store information identifying at least one DOCSIS cable modem (CM) IP address, the at least one DOCSIS CM IP address also considered to be assigned to the set-top box, the at least one DOCSIS CPE IP address being different from the at least one DOCSIS CM IP address.

144. The set-top box of claim 140, wherein the set-top box appears on the RF cable data network to conform to at least one version of a DAVIC (Digital Audio Visual Council) cable modem standard.

145. The RF cable network device of claim 139, wherein the RF cable network device is a cable modem (CM).

146. The cable modem of claim 145, wherein the cable modem (CM) appears on the RF cable data network to be the same as an ethernet attached cable modem that conforms to at least one version of a DOCSIS (Data-Over-Cable Service Interface Specification) standard.

147. The cable modem of claim 146, wherein the at least one IP address is at least one DOCSIS customer premise equipment (CPE) IP address, the cable modem further comprising logic configured to store information identifying at least one DOCSIS cable modem (CM) IP address, the at least one DOCSIS CM IP address also considered to be assigned to the cable modem, the at least one DOCSIS CPE IP address being different from the at least one DOCSIS CM IP address.

148. The cable modem of claim 145, wherein the cable modem (CM) appears on the RF cable data network to conform to at least one version of a DAVIC (Digital Audio Visual Council) cable modem standard.

149. The RF cable network device of claim 74, wherein the RF cable network device further comprises logic configured to perform as a Dynamic Host Configuration Protocol (DHCP) server that assigns at least one customer network IP address to the at least one first CPE data device connected to the at least one customer premise data communications medium.

150. The RF cable network device of claim 149, wherein the at least one customer network IP address is from a different IP address realm than the at least one IP address for RF cable data network access.

151. The RF cable network device of claim 149, wherein the RF cable network device is a set-top box (STB) that further comprises:
at least one audio/video (A/V) customer premise equipment (CPE) interface that is electromagnetically connectable to at least one customer premise audio/video (A/V) communications medium;
logic configured to select at least one audio/video (A/V) program that is communicated to the at least one RF cable interface over at least one RF cable audio/visual (A/V) network;
logic configured to receive the selected at least one A/V program from the RF cable A/V network; and
logic configured to provide the received at least one A/V program to at least one audio/video (A/V) customer premise equipment (CPE) device that is electromagnetically connectable to the at least one customer premise A/V communications medium, the at least one A/V program communicated through the at least one A/V CPE interface and over the at least one customer premise A/V communications medium.

152. The set-top box of claim 151, wherein the at least one A/V CPE device is selected from the group consisting of: a television, a video recorder, a stereo, and an audio recorder.

153. The set-top box of claim 151, wherein the set-top box appears on the RF cable data network to be the same as an ethernet attached cable modem that conforms to at least one version of a DOCSIS (Data-Over-Cable Service Interface Specification) standard.

154. The set-top box of claim 153, wherein the at least one IP address is at least one DOCSIS customer premise equipment (CPE) IP address, the set-top box further comprising logic configured to store information identifying at least one DOCSIS cable modem (CM) IP address, the at least one DOCSIS CM IP address also considered to be assigned to the set-top box, the at least one DOCSIS CPE IP address being different from the at least one DOCSIS CM IP address.

155. The set-top box of claim 151, wherein the set-top box appears on the RF cable data network to conform to at least one version of a DAVIC (Digital Audio Visual Council) cable modem standard.

156. The RF cable network device of claim 149, wherein the RF cable network device is a cable modem (CM).

157. The cable modem of claim 156, wherein the cable modem (CM) appears on the RF cable data network to be the same as an ethernet attached cable modem that conforms to at least one version of a DOCSIS (Data-Over-Cable Service Interface Specification) standard.

158. The cable modem of claim 157, wherein the at least one IP address is at least one DOCSIS customer premise equipment (CPE) IP address, the cable modem further comprising logic configured to store information identifying at least one DOCSIS cable modem (CM) IP address, the at least one DOCSIS CM IP address also considered to be assigned to the cable modem, the at least one DOCSIS CPE IP address being different from the at least one DOCSIS CM IP address.

159. The cable modem of claim 156, wherein the cable modem (CM) appears on the RF cable data network to conform to at least one version of a DAVIC (Digital Audio Visual Council) cable modem standard.

160. The RF cable network device of claim 72, wherein the RF cable network device is configured to perform the at least one integrated gateway service, the at least one integrated gateway service being selected from the group consisting of: firewall and proxy.

161. The RF cable network device of claim 160, wherein at least one option card is added to a base unit of the RF cable network device to provide at least support for the at least one integrated gateway service.

162. The RF cable network device of claim 160, wherein the RF cable network device is a set-top box (STB) that further comprises:
at least one audio/video (A/V) customer premise equipment (CPE) interface that is electromagnetically connectable to at least one customer premise audio/video (A/V) communications medium;
logic configured to select at least one audio/video (A/V) program that is communicated to the at least one RF cable interface over at least one RF cable audio/visual (A/V) network;
logic configured to receive the selected at least one A/V program from the RF cable A/V network; and
logic configured to provide the received at least one A/V program to at least one audio/video (A/V) customer premise equipment (CPE) device that is electromagnetically connectable to the at least one customer premise A/V communications medium, the at least one A/V program communicated through the at least one A/V CPE interface and over the at least one customer premise A/V communications medium.

163. The set-top box of claim 162, wherein the at least one A/V CPE device is selected from the group consisting of: a television, a video recorder, a stereo, and an audio recorder.

164. The set-top box of claim 162, wherein the set-top box appears on the RF cable data network to be the same as an ethernet attached cable modem that conforms to at least one version of a DOCSIS (Data-Over-Cable Service Interface Specification) standard.

165. The set-top box of claim 164, wherein the at least one IP address is at least one DOCSIS customer premise equipment (CPE) IP address, the set-top box further comprising logic configured to store information identifying at least one DOCSIS cable modem (CM) IP address, the at least one DOCSIS CM IP address also considered to be assigned to the set-top box, the at least one DOCSIS CPE IP address being different from the at least one DOCSIS CM IP address.

166. The set-top box of claim 162, wherein the set-top box appears on the RF cable data network to conform to at least one version of a DAVIC (Digital Audio Visual Council) cable modem standard.

167. The RF cable network device of claim 160, wherein the RF cable network device is a cable modem (CM).

168. The cable modem of claim 167, wherein the cable modem (CM) appears on the RF cable data network to be the same as an ethernet attached cable modem that conforms to at least one version of a DOCSIS (Data-Over-Cable Service Interface Specification) standard.

169. The cable modem of claim 168, wherein the at least one IP address is at least one DOCSIS customer premise equipment (CPE) IP address, the cable modem further comprising logic configured to store information identifying at least one DOCSIS cable modem (CM) IP address, the at least one DOCSIS CM IP address also considered to be assigned to the cable modem, the at least one DOCSIS CPE IP address being different from the at least one DOCSIS CM IP address.

170. The cable modem of claim 167, wherein the cable modem (CM) appears on the RF cable data network to conform to at least one version of a DAVIC (Digital Audio Visual Council) cable modem standard.

171. The RF cable network device of claim 160, wherein the firewall gateway service performs at least one of the firewall types selected from the group consisting of: packet-filtering, circuit-level gateway, and application layer gateway.

172. The RF cable network device of claim 171, wherein the packet-filtering firewall type performs state-based packet-filtering.

173. The RF cable network device of claim 160, wherein the at least one integrated gateway service performs at least one of the gateway service types selected from the group consisting of: circuit-level gateway and application layer gateway.

174. The RF cable network device of claim 173, wherein the at least one integrated gateway service type operates on IP datagrams.

175. The RF cable network device of claim 173, wherein the at least one integrated gateway service type converts network layer protocols.

176. The RF cable network device of claim 173, wherein the at least one integrated gateway service type converts network protocols between the network layer protocols of IPX (Internet Packet eXchange) and IP (Internet Protocol).

177. The RF cable network device of claim 160, wherein the RF cable network device further comprises logic configured to perform as a Dynamic Host Configuration Protocol (DHCP) server that assigns at least one customer network IP address to the at least one first CPE data device connected to the at least one customer premise data communications medium.

178. The RF cable network device of claim 177, wherein the RF cable network device is a set-top box (STB) that further comprises:
at least one audio/video (A/V) customer premise equipment (CPE) interface that is electromagnetically connectable to at least one customer premise audio/video (A/V) communications medium;
logic configured to select at least one audio/video (A/V) program that is communicated to the at least one RF cable interface over at least one RF cable audio/visual (A/V) network;
logic configured to receive the selected at least one A/V program from the RF cable A/V network; and
logic configured to provide the received at least one A/V program to at least one audio/video (A/V) customer premise equipment (CPE) device that is electromagnetically connectable to the at least one customer premise A/V communications medium, the at least one A/V program communicated through the at least one A/V CPE interface and over the at least one customer premise A/V communications medium.

179. The set-top box of claim 178, wherein the at least one A/V CPE device is selected from the group consisting of: a television, a video recorder, a stereo, and an audio recorder.

180. The set-top box of claim 178, wherein the set-top box appears on the RF cable data network to be the same as an ethernet attached cable modem that conforms to at least one version of a DOCSIS (Data-Over-Cable Service Interface Specification) standard.

181. The set-top box of claim 180, wherein the at least one IP address is at least one DOCSIS customer premise equipment (CPE) IP address, the set-top box further comprising logic configured to store information identifying at least one DOCSIS cable modem (CM) IP address, the at least one DOCSIS CM IP address also considered to be assigned to the set-top box, the at least one DOCSIS CPE IP address being different from the at least one DOCSIS CM IP address.

182. The set-top box of claim 178, wherein the set-top box appears on the RF cable data network to conform to at least one version of a DAVIC (Digital Audio Visual Council) cable modem standard.

183. The RF cable network device of claim 177, wherein the RF cable network device is a cable modem (CM).

184. The cable modem of claim 183, wherein the cable modem (CM) appears on the RF cable data network to be the same as an ethernet attached cable modem that conforms to at least one version of a DOCSIS (Data-Over-Cable Service Interface Specification) standard.

185. The cable modem of claim 184, wherein the at least one IP address is at least one DOCSIS customer premise equipment (CPE) IP address, the cable modem further comprising logic configured to store information identifying at least one DOCSIS cable modem (CM) IP address, the at least one DOCSIS CM IP address also considered to be assigned to the cable modem, the at least one DOCSIS CPE IP address being different from the at least one DOCSIS CM IP address.

186. The cable modem of claim 183, wherein the cable modem (CM) appears on the RF cable data network to conform to at least one version of a DAVIC (Digital Audio Visual Council) cable modem standard.

187. The RF cable network device of claim 72, wherein the RF cable network device is configured to perform the at least one integrated gateway service, the at least one integrated gateway service being selected from the group consisting of: tunneling and virtual private networking (VPN).

188. The RF cable network device of claim 187, wherein at least one option card is added to a base unit of the RF cable network device to provide at least support for the at least one integrated gateway service.

189. The RF cable network device of claim 187, wherein the RF cable network device is a set-top box (STB) that further comprises:
at least one audio/video (A/V) customer premise equipment (CPE) interface that is electromagnetically connectable to at least one customer premise audio/video (A/V) communications medium;
logic configured to select at least one audio/video (A/V) program that is communicated to the at least one RF cable interface over at least one RF cable audio/visual (A/V) network;
logic configured to receive the selected at least one A/V program from the RF cable A/V network; and
logic configured to provide the received at least one A/V program to at least one audio/video (A/V) customer premise equipment (CPE) device that is electromagnetically connectable to the at least one customer premise A/V communications medium, the at least one A/V program communicated through the at least one A/V CPE interface and over the at least one customer premise A/V communications medium.

190. The set-top box of claim 189, wherein the at least one A/V CPE device is selected from the group consisting of: a television, a video recorder, a stereo, and an audio recorder.

191. The set-top box of claim 189, wherein the set-top box appears on the RF cable data network to be the same as an ethernet attached cable modem that conforms to at least one version of a DOCSIS (Data-Over-Cable Service Interface Specification) standard.

192. The set-top box of claim 191, wherein the at least one IP address is at least one DOCSIS customer premise equipment (CPE) IP address, the set-top box further comprising logic configured to store information identifying at least one DOCSIS cable modem (CM) IP address, the at least one DOCSIS CM IP address also considered to be assigned to the set-top box, the at least one DOCSIS CPE IP address being different from the at least one DOCSIS CM IP address.

193. The set-top box of claim 189, wherein the set-top box appears on the RF cable data network to conform to at least one version of a DAVIC (Digital Audio Visual Council) cable modem standard.

194. The RF cable network device of claim 187, wherein the RF cable network device is a cable modem (CM).

195. The cable modem of claim 195, wherein the cable modem (CM) appears on the RF cable data network to be the same as an ethernet attached cable modem that conforms to at least one version of a DOCSIS (Data-Over-Cable Service Interface Specification) standard.

196. The cable modem of claim 195, wherein the at least one IP address is at least one DOCSIS customer premise equipment (CPE) IP address, the cable modem further comprising logic configured to store information identifying at least one DOCSIS cable modem (CM) IP address, the at least one DOCSIS CM IP address also considered to be assigned to the cable modem, the at least one DOCSIS CPE IP address being different from the at least one DOCSIS CM IP address.

197. The cable modem of claim 194, wherein the cable modem (CM) appears on the RF cable data network to conform to at least one version of a DAVIC (Digital Audio Visual Council) cable modem standard.

198. The RF cable network device of claim 187, wherein the at least one integrated service communicates encapsulated information in IP datagrams over the RF cable network.

199. The RF cable network device of claim 198, wherein the at least one integrated service at least one service utilizing at least one version of at least one protocol selected from the group consisting of: generic routing encapsulation (GRE), Ascend tunnel management protocol (ATMP), point-to-point tunneling protocol (PPTP), layer two forwarding (L2F) protocol, layer two tunneling protocol (L2TP), IP Security (IPSec), and multi-protocol label switching (MPLS).

200. The RF cable network device of claim 187, wherein the RF cable network device further comprises logic configured to perform as a Dynamic Host Configuration Protocol (DHCP) server that assigns at least one customer network IP address to the at least one first CPE data device connected to the at least one customer premise data communications medium.

201. The RF cable network device of claim 200, wherein the RF cable network device is a set-top box (STB) that further comprises:
at least one audio/video (A/V) customer premise equipment (CPE) interface that is electromagnetically connectable to at least one customer premise audio/video (A/V) communications medium;
logic configured to select at least one audio/video (A/V) program that is communicated to the at least one RF cable interface over at least one RF cable audio/visual (A/V) network;
a logic configured to receive the selected at least one A/V program from the RF cable A/V network; and
logic configured to provide the received at least one A/V program to at least one audio/video (A/V) customer premise equipment (CPE) device that is electromagnetically connectable to the at least one customer premise A/V communications medium, the at least one A/V program communicated through the at least one A/V CPE interface and over the at least one customer premise A/V communications medium.

202. The set-top box of claim 201, wherein the at least one A/V CPE device is selected from the group consisting of: a television, a video recorder, a stereo, and an audio recorder.

203. The set-top box of claim 201, wherein the set-top box appears on the RF cable data network to be the same as an ethernet attached cable modem that conforms to at least one version of a DOCSIS (Data-Over-Cable Service Interface Specification) standard.

204. The set-top box of claim 203, wherein the at least one IP address is at least one DOCSIS customer premise equipment (CPE) IP address, the set-top box further comprising logic configured to store information identifying at least one DOCSIS cable modem (CM) IP address, the at least one DOCSIS CM IP address also considered to be assigned to the set-top box, the at least one DOCSIS CPE IP address being different from the at least one DOCSIS CM IP address.

205. The set-top box of claim 201, wherein the set-top box appears on the RF cable data network to conform to at least one version of a DAVIC (Digital Audio Visual Council) cable modem standard.

206. The RF cable network device of claim 200, wherein the RF cable network device is a cable modem (CM).

207. The cable modem of claim 206, wherein the cable modem (CM) appears on the RF cable data network to be the same as an ethernet attached cable modem that conforms to at least one version of a DOCSIS (Data-Over-Cable Service Interface Specification) standard.

208. The cable modem of claim 207, wherein the at least one IP address is at least one DOCSIS customer premise equipment (CPE) IP address, the cable modem further comprising logic configured to store information identifying at least one DOCSIS cable modem (CM) IP address, the at least one DOCSIS CM IP address also considered to be assigned to the cable modem, the at least one DOCSIS CPE IP address being different from the at least one DOCSIS CM IP address.

209. The cable modem of claim 206, wherein the cable modem (CM) appears on the RF cable data network to conform to at least one version of a DAVIC (Digital Audio Visual Council) cable modem standard.

210. A method of implementing at least one integrated gateway service in a radio frequency (RF) cable network device, the method comprising the steps performed in the RF cable network device of:
providing at least one RF cable interface that is attachable to at least one RF cable, the at least one RF cable being at least part of an RF cable data network, the at least one RF cable at least providing downstream communications in the RF cable data network, the RF cable data network providing bi-directional data connectivity between the RF cable network device at a customer premise and a cable modem termination device;
providing at least one customer premise data interface that is electromagnetically connectable to at least one customer premise data communications medium, the at least one customer premise data communications medium further being electromagnetically connectable to at least one first customer premise equipment (CPE) data device, the at least one RF cable interface and the at least one customer premise data interface capable of providing at least part of a communications facility that can be used in a conveyance of data between the at least one first CPE data device and the at least one RF cable interface;
storing information identifying at least one IP address, the at least one IP address being assigned to the RF cable network device;
maintaining information that provides a forward direction mapping between first upstream data and second upstream data, the first upstream data being received on the at least one customer premise data interface and being received from the at least one first CPE data device, the second upstream data being transmitted into the RF cable data network and being transmitted by the RF cable network device;
maintaining information that provides a reverse direction mapping between first downstream data and second downstream data, the first downstream data being received on the at least one RF cable interface and being received from the RF cable data network, the second downstream data being transmitted on the at least one customer premise data interface and being transmitted by the RF cable network device;
receiving at least one first medium access control (MAC) frame that is at least part of the first upstream data;
forming at least one first IP datagram at least based upon the at least one first MAC frame, at least based upon the at least one IP address, and at least based upon the forward direction mapping, the at least one first IP datagram comprising a source IP address field, the at least one IP address being placed into the source IP address field of the at least one first IP datagram;
transmitting the at least one first IP datagram that is at least part of the second upstream data;
receiving at least one second IP datagram that is at least part of the first downstream data, the at least one second IP datagram comprising a destination IP address field that contains the at least one IP address;
forming at least one second medium access control (MAC) frame at least based upon the at least one second IP datagram, at least based upon the at least one IP address, and at least based upon the reverse direction mapping; and
transmitting the at least one second MAC frame that is at least part of the second downstream data.

211. The method of claim 210, wherein the RF cable data network further comprises at least one telco return path that at least provides upstream communications in the RF cable data network.

212. The method of claim 210, wherein the at least one first MAC frame comprises a third IP datagram, wherein the at least one second MAC frame comprises a fourth IP datagram, and wherein the method of implementing at least one integrated gateway service is used in performing network address translation (NAT), NAT being a gateway service that translates information in IP datagrams.

213. The method of claim 212, wherein the logic configured to perform NAT performs at least one type of NAT selected from the group consisting of: traditional NAT, basic NAT, network address-port translation (NAPT), bi-directional NAT, and twice NAT.

214. The method of claim 210, wherein the method of implementing at least one integrated gateway service is used in performing at least one type of service that is selected from the group consisting of: firewall and proxy.

215. The method of claim 210, wherein the method of implementing at least one integrated gateway service is used in performing at least one type of service that is selected from the group consisting of: tunneling and virtual private networking (VPN).

216. A radio frequency (RF) cable network device with integrated user processes, the device comprising:
at least one RF cable interface that is attachable to at least one RF cable, the at least one RF cable being at least part of an RF cable data network, the at least one RF cable at least providing downstream communications in the RF cable data network, the RF cable data network providing bi-directional data connectivity between the RF cable network device at a customer premise and a cable modem termination device;
logic configured to store at least one cable modem (CM) IP address assigned to the RF cable network device;
logic configured to store at least one customer premise equipment (CPE) IP address assigned to the RF cable network device, the at least one CPE IP address being different from the at least one CM IP address; and
logic configured to provide at least one user process, the at least one CPE IP address being in a source IP address field of at least one first IP datagram that carries information from the at least one user process, the at least one first IP datagram being communicated over the RF cable data network.

217. The RF cable network device of claim 216, wherein the RF cable data network further comprises at least one telco return path that at least provides upstream communications in the RF cable data network.

218. The RF cable network device of claim 216, wherein the RF cable network device further comprises logic configured to run at least one management and configuration application that communicates with service provider equipment and that is used to manage and configure the RF cable network device, the at least one CM IP address being in a source IP address field of at least one second IP datagram that carries information from the at least one management and configuration application, the at least one second IP datagram being communicated over the RF cable data network.

219. The RF cable network device of claim 218, wherein the at least one management and configuration application uses at least version of at least one of the protocols selected from the group consisting of: bootstrap protocol (BOOTP), dynamic host configuration protocol (DHCP), trivial file transfer protocol (TFTP), and simple network management protocol (SNMP).

220. The RF cable network device of claim 216, wherein the at least one user process communicates over the RF cable network using at least one version of at least one TCP/IP (transmission control protocol/internet protocol) suite application protocol that is selected from the group of consisting of: telnet, rlogin, file transfer protocol (FTP), network file system (NFS), electronic mail, simple mail transfer protocol (SMTP), post office protocol (POP), internet message access protocol (IMAP), multipurpose internet mail extensions (MIME), hyper-text transfer protocol (HTTP), and real-time transport protocol (RTP).

221. The RF cable network device of claim 216, wherein the at least one user process provides at least one gateway service selected from the group consisting of: network address translation (NAT), firewall, proxy, tunneling, and virtual private networking (VPN).

222. The RF cable network device of claim 216, wherein the RF cable network device is a set-top box (STB) that further comprises:
at least one audio/video (A/V) customer premise equipment (CPE) interface that is electromagnetically connectable to at least one customer premise audio/video (A/V) communications medium;
logic configured to select at least one audio/video (A/V) program that is communicated to the at least one RF cable interface over at least one RF cable audio/visual (A/V) network;
logic configured to receive the selected at least one A/V program from the RF cable A/V network; and
logic configured to provide the received at least one A/V program to at least one audio/video (A/V) customer premise equipment (CPE) device that is electromagnetically connectable to the at least one customer premise A/V communications medium, the at least one A/V program communicated through the at least one A/V CPE interface and over the at least one customer premise A/V communications medium.

223. The set-top box of claim 222, wherein the at least one A/V CPE device is selected from the group consisting of: a television, a video recorder, a stereo, and an audio recorder.

224. The set-top box of claim 222, wherein the set-top box appears on the RF cable data network to be the same as an ethernet attached cable modem that conforms to at least one version of a DOCSIS (Data-Over-Cable Service Interface Specification) standard.

225. The set-top box of claim 222, wherein the set-top box appears on the RF cable data network to conform to at least one version of a DAVIC (Digital Audio Visual Council) cable modem standard.

226. The RF cable network device of claim 216, wherein the RF cable network device is a cable modem (CM).

227. The cable modem of claim 226, wherein the cable modem (CM) appears on the RF cable data network to be the same as an ethernet attached cable modem that conforms to at least one version of a DOCSIS (Data-Over-Cable Service Interface Specification) standard.

228. The cable modem of claim 226, wherein the at least one IP address is at least one DOCSIS customer premise equipment (CPE) IP address, the cable modem further comprising logic configured to store information identifying at least one DOCSIS cable modem (CM) IP address, the at least one DOCSIS CM IP address also considered to be assigned to the cable modem, the at least one DOCSIS CPE IP address being different from the at least one DOCSIS CM IP address.

229. The cable modem of claim 226, wherein the cable modem (CM) appears on the RF cable data network to conform to at least one version of a DAVIC (Digital Audio Visual Council) cable modem standard.

230. A method of implementing at least one integrated user process in a radio frequency (RF) cable network device, the method comprising the steps performed in the RF cable network device of:
providing at least one RF cable interface that is attachable to at least one RF cable, the at least one RF cable being at least part of an RF cable data network, the at least one RF cable at least providing downstream communications in the RF cable data network, the RF cable data network providing bi-directional data connectivity between the RF cable network device at a customer premise and a cable modem termination device;
storing at least one cable modem (CM) IP address assigned to the RF cable network device;
storing at least one customer premise equipment (CPE) IP address assigned to the RF cable network device, the at least one CPE IP address being different from the at least one CM IP address; and
providing at least one user process, the at least one CPE IP address being in a source IP address field of at least one IP datagram that carries information from the at least one user process, the at least one IP datagram being communicated over the RF cable data network.

231. The method claim 230, wherein the RF cable data network further comprises at least one telco return path that at least provides upstream communications in the RF cable data network.

232. The method of claim 230 further comprising the step of running at least one management and configuration application that communicates with service provider equipment and that is used to manage and configure the RF cable network device, the at least one CM IP address being in a source IP address field of at least one second IP datagram that carries information from the at least one management and configuration application, the at least one second IP datagram being communicated over the RF cable data network.

233. The method of claim 232, wherein the at least one management and configuration application uses at least version of at least one of the protocols selected from the group consisting of: bootstrap protocol (BOOTP), dynamic host configuration protocol (DHCP), trivial file transfer protocol (TFTP), and simple network management protocol (SNMP).

234. The method of claim 230, wherein the at least one user process communicates over the RF cable network using at least one version of at least one TCP/IP (transmission control protocol/internet protocol) suite application protocol that is selected from the group of consisting of: telnet, rlogin, file transfer protocol (FTP), network file system (NFS), electronic mail, simple mail transfer protocol (SMTP), post office protocol (POP), internet message access protocol (IMAP), multipurpose internet mail extensions (MIME), hyper-text transfer protocol (HTTP), and real-time transport protocol (RTP).

235. The method of claim 230, wherein the at least one user process provides at least one gateway service selected from the group consisting of: network address translation (NAT), firewall, proxy, tunneling, and virtual private networking (VPN).
